(19) United States
(12) Patent Application Publication
(10) Pub. No.: US 2026/0367759 A1
(43) Pub. Date: Nov. 19, 2026

(54) USER INTERFACES FOR GENERATING AUTOMATICALLY-GENERATED VISUAL MEDIA

(71) Applicant: Apple Inc., Cupertino, CA (US)

(72) Inventor: Grant R. PAUL, San Francisco, CA (US)

(21) Appl. No.: 19/664,530

(22) Filed: Apr. 30, 2026

Related U.S. Application Data
(60) Provisional application No. 63/808,082, filed on May 19, 2025.

(51) Int. Cl. G06F 3/0482; G06F 3/0484; G06T 11/60; G06T 13/00

(52) U.S. Cl. CPC G06F 3/0482; G06F 3/0484; G06T 11/60; G06T 13/00; G06T 2200/24

(57) ABSTRACT

In some embodiments, an electronic device generates automatically-generated visual media using a machine learning (ML) model. The electronic device optionally makes automatically-generated visual media accessible in different locations. The electronic device optionally further allows for an automatically-generated visual media item to be re-sized in accordance with a drag input. The electronic device optionally also generates a different appearance of an automatically-generated visual media item in response to a same prompt and different appearance parameter associated with a respective user interface.

### CROSS REFERENCE TO RELATED APPLICATIONS

This application claims the benefit of U.S. Provisional Application No. 63/808,082, filed May 19, 2025, the contents of which are herein incorporated by reference in its entirety for all purposes.

### FIELD OF THE DISCLOSURE

This disclosure relates generally to an electronic device presenting user interfaces for generating automatically-generated visual media.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to create generative images using reference images. The user may therefore desire efficient ways of generating automatically-generated content and displaying the automatically-generated content.

### SUMMARY OF THE DISCLOSURE

Providing efficient ways of selecting different machine learning (ML) models and/or accessing automatically-generated visual media items enhances user interactions with the electronic device by reducing the time and inputs needed to perform the processes of selecting ML models and/or accessing automatically-generated visual media items and reducing user errors.

Updating the size of an automatically-generated visual media item after generation of the automatically-generated visual media item allows a user greater control over a size and/or aspect ratio of an AI generated media item. Further, computational advantages are achieved by allowing an AI model to generate initially a visual media item having a certain size (e.g., a square size) and then modifying the size of the visual media item, rather than requiring an AI model capable of generating a visual media item having any size.

By generating one or more one or more automatically-generated visual media items to have a certain appearance based on a prompt being received from a different respective application, an appearance of the one or more automatically-generated visual media items can be controlled without a further user input. This reduces the number of user interactions with an automatically-generated visual media application, which can reduce user error and expedite the generation of the visual media, thereby reducing the amount of computing resources required to perform the task.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6AJ illustrate exemplary ways in which an electronic device generates automatically -generated visual media using a machine learning (ML) model in accordance with some embodiments of the disclosure.

FIG. 7 illustrates a flow diagram illustrating a method in which an electronic generates automatically-generated visual media using a machine learning (ML) model in accordance with some embodiments of the disclosure.

FIG. 8 illustrates a flow diagram illustrating a method in which an electronic device makes automatically-generated visual media accessible in different locations in accordance with some embodiments of the disclosure.

FIGS. 9A-9H illustrate exemplary ways in which an electronic device displays an automatically-generated visual media item at a new size, in response to detecting a drag input directed towards the automatically-generated visual media item.

FIG. 10 illustrates a flow diagram illustrating a method in which an electronic device displays an automatically-generated visual media item at a new size, in response to detecting a drag input directed towards the automatically-generated visual media item.

FIGS. 11A-11G illustrate exemplary ways in which an electronic device displays an automatically-generated visual media item with a different appearance based on an appearance parameter associated with a respective user interface.

FIG. 12 illustrates a flow diagram illustrating a method in which an electronic device displays an automatically-generated visual media item with a different appearance based on an appearance parameter associated with a respective user interface.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Providing efficient ways of selecting different machine learning (ML) models and/or accessing automatically-generated visual media items enhances user interactions with the electronic device by reducing the time and inputs needed to perform the processes of selecting ML models and/or accessing automatically-generated visual media items and reducing user errors.

Updating the size of an automatically-generated visual media item after generation of the automatically-generated visual media item allows a user greater control over a size and/or aspect ratio of an ML generated media item. Further, computational advantages are achieved by allowing an ML model to generate initially a visual media item having a certain size (e.g., a square size) and then modifying the size of the visual media item, rather than requiring an AI model capable of generating a visual media item having any size.

By generating one or more one or more automatically-generated visual media items to have a certain appearance based on a prompt being received from a different respective application, an appearance of the one or more automatically-generated visual media items can be controlled without a further user input. This reduces the number of user interactions with an automatically-generated visual media application, which can reduce user error and expedite the generation of the visual media, thereby reducing the amount of computing resources required to perform the task.

Although the following description uses terms "first," "second," etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms "a," "an," and "the" are intended to include the plural forms as well, unless the context clearly indicates otherwise. It will also be understood that the term "and/or" as used herein refers to and encompasses any and all possible combinations of one or more of the associated listed items. It will be further understood that the terms "includes," "including," "comprises," and/or "comprising," when used in this specification, specify the presence of stated features, integers, steps, operations, elements, and/or components, but do not preclude the presence or addition of one or more other features, integers, steps, operations, elements, components, and/or groups thereof.

The term "if" is, optionally, construed to mean "when" or "upon" or "in response to determining" or "in response to detecting," depending on the context. Similarly, the phrase "if it is determined" or "if [a stated condition or event] is detected" is, optionally, construed to mean "upon determining" or "in response to determining" or "upon detecting [the stated condition or event]" or "in response to detecting [the stated condition or event]," depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

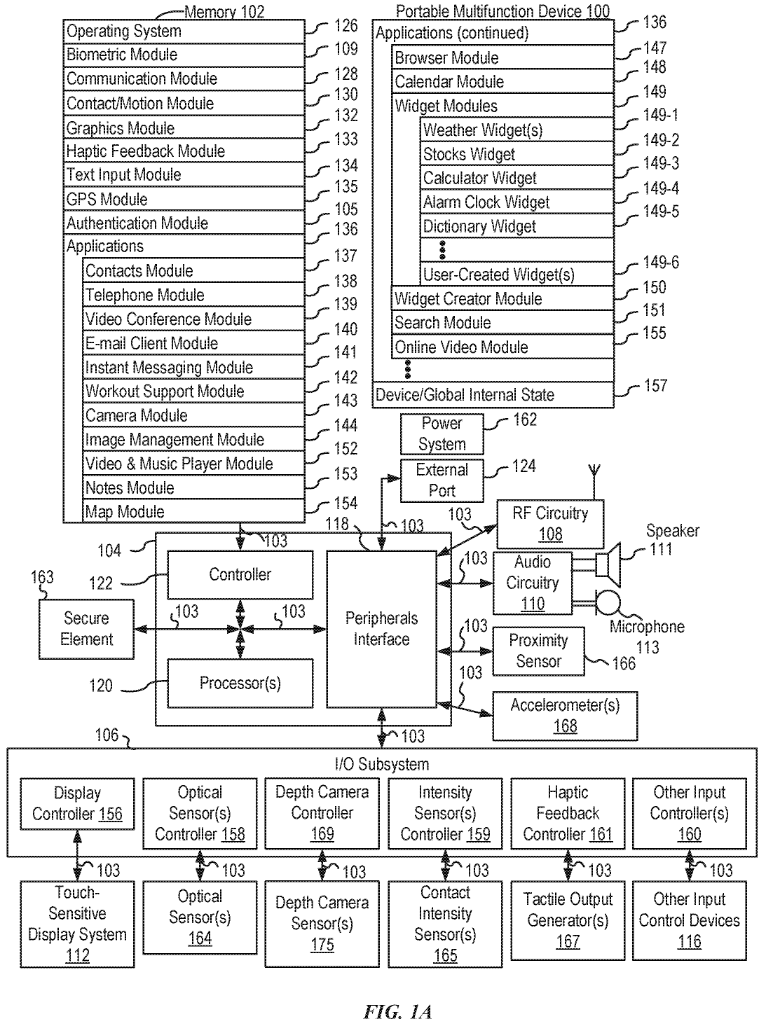

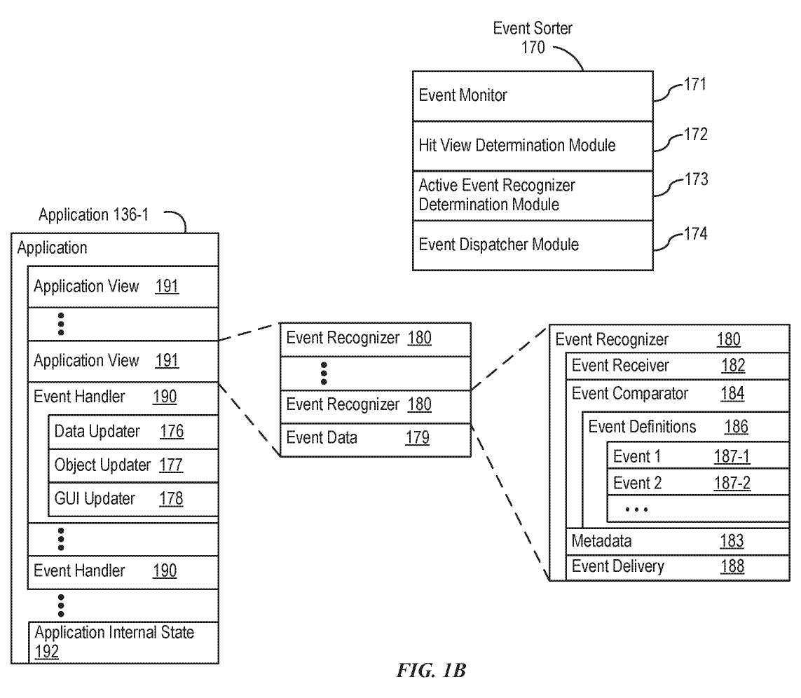

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a "touch screen" for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term "intensity" of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term "tactile output" refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a "down click" or "up click" of a physical actuator button. In some cases, a user will feel a tactile sensation such as a "down click" or "up click" even when there is no movement of a physical actuator button associated with the touch-sensitive surface that is physically pressed (e.g., displaced) by the user's movements. As another example, movement of the touch-sensitive surface is, optionally, interpreted or sensed by the user as "roughness" of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an "up click," a "down click," "roughness"), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

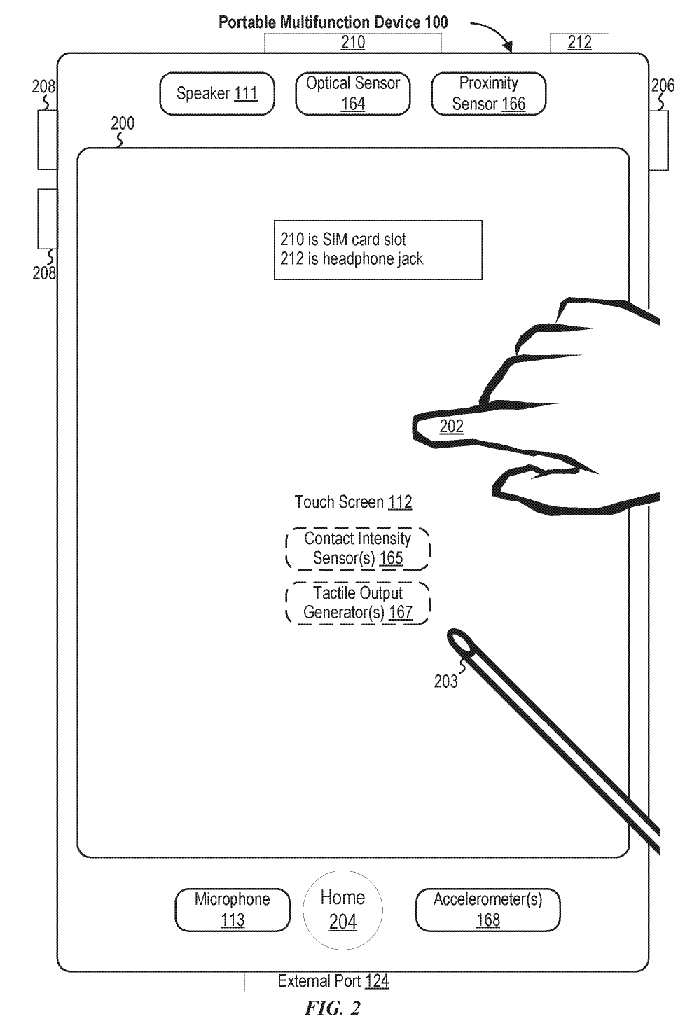

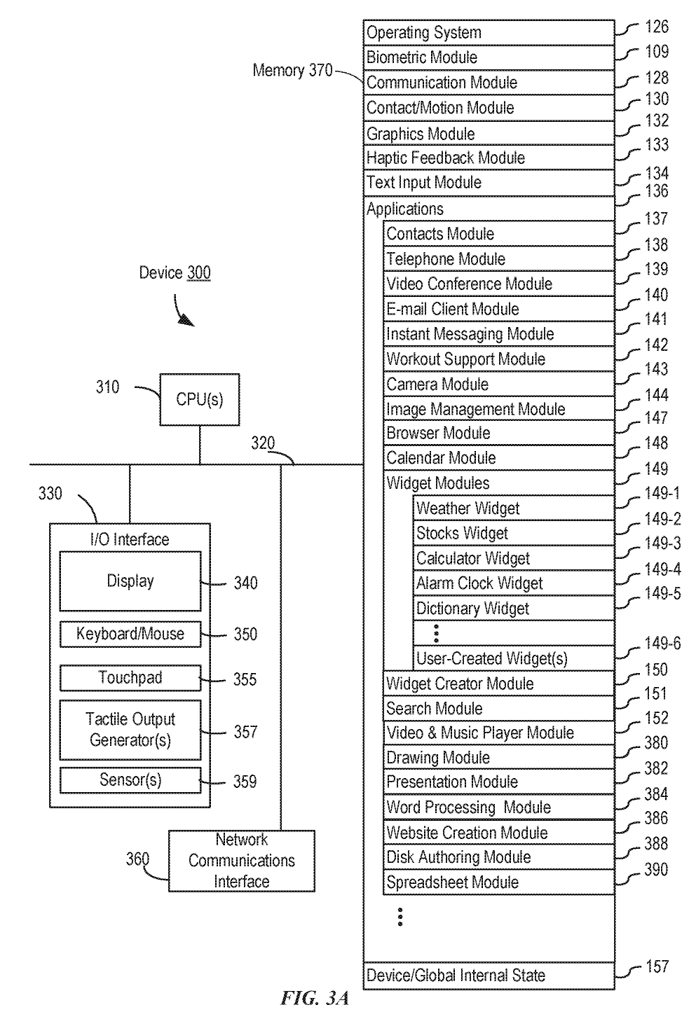

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. Patent Application 11/322,549, "Unlocking a Device by Performing Gestures on an Unlock Image," filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed "graphics"). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Patents: 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. Patent Application No. 11/381,313, "Multipoint Touch Surface Controller," filed May 2, 2006; (2) U.S. Patent Application No. 10/840,862, "Multipoint Touchscreen," filed May 6, 2004; (3) U.S. Patent Application No. 10/903,964, "Gestures For Touch Sensitive Input Devices," filed Jul. 30, 2004; (4) U.S. Patent Application No. 11/48,264, "Gestures For Touch Sensitive Input Devices," filed Jan. 31, 2005; (5) U.S. Patent Application No. 11/38,590, "Mode-Based Graphical User Interfaces For Touch Sensitive Input Devices," filed Jan. 18, 2005; (6) U.S. Patent Application No. 11/228,758, "Virtual Input Device Placement On A Touch Screen User Interface," filed Sep. 16, 2005; (7) U.S. Patent Application No. 11/228,700, "Operation Of A Computer With A Touch Screen Interface," filed Sep. 16, 2005; (8) U.S. Patent Application No. 11/228,737, "Activating Virtual Keys Of A Touch-Screen Virtual Keyboard," filed Sep. 16, 2005; and (9) U.S. Patent Application No. 11/367,749, "Multi-Functional Hand-Held Device," filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. Patent Application Nos. 11/241,839, "Proximity Detector In Handheld Device"; 11/240,788, "Proximity Detector In Handheld Device"; 11/620,702, "Using Ambient Light Sensor To Augment Proximity Sensor Output"; 11/586,862, "Automated Response To And Sensing Of User Activity In Portable Devices"; and 11/638,251, "Methods And Systems For Automatic Configuration Of Peripherals," which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, "Acceleration-based Theft Detection System for Portable Electronic Devices," and U.S. Patent Publication No. 20060017692, "Methods And Apparatuses For Operating A Portable Device Based On An Accelerometer," both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

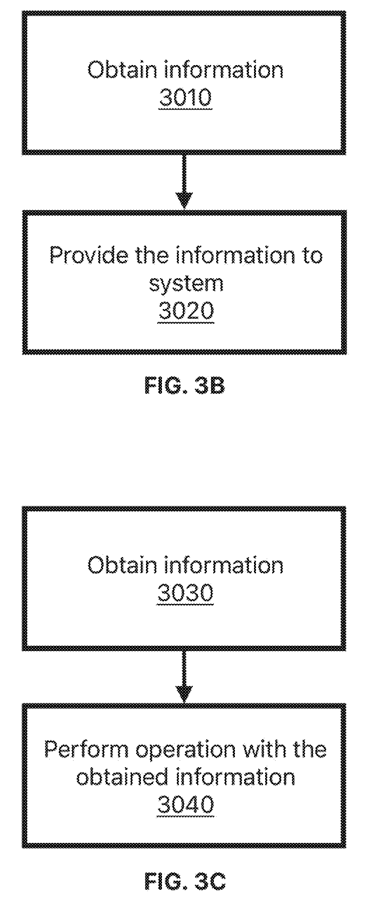

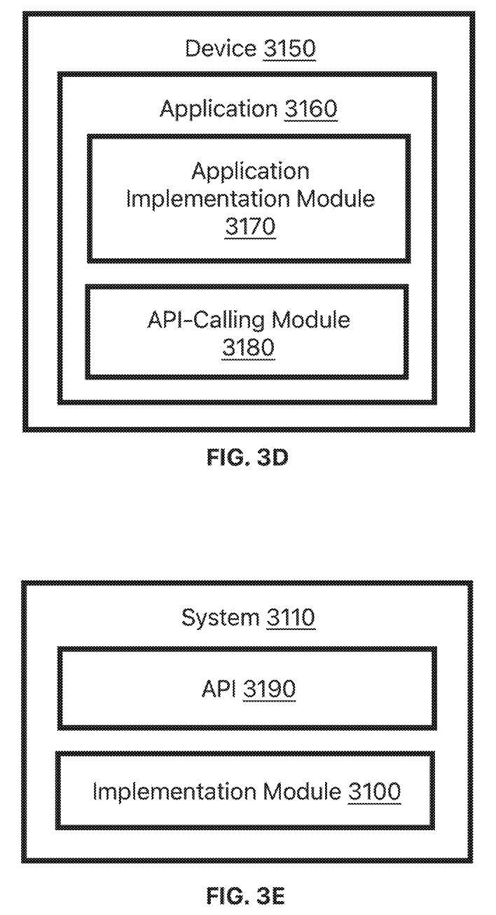

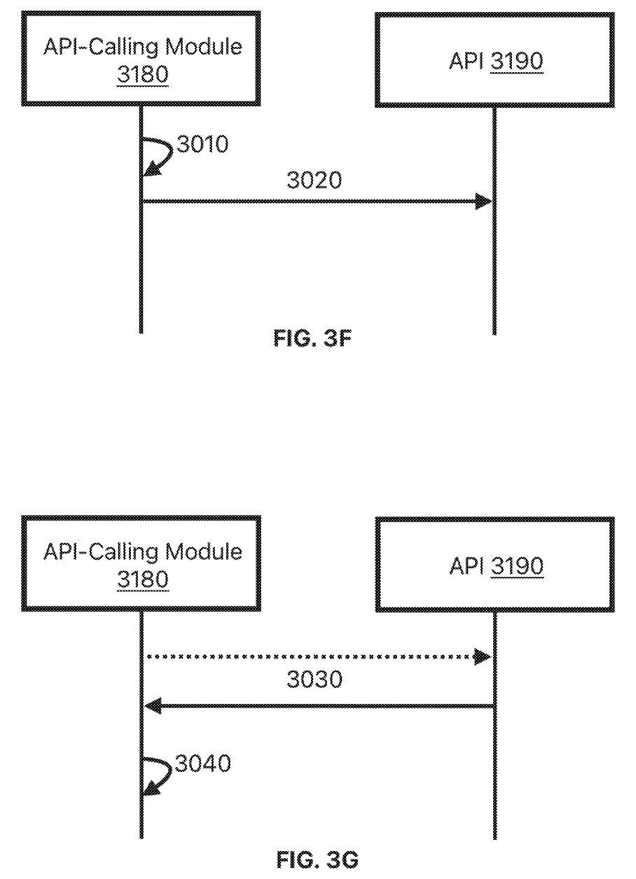

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., "multitouch"/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has "clicked" on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse "click" threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click "intensity" parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term "graphics" includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, "instant messaging" refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to -do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to -do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, "Portable Multifunction Device, Method, and Graphical User Interface for Playing Online Videos," filed June 20, 2007, and U.S. Patent Application No. 11/968,67, "Portable Multifunction Device, Method, and Graphical User Interface for Playing Online Videos," filed December 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a "menu button" is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as "home" or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIGS. 3B and 3F , application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIGS. 3C and 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

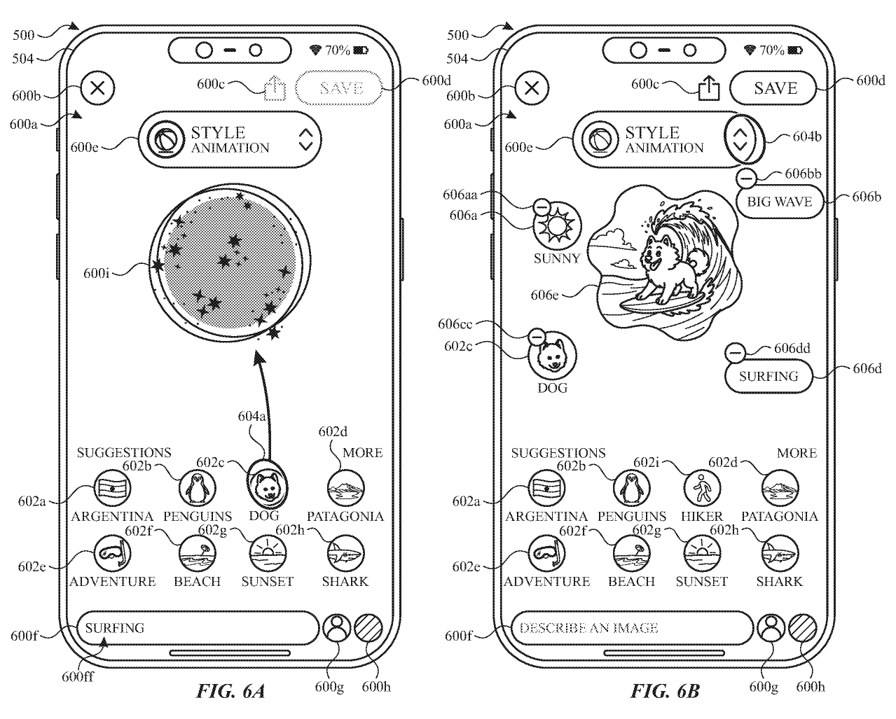

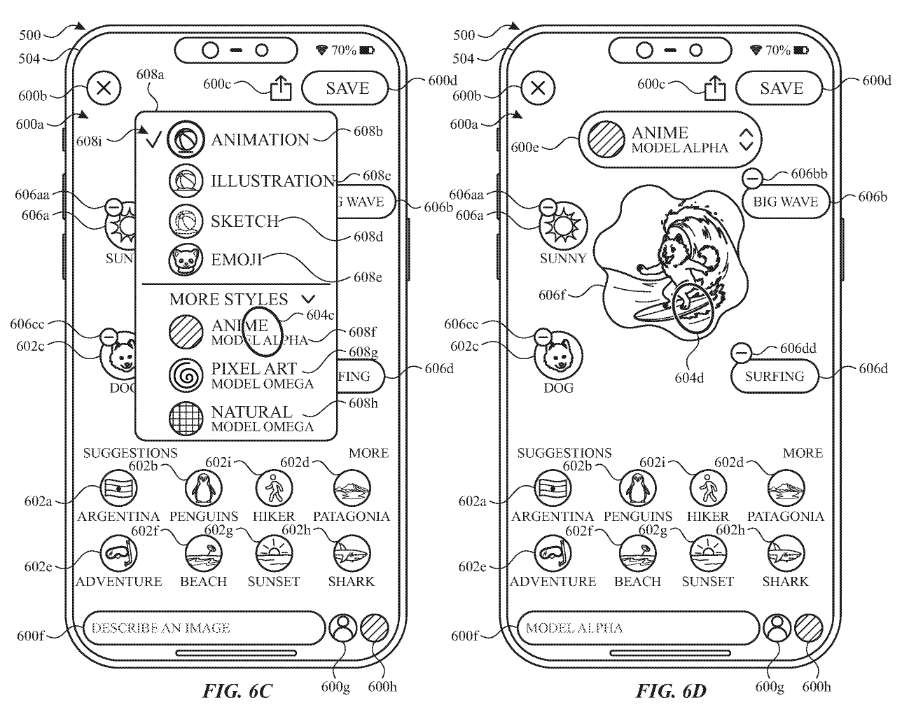

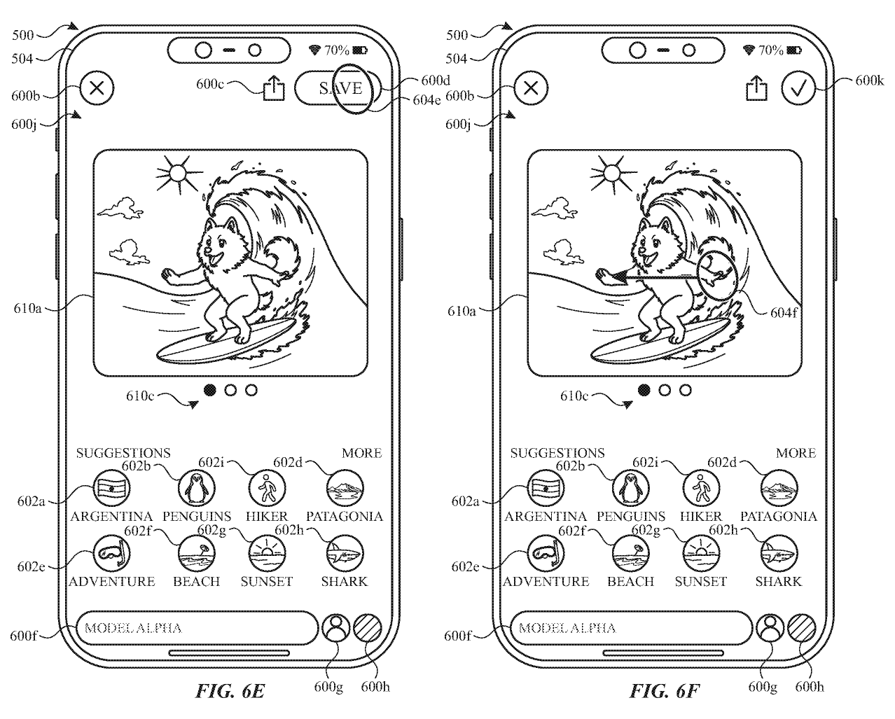

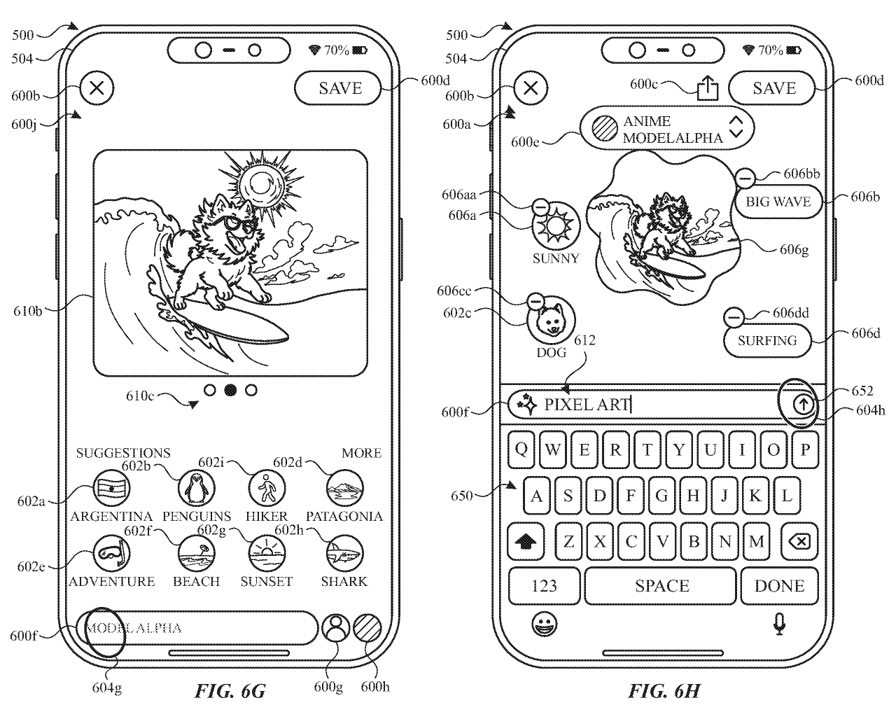

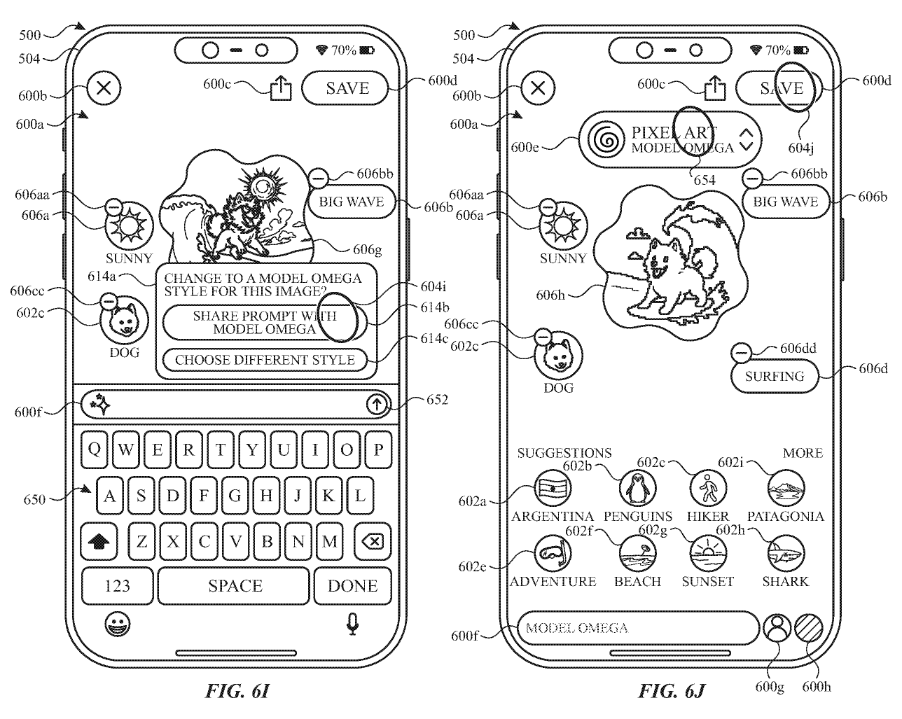

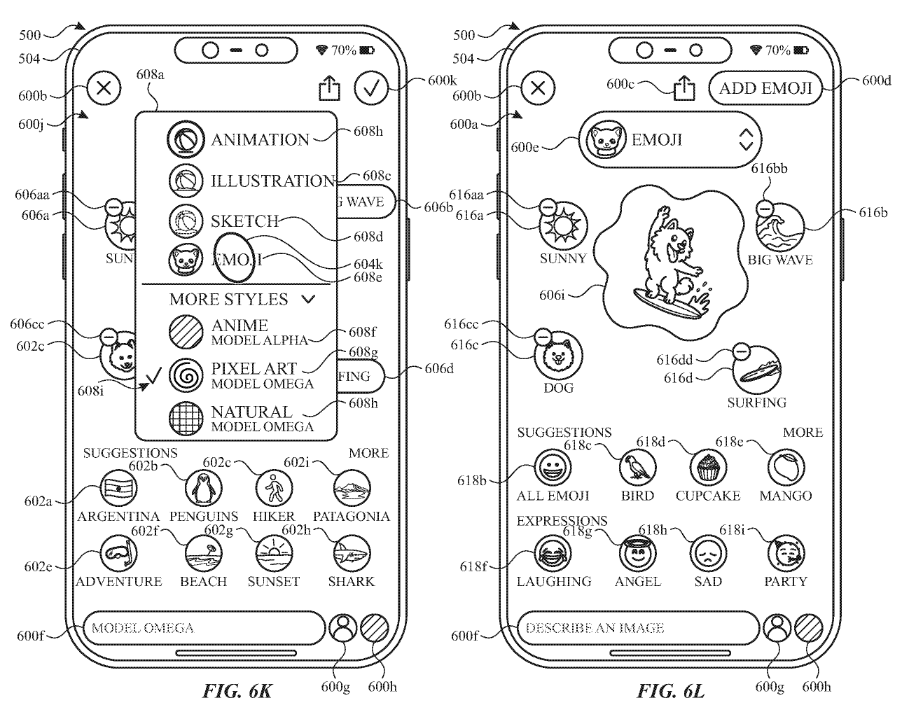

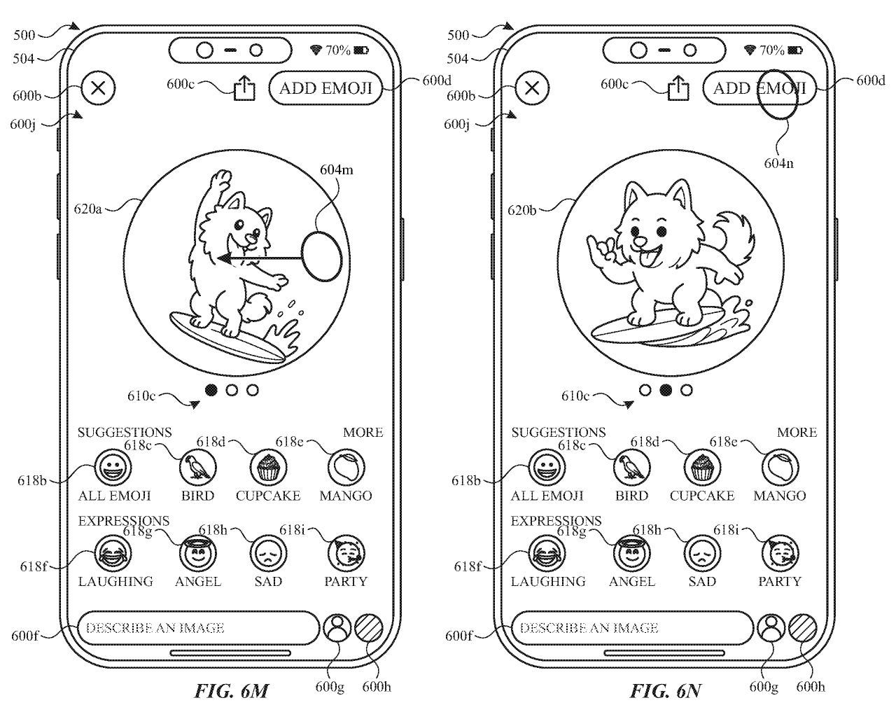

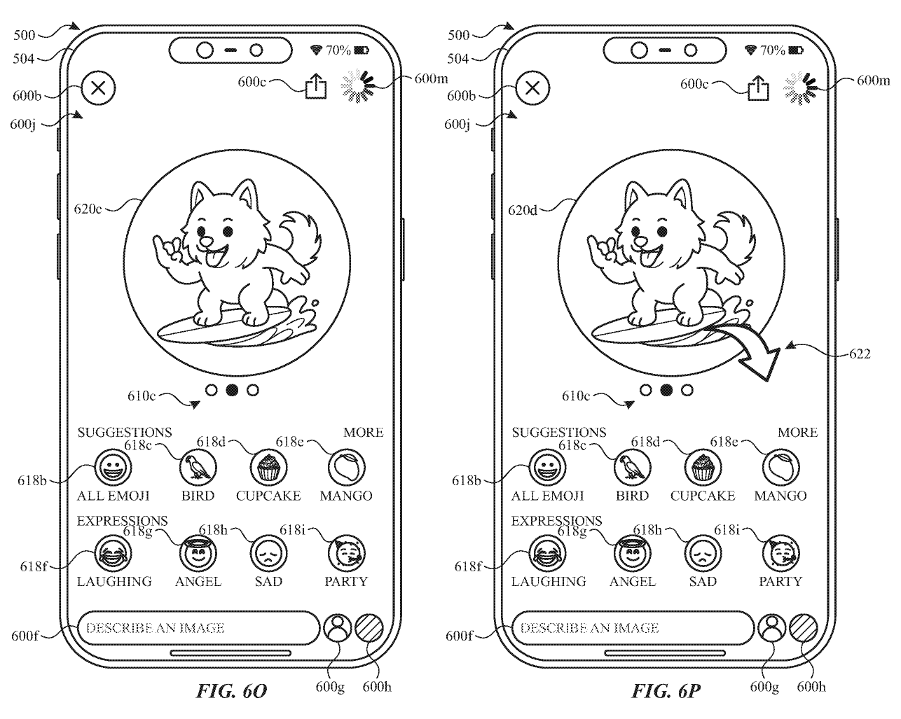

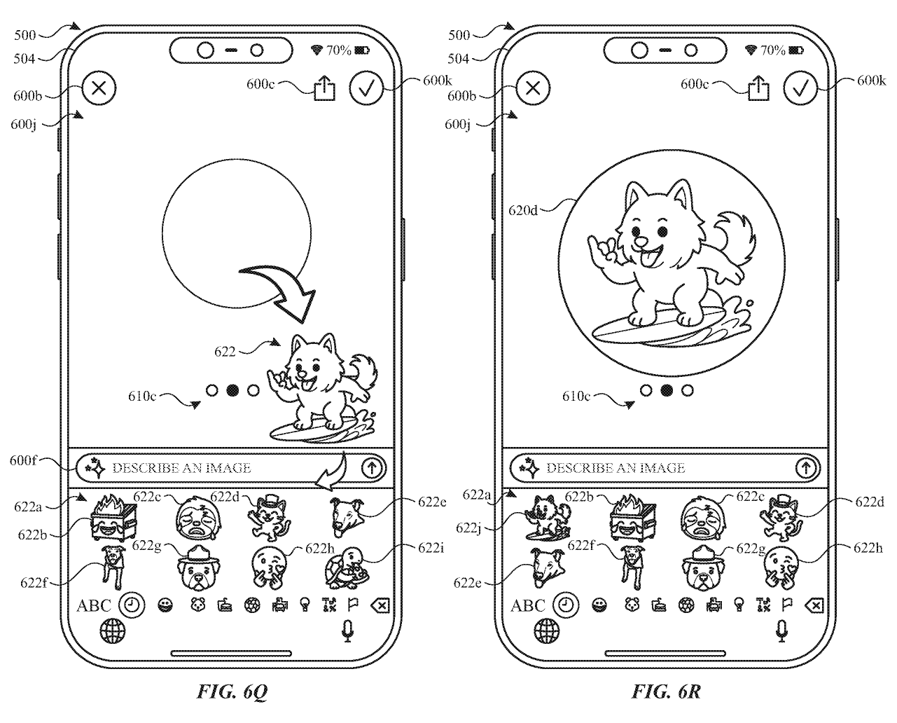

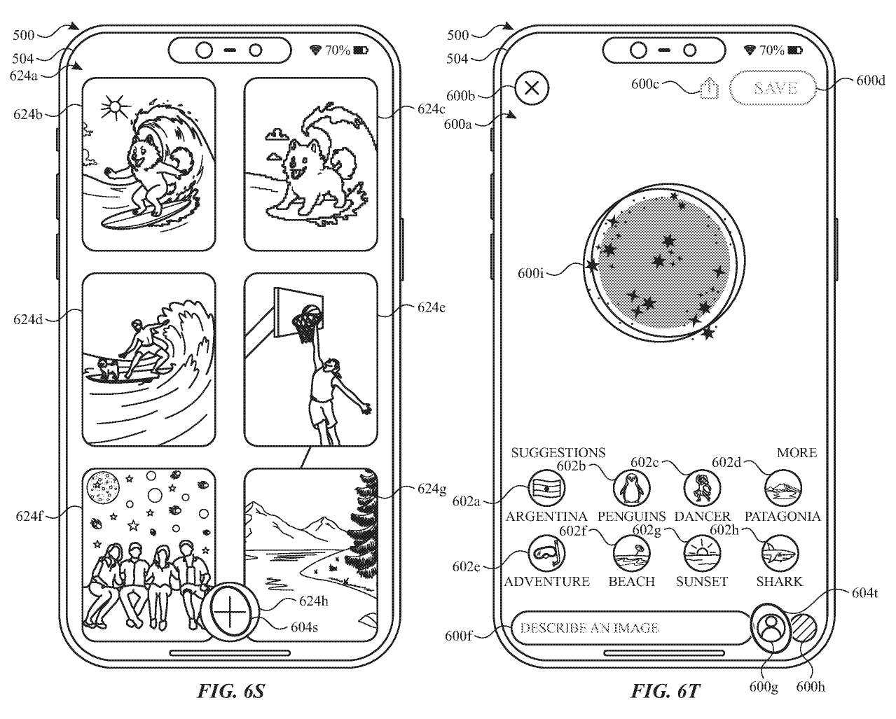

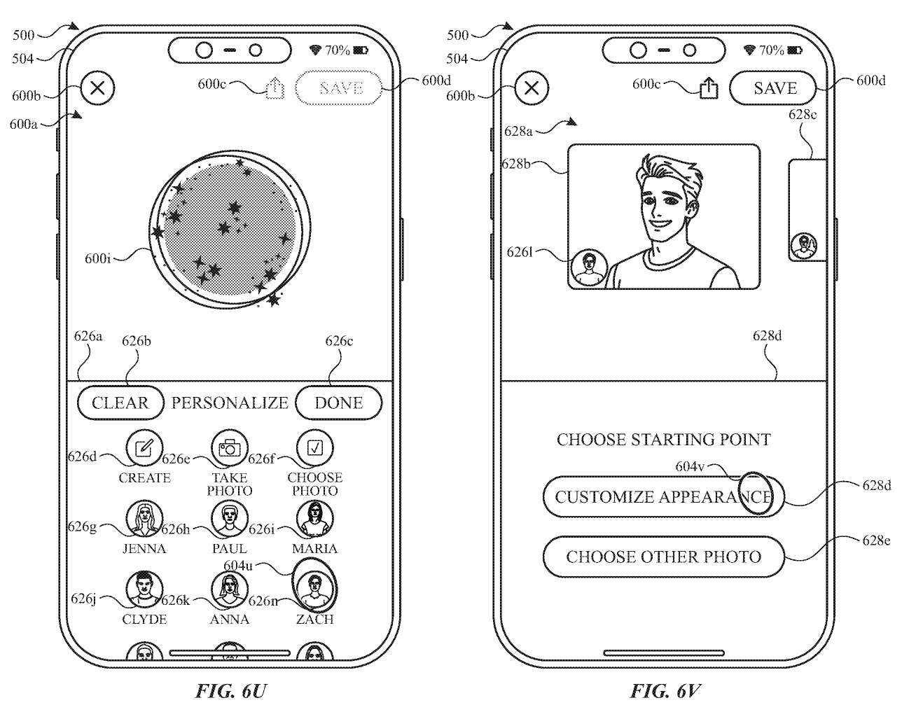

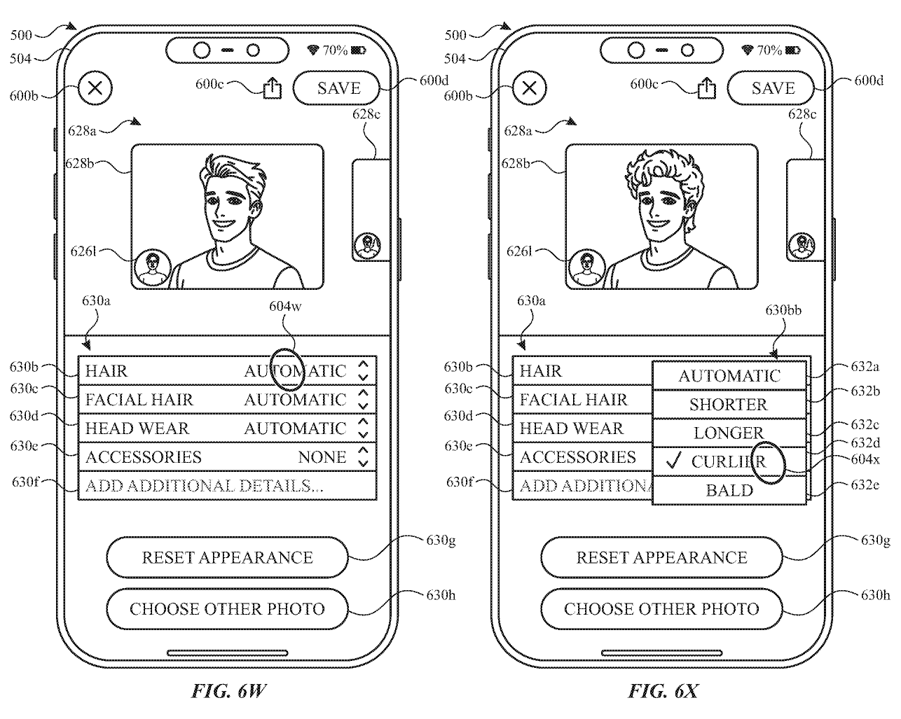

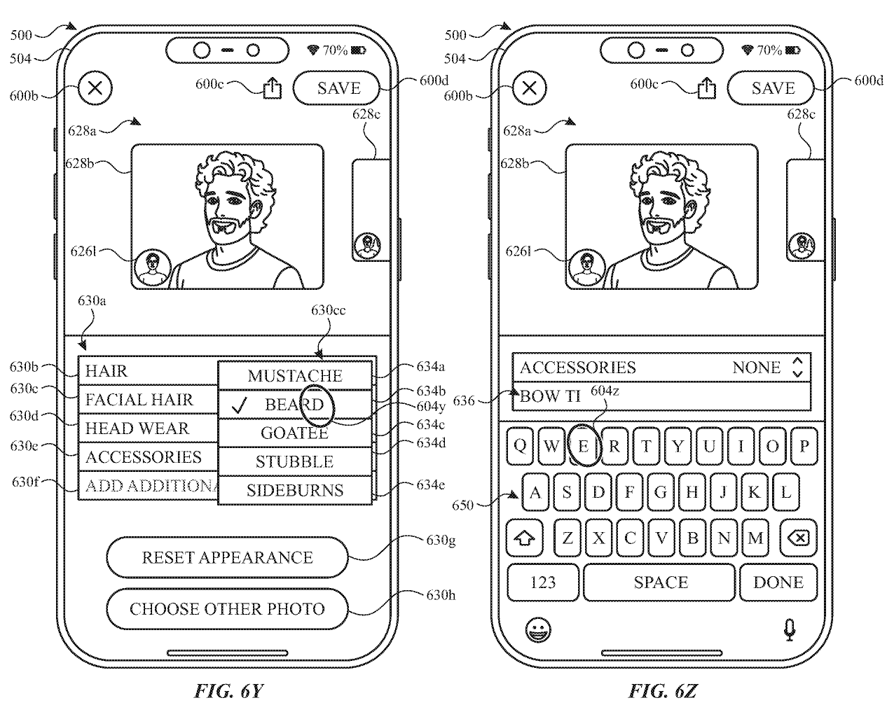

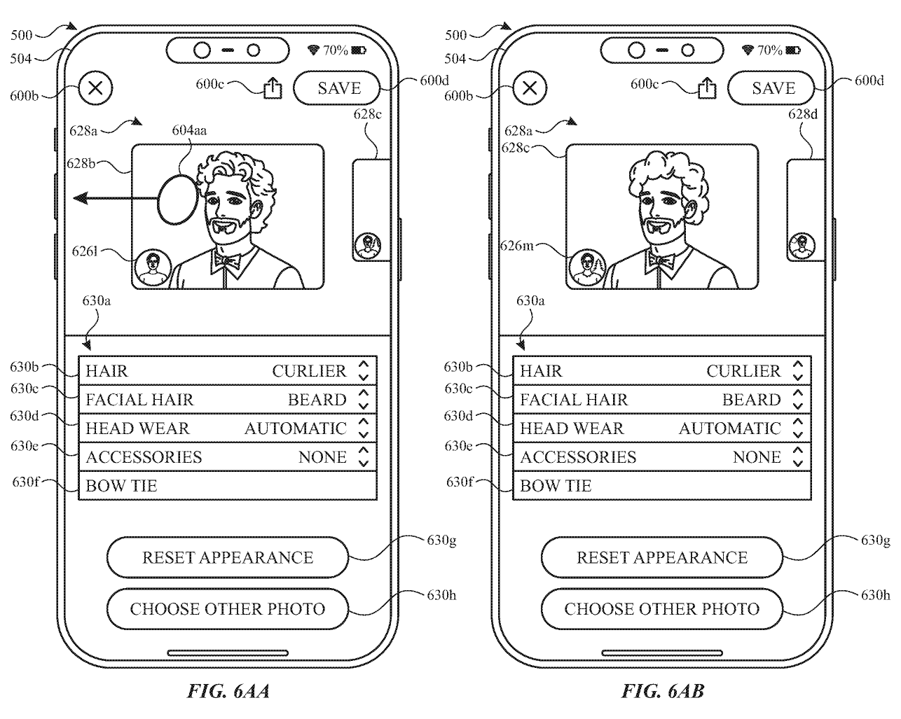

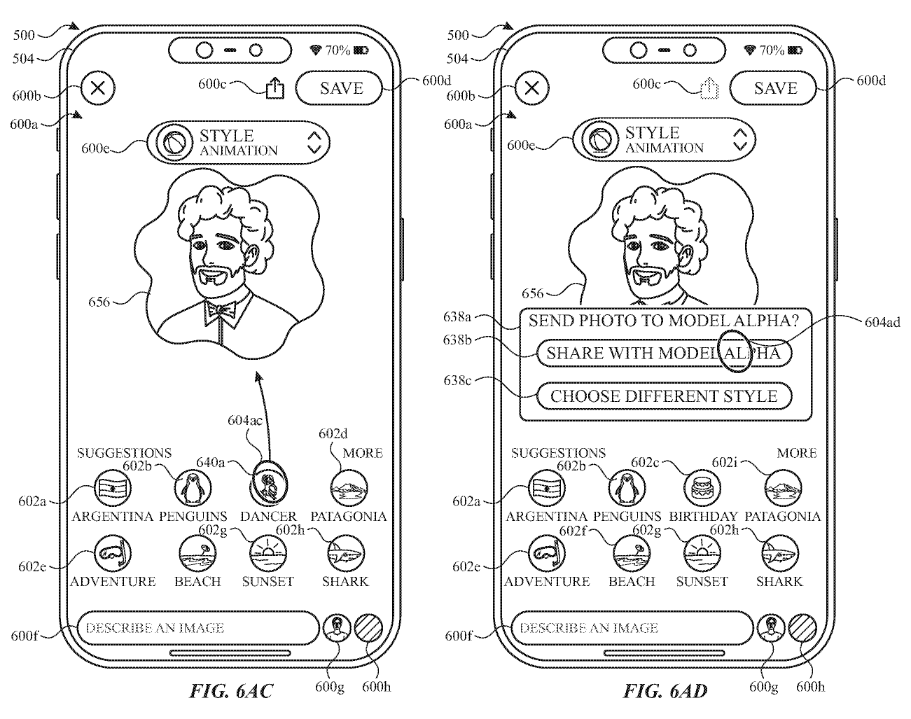

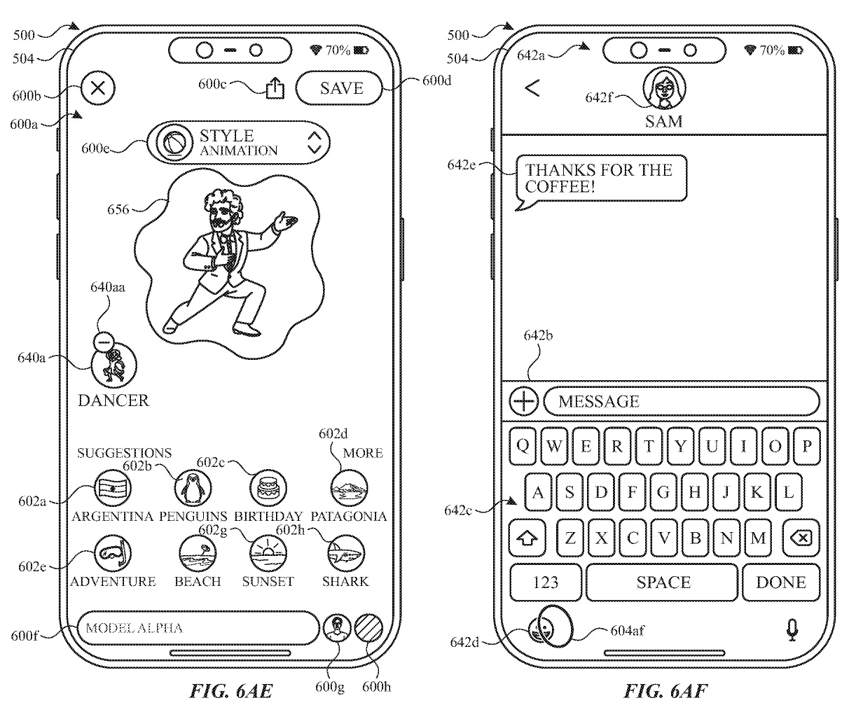

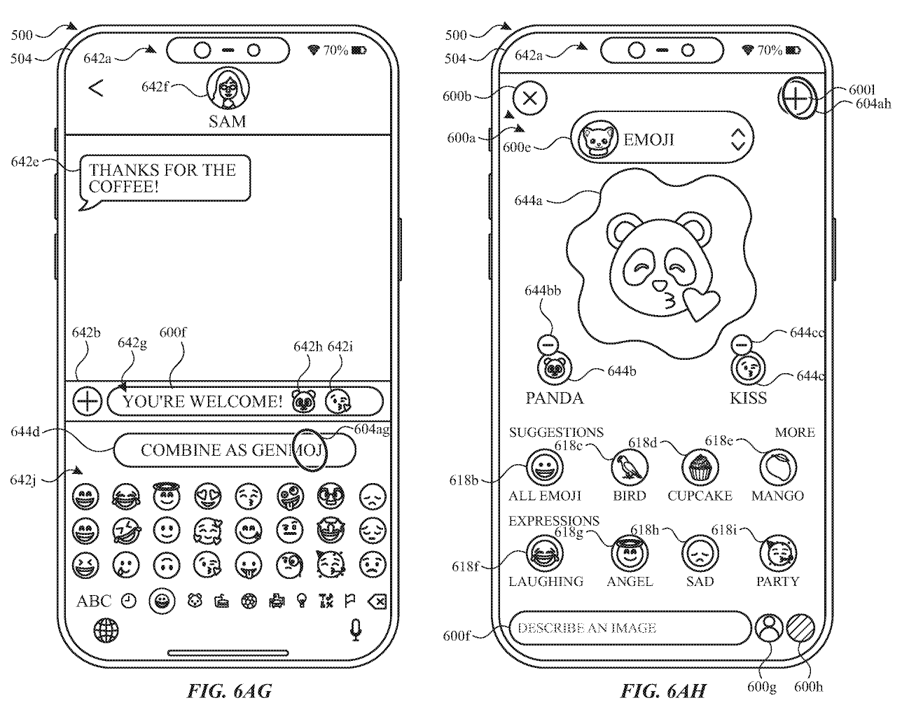

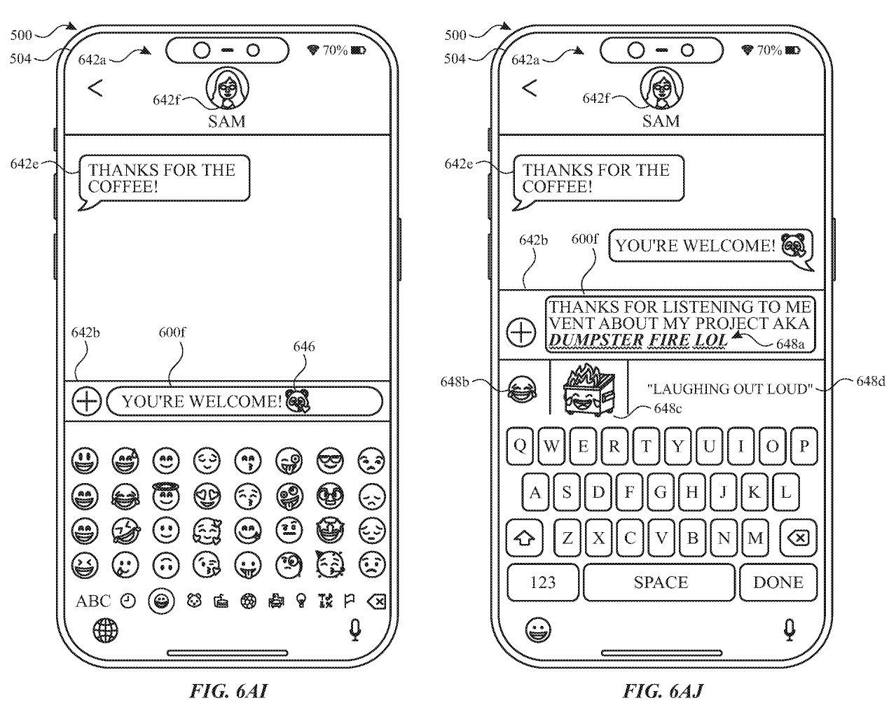

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700, 800, 1000, and 1200, (FIGS. 6, 8, 10, and 12) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

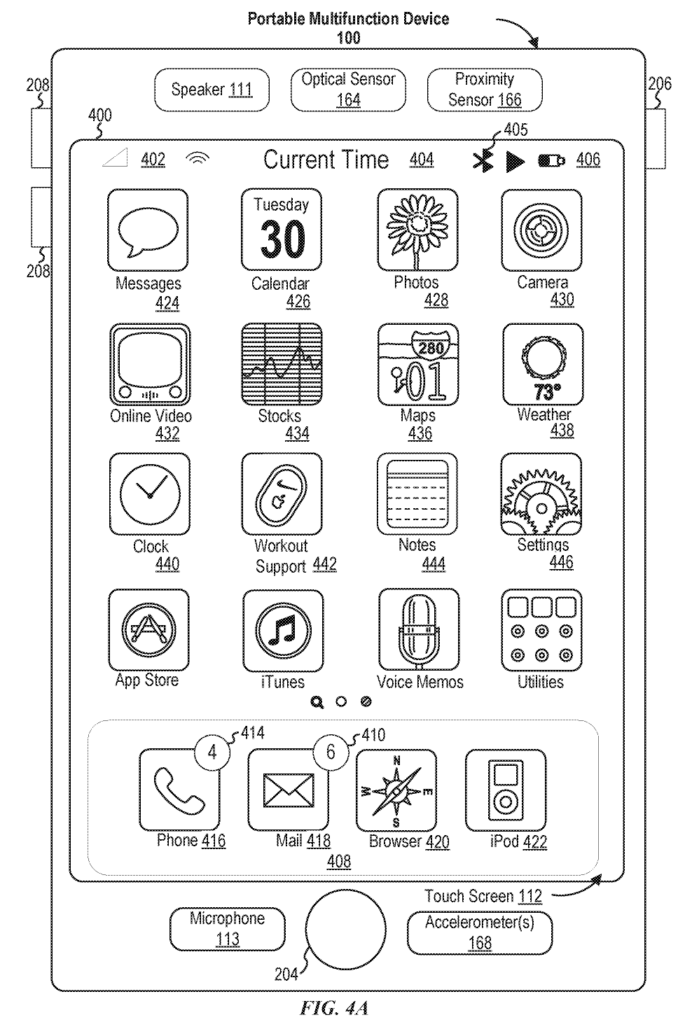

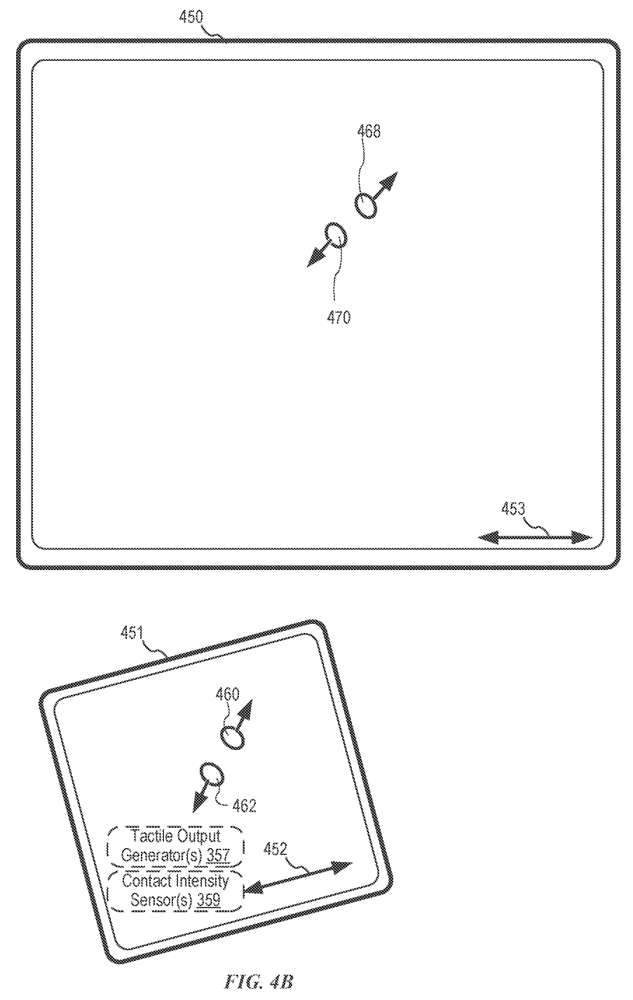

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300,FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term "focus selector" refers to an input element that indicates a current part of a user interface with which a user is interacting. In some implementations that include a cursor or other location marker, the cursor acts as a "focus selector," so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a "focus selector," so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term "characteristic intensity" of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a "down stroke" of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an "up stroke" of the respective press input).

In some embodiments, the device employs intensity hysteresis to avoid accidental inputs sometimes termed "jitter," where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an "up stroke" of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

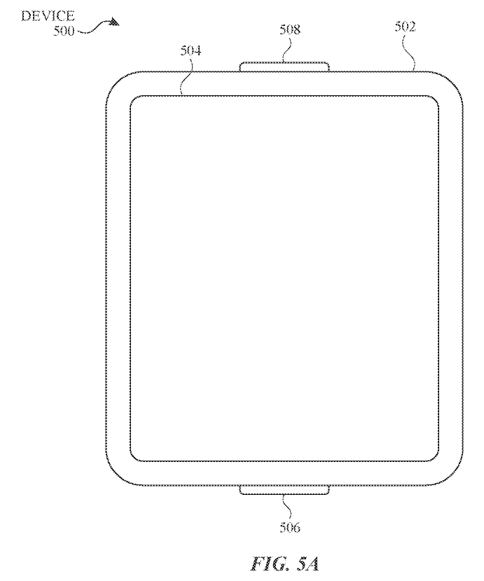

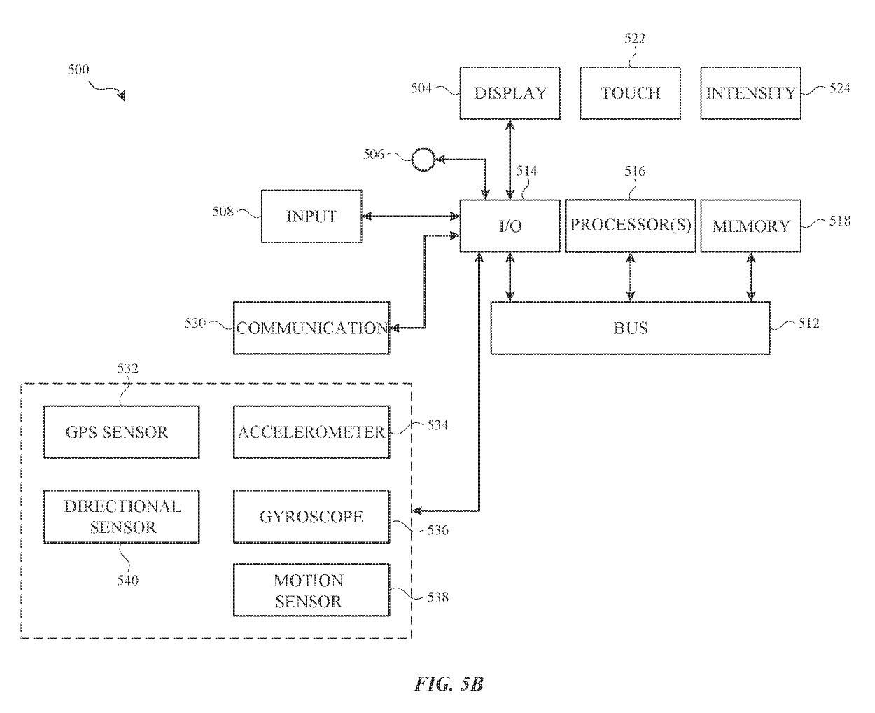

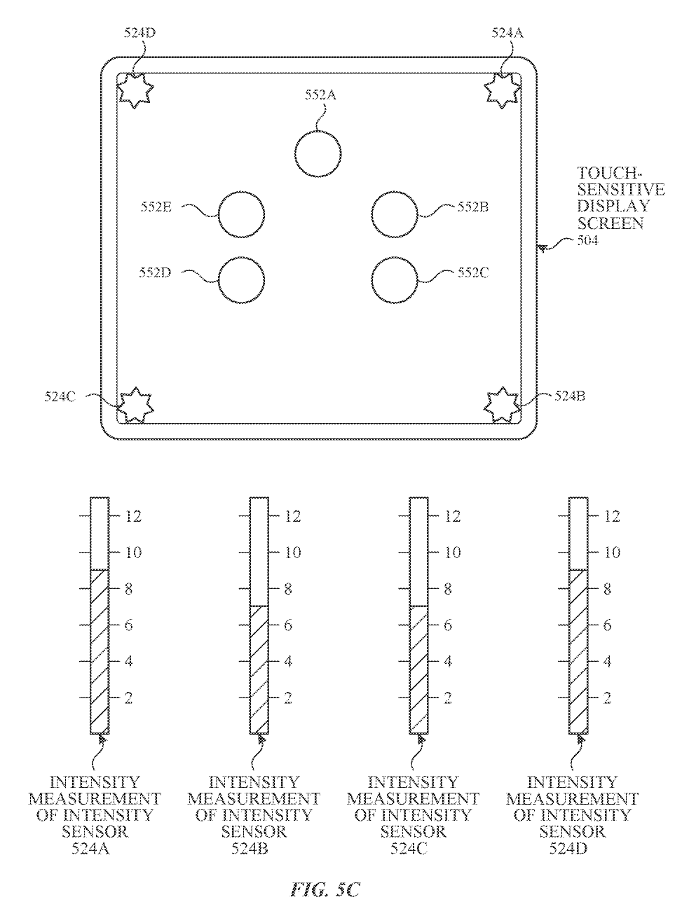

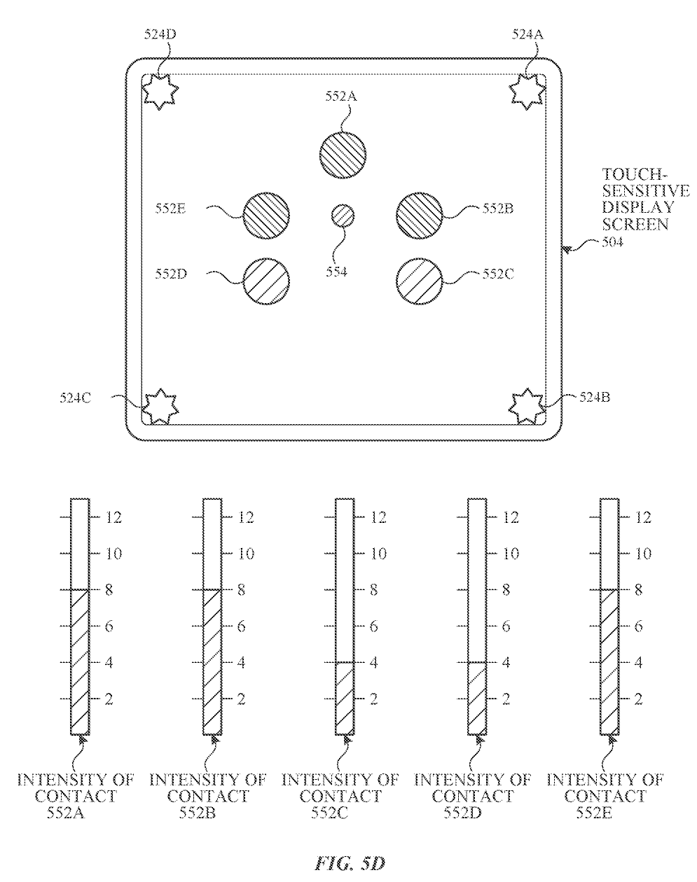

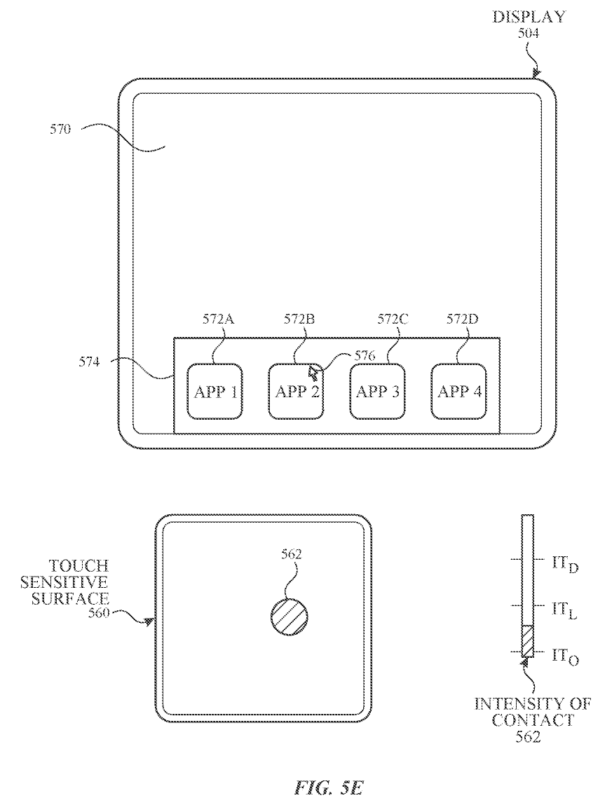

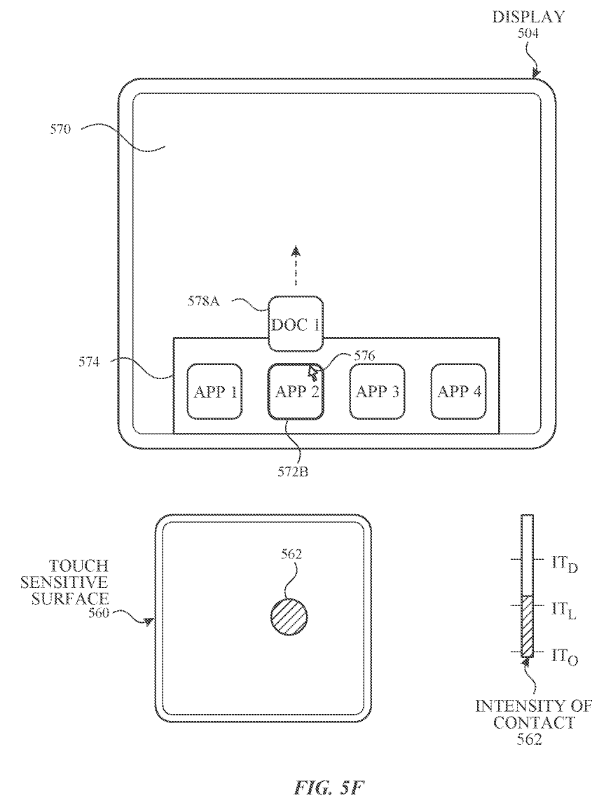

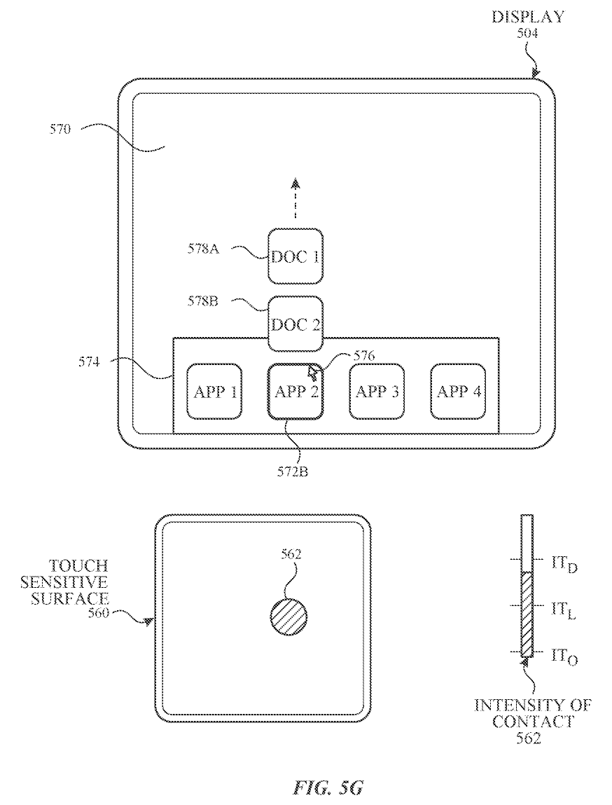

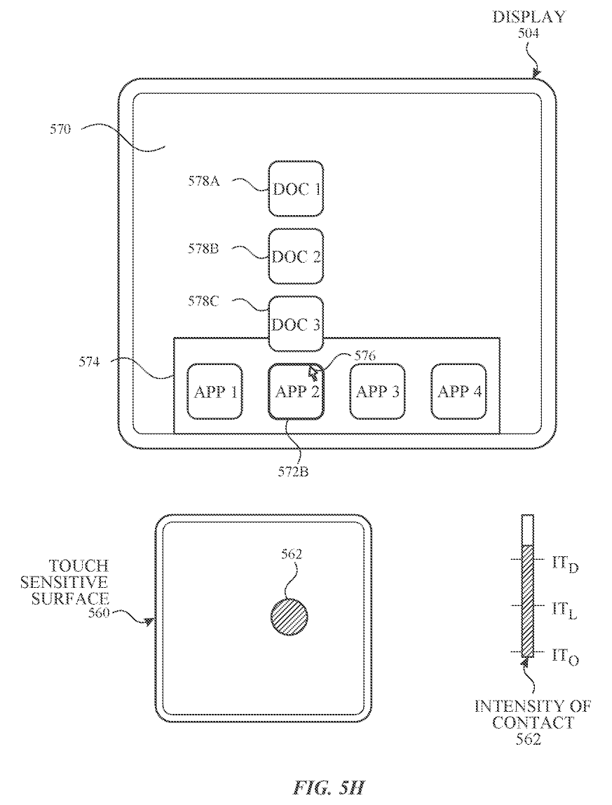

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 516 optionally execute any number of programs stored in memory 506 or storage, which optionally includes instructions to perform one or more of the methods and/or processes described herein (e.g., methods 700, 800, 1000, and/or 1200). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user’s intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij = A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

In some embodiments, the processes described herein to generate automatically-generated visual media using a machine learning (ML) model (“visual media generation using an ML model process”), to make automatically-generated visual media accessible in different locations (“automatically-generated visual media saving process”), to allow for an automatically-generated visual media item to be re-sized in accordance with a drag input and/or to generate a different appearance of an automatically-generated visual media item in response to a same prompt and different appearance parameter associated with a respective user interface, can be deployed as one or more generative models, where content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content. Automatically-generated content optionally includes deterministically generated content that is generated by one or more computer systems and/or non-deterministically generated content that is generated automatically by one or more computer systems.

In some embodiments, automatically-generated content that is generated using a non-deterministic process is referred to as generative content (e.g., generative images, generative graphics, generative video, generative audio, and/or generative text). Generative content is typically generated by an automated process based on a prompt that is provided to the automated process. In some embodiments, the automated process is a Machine Learning (ML) process. An ML process typically uses one or more ML models to generate an output based on an input. An ML process optionally includes one or more pre-processing steps to adjust the input before it is used by the ML model to generate an output (e.g., adjustment to a user-provided prompt, creation of a system-generated prompt, and/or ML model selection). Generative content can, in some embodiments, be generated using a non-deterministic process that generates content using one or more automatic steps that include specific rules and steps for processing a prompt including one or more non-deterministic steps that introduce novel generative elements into the content that is generated. An ML process optionally includes one or more post-processing steps to adjust the output by the ML model (e.g., passing ML model output to a different ML model, upscaling, downscaling, cropping, formatting, and/or adding or removing metadata) before the output of the ML model used for other purposes such as being provided to a different software process for further processing or being presented (e.g., visually or audibly) to a user. An ML process that generates generative content is sometimes referred to as a generative ML process.

A prompt for generating generative content can include one or more of: one or more words (e.g., a natural language prompt that is written or spoken), one or more images, one or more drawings, and/or one or more videos. ML processes can include neural networks, linear regression, decision trees, support vector machines (SVMs), Naive Bayes, and k-nearest neighbors. Neural networks can include transformer-based deep neural networks such as large language models (LLMs) that are trained using supervised, unsupervised, reinforcement, and/or other learning techniques. Generative pre-trained transformer models are a type of LLM that can be effective at generating novel generative content based on a prompt. Some ML processes use a prompt that includes text to generate either different generative text, generative audio content, and/or generative visual content. Some ML processes use a prompt that includes visual content and/or an audio content to generate generative text (e.g., a transcription of audio and/or a description of the visual content). Some multi-modal ML processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an ML process that include phrasing, a specified style, relevant context (e.g., starting point content and/or one or more examples), and/or a role for the ML process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseudo-random seed content is used as a starting point for creating the generative content). For example when generating an image from a diffusion model, a random noise pattern is iteratively denoised based on the prompt to generate an image that is based on the prompt. While specific types of ML processes have been described herein, it should be understood that a variety of different ML processes could be used to generate generative content based on a prompt.

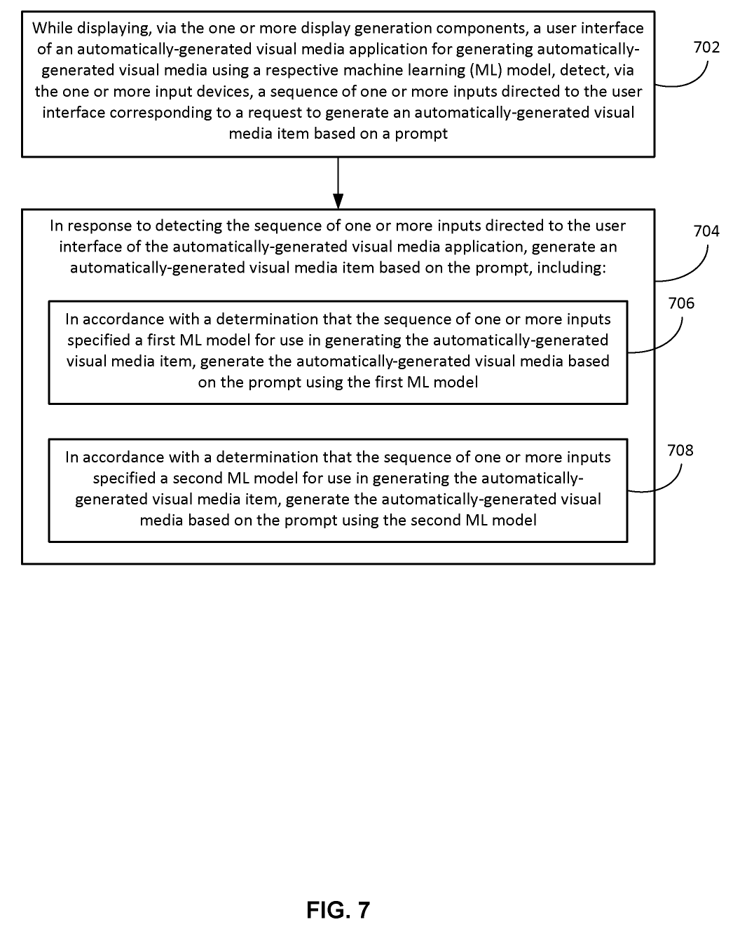

FIGS. 6A-6AJ illustrate exemplary ways in which an electronic device generates automatically -generated visual media using a machine learning (ML) model in accordance with some embodiments of the disclosure. The embodiments in these figures are used to illustrate the processes described below, including the processes described with reference to FIG. 7. Although FIGS. 6A-6AJ illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6AJ.

Users interact with electronic devices in many different manners. In some embodiments, an electronic device 500 is in communication with one or more display generation components 504 and one or more input devices described in detail with reference to method 700 in FIG. 7. The embodiments described below provide ways in which the electronic device generates automatically-generated visual media using a ML model (e.g., described in more detail below and with reference to method 700). For example, displaying a user interface for generating automatically-generated visual media using one or more ML models enables a user to quickly and conveniently access different ML models, without having to use additional inputs to navigate to a user interface of a ML model, thereby providing more direct interaction with the ML model to the user, reducing the need for additional inputs to display a user interface of the ML model, and avoiding erroneous inputs related to searching for the ML model which reduces power usage and improves battery life of the electronic device by enabling the user to use the electronic device more quickly and efficiently. It is understood that people use devices. When a person uses a device, that person is optionally referred to as a user of the device.

FIG. 6A illustrates an electronic device 500 with a display generation component 504 (e.g., a touchscreen). In some embodiments, the electronic device 500 is a mobile device, such as a smartphone, tablet, wearable device, or any of the devices described in method 700. In some embodiments, the electronic device 500 displays, via the display generation component 504, a plurality of different user interfaces of applications associated with the electronic device 500. For example, in FIG. 6A, the electronic device 500 displays, via display generation component 504, a visual media creation user interface 600a of an automatically-generated visual media application. In some embodiments, the visual media creation user interface 600a of an automatically-generated visual media application includes a plurality of user interface components or user interface elements (e.g., menus, fields, icons, buttons, options, or other elements) that are selectable to initiate a process for generating automatically-generated visual media based on a prompt using a ML model. In some embodiments, the electronic device 500 initiates the process for generating automatically-generated visual media in response to detecting (or, optionally, receiving) a prompt for use in generating automatically-generated visual media. In some embodiments, the prompt includes one or more prompt components and these prompt components include text, keywords, images, video, special characters, visual media, and/or other inputs describing a concept (e.g., style, theme, mood, activity, costume, accessory, places, graphics, or visual characteristic that will influence the generation of the automatically-generated visual media). In some embodiments, the one or more prompt components include computer-generated suggested concepts (or, optionally referred to as predefined concepts) or recognized concepts. For example, in FIG. 6A, the visual media creation user interface 600a includes a set of prompt components 602a through 602h corresponding to computer-generated suggested concepts. For example, a respective prompt component (e.g., prompt component 602a, prompt component 602b, prompt component 602c, prompt component 602d, prompt component 602e, prompt component 602f, prompt component 602g, or prompt component 602h) is selectable (e.g., via various input methods described below, and in more detail, in method 700) to cause the electronic device 500 to use a corresponding computer-generated suggested concept (e.g., Argentina, penguins, dog, Patagonia, adventure, beach, sunset, or shark) as basis or influence for generating an automatically-generated visual media.

The visual media creation user interface 600a also includes content entry field 600f that, when selected (e.g., via various input methods described below, and in more detail, in method 700), causes the electronic device 500 to display, via display generation component 504, a soft keyboard (e.g., described in more detail below with reference to FIG. 6H) for inputting a textual description and/or one or more emojis that is used as a prompt component for use in generating an automatically-generated visual media. The visual media creation user interface 600a also includes a subject prompt component option 600g that, when selected, causes the electronic device 500 to display a user interface component (e.g., subject personalization user interface component 626a in FIG. 6U described in more detail below). In some embodiments, the subject personalization user interface component 626a includes one or more options for selecting a subject as the focus or basis of the automatically-generated visual media. In some embodiments, the visual media creation user interface 600a also includes an add photo prompt component option 600h that, when selected, causes the electronic device 500 to initiate a process to take a photo of a subject for inclusion in the prompt for generating the automatically-generated visual media; or initiate a process to select a photo of a subject from a photo library for inclusion in the prompt for generating the automatically-generated visual media. The visual media creation user interface 600a also includes a style prompt component option 600e that, when selected, causes the electronic device 500 to display a user interface component (e.g., style selector user interface component 608a in FIG. 6C described in more detail below). In some embodiments, the style selector user interface component 608a includes one or more options for selecting a style provided by a respective ML model (e.g., a first ML model, a second ML model, or other ML model described in more detail in method 700) that defines a visual characteristic used for generating the automatically-generated visual media. In some embodiments, the visual media creation user interface 600a also includes a generation status indication 600i indicative of the electronic device 500 being ready to receive a prompt for generating the automatically-generated visual media. In some embodiments, the visual media creation user interface 600a also includes a close user interface element 600b that, when selected, causes the electronic device 500 to close (e.g., cease to display) the visual media creation user interface 600a; a share user interface element 600c that, when selected, causes the electronic device 500 to initiate a process to share, copy, or print the automatically-generated visual media; and a save user interface element 600d that, when selected, causes the electronic device 500 to make the automatically-generated visual media accessible at a respective location (e.g., a first location, a second location, or other location described in more detail with reference to FIGS. 6E-6S and method 700). In some embodiments, and as shown in FIG. 6A, the share user interface element 600c and the save user interface element 600c are disabled or not selectable to perform a respective action (e.g., initiate the process to share, copy, or print the automatically-generated visual media; or cause the electronic device 500 to make the automatically-generated visual media accessible at the respective location). In some embodiments, the electronic device 500 changes the states of the share user interface element 600c and the save user interface element 600c from disabled to enabled or active after generating the automatically-generated visual media as described in FIG. 6B.

In some embodiments, the electronic device 500 determines a request to generate an automatically-generated visual media item based on a prompt that includes one or more prompt components. For example, the electronic device 500 identifies the request to generate an automatically-generated visual media item in response to detecting a sequence of one or more inputs to add one or more prompt components. For example, in FIG. 6A, the sequence of one or more inputs to add one or more prompt components include a dragging input with contact 604a (e.g., a tap or long press input) directed to prompt component 602c followed by movement of the contact 604a. Although contact 604a is illustrated as a touch input, it should be understood that dragging inputs are not limited to touch inputs. Other types of dragging inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 700, are possible. In some embodiments, the sequence of one or more inputs to add one or more prompt components include one or more text entry (or handwritten) inputs using a soft keyboard user interface element, a physical (or hardware) keyboard, touchpad, stylus, and/or dictation corresponding to entry of content, such as content 600ff (e.g., “surfing”) into content entry field 600f in FIG. 6A. In some embodiments, and as shown in FIG. 6B, in response to detecting the sequence of one or more inputs, the electronic device 500 generates a first automatically-generated visual media item based on a prompt that includes prompt component 602c, content 600ff, and one or more other components described below. In FIG. 6B, the electronic device 500 displays in the visual media creation user interface 600a a preview 606e of the first automatically-generated visual media item. The visual media creation user interface 600a also includes prompt component 602c and a deletion user interface element 606cc associated with the prompt component 602c that, when selected, causes the electronic device 500 to remove the prompt component 602c from the prompt for generating automatically-generated visual media. The visual media creation user interface 600a also includes prompt component 606d corresponding to content 600ff of FIG. 6A, and a deletion user interface element 606dd that, when selected, causes the electronic device 500 to remove the prompt component 602c from the prompt for generating automatically-generated visual media. In some embodiments, in response to detecting the sequence of one or more inputs (e.g., corresponding to a request to add the prompt component 602c as described in more detail with reference to FIG. 6A), the electronic device 500 displays in the visual media creation user interface 600a prompt component 602i corresponding to computer-generated suggested concept (e.g., hiker), as shown in FIG. 6B.

In some embodiments, the prompt also specifies a first style (e.g., animation) provided by a first ML model used to give the first automatically-generated visual media item a particular aesthetic appearance or overall artistic look, such as the animation inspired aesthetic shown in the preview 606e of the first automatically-generated visual media item in FIG. 6B. In some embodiments, the prompt also includes other prompt components added in a manner similar to adding prompt component 602c and prompt component 606d corresponding to content 600ff described in FIG. 6A. For example, and as shown in FIG. 6B, the other prompt components include prompt component 606a and associated deletion user interface element 606aa and prompt component 606d and associated deletion user interface element 606bb. In some embodiments, prompt component 606a and associated deletion user interface element 606aa have one or more characteristics of prompt component 602c and deletion user interface element 606cc. In some embodiments, prompt component 606b and associated deletion user interface element 606bb have one or more characteristics of prompt component 602d and deletion user interface element 606dd. In some embodiments, while the electronic device 500 displays the preview 606e of the first automatically-generated visual media item in FIG. 6B, the electronic device 500 enables the share user interface element 600c and the save user interface element 600d such that these elements are selectable to initiate the process to share, copy, or print the automatically-generated visual media; or cause the electronic device 500 to make the automatically-generated visual media accessible at the respective location, respectively.

In some embodiments, the electronic device 500 detects a request to change the style and/or ML model used for generating the automatically-generated visual media. For example, in FIG. 6B, the electronic device detects a selection input with contact 604h (e.g., a tap or long press input) directed to style prompt component option 600e. Although contact 604h is illustrated as a touch input, it should be understood that selection inputs are not limited to touch inputs. Other types of selection inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 700, are possible. In some embodiments, in response to detecting this selection input directed to style prompt component option 600e, the electronic device 500 displays in visual media content creation user interface 600a a style selector user interface component 608a, as shown in FIG. 6C. The style user interface component 608a is a menu-type user interface component that includes a plurality of selectable options corresponding to a plurality of visual styles (e.g., animation, illustration, sketch, emoji, anime, pixel art, or natural) and respective ML model (e.g., built-in ML model described in more detail below with reference to ML models integrated with the operating system of the electronic device, model alpha, or model omega) for use in generating the automatically-generated visual media based on the selected visual style and ML model. For example, and as shown in FIG. 6C, the style selection user interface component 608a includes style options 608b through 608h corresponding to different styles and ML models. For example, a respective style option (e.g., style option 608b, style option 608c, style option 608d, style option 608e, style option 608f, style option 608g, or style option 608h) is selectable (e.g., via various input methods described below, and in more detail, in method 700) to cause the electronic device 500 to use a corresponding style and ML model (e.g., animation provided by the built-in ML model, illustration provided by the built-in ML model, sketch provided by the built-in ML model, emoji provided by the built-in ML model, anime provided by the model alpha, pixel art provided by the model omega, or natural provided by the model omega) as the stylistic basis for generating automatically-generated visual media.

In some embodiments, the respective style option includes an indication of the ML model. For example, in FIG. 6C, style option 608f identifies a first ML model (e.g., model alpha) used to generate the automatically-generated visual media in the visual style (e.g., Anime) corresponding to style option 608f. In some embodiments, the style selection user interface component 608a includes a plurality of different visual styles and ML models. For example, in FIG. 6C, the style selection user interface component 608a includes style option 608g provided by a second ML model (e.g., model omega) different from the first ML model (e.g., model alpha) used for generating automatically-generated visual media in the visual style (e.g., Anime) corresponding to style option 608f. In some embodiments, the first ML model and the second ML model are not built-in the electronic device and/or integrated with the operating system of the electronic device. In some embodiments, the style option does not include an indication of an associated ML model. For example, in FIG. 6C, style options 608b through 608e do not include an indication of an ML model used to generate the automatically-generated visual media in the respective visual style (e.g., animation, illustration, sketch, or emoji). In some embodiments, when the style option does not include an indication of an associated ML model, the ML model is built-in the electronic device and/or integrated with the operating system of the electronic device. In some embodiments, the style selection user interface component 608a includes an indication (e.g., checkmark icon 608i) of the currently selected style option 608b, as shown in FIG. 6C.

In some embodiments, and as shown in FIG. 6C, the electronic device identifies the request to change the style and/or ML model used for generating the automatically-generated visual media when the electronic device detects a selection input with contact 604c (e.g., a tap or long press input) directed to style option 608f. Other selection inputs are supported and described in more detail below at least with reference to method 700. In some embodiments, in response to detecting this selection input directed to style option 608f, the electronic device 500 displays a preview 606f of a second automatically-generated visual media item based on the visual style (e.g., Anime). The electronic device 500 also updates the style prompt component option 600e to indicate the currently selected style option 608f, such as an indication that includes a visual indication (e.g., logo or graphic) and a label (e.g., Anime – Model Alpha), as shown in FIG. 6D. In some embodiments, the electronic device 500 displays an indication of the ML model currently being used for generating the automatically-generated visual media. For example, in FIG. 6D, the electronic device 500 replaces the placeholder text of the content entry field 600f (e.g., “Describe an image”) with an identifier of the ML model (e.g., “model alpha”). In some embodiments, and as shown in FIG. 6D, the prompt used in generating the second automatically-generated visual media includes one or more same prompt components (e.g., prompt components 606a through 606d) as the prompt used in generating the first automatically-generated visual media item (e.g., preview 606e of the first automatically-generated visual media item in FIG. 6B). In FIG. 6D, the visual style of the preview 606f of the second automatically-generated visual media is different from the visual style of the preview 606e of the first automatically-generated visual media item.

In some embodiments, in FIG. 6D, the electronic device 500 detects a selection input with contact 604d (e.g., a tap or long press input) directed to the preview 606f of the second automatically-generated visual media. Although contact 604d is illustrated as a touch input, it should be understood that selection inputs are not limited to touch inputs. Other types of selection inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 700, are possible. In some embodiments, in response to detecting this selection input directed to the preview 606f of the second automatically-generated visual media, the electronic device 500 displays, via the display generation component 504, a variants user interface 600j, as shown in FIG. 6E. Additionally or alternatively, and as shown in FIGS. 6L and 6M, the electronic device 500 tracks an amount of time that has elapsed since an input was last detected, and in some embodiments, when the electronic device 500 determines that the amount of time exceeds a time threshold (e.g., 5, 10, 20, 30, 40, 60, or 120 seconds), the electronic device 500 displays the variants user interface 600j, as shown in FIG. 6E.

In FIG. 6E, the variants user interface 600j is a user interface of the automatically-generated visual media application and includes one or more of the same user interface elements or components, and/or options as the visual media creation user interface 600a in FIG. 6D (e.g., prompt component 602a, prompt component 602b, prompt components 602d through 602i, content entry field 600f, subject prompt component option 600g, add photo prompt component option 600h, close user interface element 600b, share user interface element 600c, save user interface element 600d, and/or prompt component 602i). Variants user interface 600j also includes a preview 610a of the second automatically-generated visual media item. In some embodiments, the preview 610a of the second automatically-generated visual media item displayed in the variants user interface 600j in FIG. 6E is a size larger than the size of the preview 606f of the second automatically-generated visual media item displayed in the visual media creation user interface 600a in FIG. 6D. For example, in FIG. 6E, the preview 610a of the second automatically-generated visual media item includes more of the background than the background of the preview 606f of the second automatically-generated visual media item displayed in the visual media creation user interface 600a in FIG. 6D. In some embodiments the preview representation 610a is displayed in a visible or invisible content container where different previews of respective automatically-generated visual media items are displayed. In some embodiments, the preview 610a of the second automatically-generated visual media item has one or more characteristics of the preview of the automatically-generated visual media item described in method(s) 1000 and/or 1200. In FIG. 6E, the electronic device 500 displays indicator 610c corresponding to a number of automatically-generated visual media items generated based on the prompt. In FIG. 6E, the electronic device displays indicator 610c as a series of dot images where a solid dot denotes the currently displayed preview 610a of the second automatically-generated visual media, and outlines of dots denote other previews of other automatically-generated visual media.

In FIG. 6E, the electronic device 500 detects a selection input with contact 604e (e.g., a tap or long press input) directed to save user interface element 600d. Other selection inputs are supported and described in more detail below at least with reference to method 700. In some embodiments, in response to detecting this selection input directed to save user interface element 600d, the electronic device 500 makes the second automatically-generated visual media item accessible at a location associated with the automatically-generated visual media application, such as an automatically-generated visual media library user interface 624a of the automatically-generated visual media application described in more detail with reference to FIG. 6S. In some embodiments, the electronic device 500 saves automatically-generated visual media to different locations based on the prompt as described in FIGS. 6O-6S, and in more detail, in method 700. In some embodiments, the electronic device 500 provides quick access to the saved automatically-generated visual media in appropriate locations at which the saved automatically-generated visual media is most likely to be used/accessed by the user of the electronic device. In some embodiments, in response to detecting the selection input with contact 604e directed to the save user interface element 600d in FIG. 6E, the electronic device 500 maintains display of the variants user interface 600j and changes the appearance of the save user interface element 600d to a confirmation indicator 600k indicative of saving the automatically-generated visual media item, as shown in FIG. 6F. In some embodiments, ceasing display of the variants user interface 600j causes the removal of the prompt including the prompt components used in generating the preview 610b of the second automatically-generated visual media. Thus, in some embodiments, forgoing navigating to the location associated with the automatically-generated visual media application in response to detecting the selection input with contact 604e directed to the save user interface element 600d avoids the need for additional input to reenter prompt components to the prompt for use in generating automatically-generated visual media.

In FIG. 6F, the electronic device 500 detects a navigation input with contact 604f (e.g., a tap or long press input) directed to the preview 610a of the second automatically-generated visual media item followed by movement of contact 604f, and a lifting of contact 604f from the display generation component 504. In some embodiments, the navigation input with contact 604f is a swipe gesture (e.g., as described in more detail in method 700) or other navigation input that indicates a direction of navigation such as indicating a next input with selection of a right arrow key and a previous input with selection of a left arrow key on an input device or soft keyboard. Although contact 604f is illustrated as a touch input, it should be understood that navigation inputs are not limited to touch inputs. Other types of navigation inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 700, are possible.

In some embodiments, in response to detecting the navigation input with contact 604f directed to the preview 610a of the second automatically-generated visual media item, the electronic device 500 moves the preview 610a of the second automatically-generated visual media item off a display area of the variants user interface 600j and moves the preview 610b of a third automatically-generated visual media item into the display area as shown in FIG. 6G. In FIG. 6G, the electronic device 500 updates indicator 610c such that the dot image corresponding to the preview 610b of the third automatically-generated visual media item includes a solid visual appearance indicative of the preview 610b of the third automatically-generated visual media item being currently displayed. The electronic device 500 also updates the dot image corresponding to the preview 610a of the second automatically-generated visual media item with an outline visual appearance indicative of the preview 610a of the second automatically-generated visual media item not being currently displayed. In some embodiments, while displaying the variants user interface 600j in FIG. 6G, the electronic device 500 detects a selection input with contact 604g (e.g., a tap or long press input) directed to content entry field 600f. Although contact 604g is illustrated as a touch input, it should be understood that selection inputs are not limited to touch inputs. Other types of selection inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 700, are possible. In some embodiments, in response to detecting this selection input in FIG. 6G, the electronic device 500 ceases displaying the variants user interface 600j, and displays the visual media creation user interface 600a including soft keyboard user interface element 650, as shown in FIG. 6H. The visual media creation user interface 600a also includes a preview 606g of the third automatically-generated visual media item. In some embodiments, the preview 606g of the third automatically-generated visual item has one or more characteristics of the preview 606f of the second automatically-generated visual media item in FIG. 6D.

In some embodiments, the electronic device 500 detects one or more text entry inputs directed to the keyboard user interface element 650 corresponding to a request to add a prompt component that includes content 612 (e.g., “pixel art”) and in response, the electronic device 500 displays the content 612 in the content entry field 600f. In some embodiments, while the electronic device 500 displays the content 612 in the content entry field 600f, the electronic device 500 detects a selection input with contact 604h directed to a submit option 652, and in response to detecting this selection input, the electronic device 500 displays in the visual media creation user interface 600a a notification 614a, as shown in FIG. 6I. For example, the electronic device 500 determines that content 612 is a visual style provided by an ML model different from the current ML model being used to generate automatically-generated visual media. In some embodiments, in accordance with this determination, the electronic device 500 displays the notification 614a in FIG. 6I. In some embodiments, the notification 614a includes information identifying the ML (e.g., model omega) and a first option 614b that, when selected, causes the electronic device 500 to transmit the prompt including visual style to the ML model. In some embodiments, the notification 614a includes a second option 614c that, when selected causes the electronic device 500 to display the style prompt component option 600e described with reference to FIG. 6C and/or forgo initiating the process to generate automatically-generated visual media using the entered visual style (e.g., maintain using the currently selected ML model). In some embodiments, the content included in notification 614a notifies the user that in prior to transmitting the prompt to the ML model for use in generating automatically-generated visual media using the entered style, the electronic device 500 requires permission from the user of the electronic device to share the prompt with the ML model. In some embodiments, the electronic device 500 detects a selection input with contact 604i (e.g., a tap or long press input) directed to the first option 614b. Other selection inputs are supported and described in more detail below at least with reference to method 700. In some embodiments, in response to detecting this selection input directed to the first option 614b, the electronic device 500 generates a fourth automatically-generated visual media item including displaying in the visual media creation user interface 600a preview 606h of the fourth automatically-generated visual media item. In some embodiments, the electronic device 500 also updates the style prompt component option 600e to indicate the newly selected ML model, such as displaying a visual indication (e.g., logo or graphic) and a label (e.g., “Pixel Art – Model Omega”), as shown in FIG. 6J. In some embodiments, the electronic device 500 also changes the placeholder text of the content entry field 600f to include this ML model. In some embodiments, and as shown in FIG. 6J, the prompt used in generating the preview 606h of the fourth automatically-generated visual media item includes one or more same prompt components (e.g., prompt components 606a through 606d) as the prompt used in generating the third automatically-generated visual media item (e.g., preview 606g of the third automatically-generated visual media item in FIG. 6H). In FIG. 6J, the visual style of the preview 606h of the fourth automatically-generated visual media item is different from the visual style of the preview 606g of the third automatically-generated visual media item.

In FIG. 6J, the electronic device 500 detects a selection input with contact 604j (e.g., a tap or long press input) directed to save user interface element 600d. Although contact 604j is illustrated as a touch input, it should be understood that selection inputs are not limited to touch inputs. Other types of selection inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 700, are possible. In some embodiments, in response to detecting this selection input directed to save user interface element 600d, the electronic device 500 makes the fourth automatically-generated visual media item accessible at a location associated with the automatically-generated visual media application, such as an automatically-generated visual media library user interface 624a of the automatically-generated visual media application described in more detail with reference to FIG. 6S. In some embodiments, the electronic device 500 detects a selection input with contact 654 (e.g., a tap or long press input) directed to style prompt component option 600e, and in response to detecting this selection input, the electronic device 500 displays in the visual media creation user interface 600a the style selector user interface component 608a, as shown in FIG. 6K. In some embodiments, while the electronic device 500 displays the style selector user interface component 608a, the electronic device 500 detects a selection input with contact 604k directed to style option 608e corresponding to an emoji style. In some embodiments, in response to detecting this selection input directed to style option 608e, the electronic device 500 displays a preview 606i of a fifth automatically-generated visual media item based on the emoji style. The electronic device 500 also updates the style prompt component option 600e to indicate the currently selected style option 608e, such as an indication that includes a visual indication (e.g., logo or graphic) and a label (e.g., Emoji), as shown in FIG. 6L. In some embodiments, the electronic device 500 displays an indication of generating automatically-generated visual media based on the emoji style (e.g., automatically-generated emoji). For example, and as shown in FIG. 6L, the electronic device 500 changes the content of the save user interface element 600d to indicate the emoji style with the content “add emoji” as shown in FIG. 6L. In some embodiments, and as shown in FIG. 6D, the prompt used in generating the fifth automatically-generated visual media includes one or more same prompt components as the prompt used in generating the fourth automatically-generated visual media item (e.g., preview 606g of the fourth automatically-generated visual media item in FIG. 6H). For example, prompt components 616a through 616d in FIG. 6L correspond to prompt components 606a through 606d in FIG. 6H. In some embodiments, prompt components 616a through 616d have an emoji appearance because the emoji style is in use. In some embodiments, while the electronic device 500 is generating automatically-generated emojis, the electronic device 500 displays a set of emoji prompt components 618b through 618i corresponding to standard emojis (e.g., not automatically-generated emojis). In some embodiments, the set of emoji prompt components include a variety of different types of emojis (e.g., animals, food, expressions, and/or other emoji types). For example, emoji prompt components 618f through 618i include emoji expressions. In some embodiments, the set of emoji prompt components has one or more characteristics of the set of prompt components 602a through 602h in FIG. 6B.

In some embodiments, while the electronic device 500 displays the preview 606i of the fifth automatically-generated visual media item based on the emoji style (e.g., a automatically-generated emoji), the electronic device 500 determines that an amount of time that has elapsed since an input was last detected exceeds a time threshold (e.g., 5, 10, 20, 30, 40, 60, or 120 seconds). In some embodiments, in accordance with this determination, the electronic device 500 displays the variants user interface 600j, as shown in FIG. 6M. The variants user interface 600j in FIG. 6M has one or more characteristics of the variants user interface 600j on FIG. 6E. For example, in FIG. 6M, the variants user interface 600j is a user interface of the automatically-generated visual media application and includes one or more of the same user interface elements or components, and/or options as the visual media creation user interface 600a in FIG. 6L (e.g., , prompt components 618b through 618i, content entry field 600f, subject prompt component option 600g, add photo prompt component option 600h, close user interface element 600b, share user interface element 600c, and/or save user interface element 600d). Variants user interface 600j of FIG. 6M also includes a preview 620a of the fifth automatically-generated visual media item. In some embodiments, the preview 620a of the fifth automatically-generated visual media item displayed in the variants user interface 600j in FIG. 6M is a size larger than the size of the preview 606i of the fifth automatically-generated visual media item displayed in the visual media creation user interface 600a in FIG. 6L. In some embodiments, because the fifth automatically-generated visual media is an emoji style, previews 620a and 606i include minimal background, and conform with standard emoji styles. In some embodiments, preview 620a of the fifth automatically-generated visual media item has a shape different from the shape of the previews of automatically-generated visual media items that are not based on the emoji style, such as preview 610a of the first automatically-generated visual media item in FIG. 6E. For example, the preview 620a of the fifth automatically-generated visual media item in FIG. 6M has a circular shape, while the preview 610a of the first automatically-generated visual media item in FIG. 6E has a rectangular shape (e.g., to show more of the background of the first automatically-generated visual media described in more detail in method 700).

In FIG. 6M, the preview 620a of the fifth automatically-generated visual media item is displayed in a visible or invisible content container where different previews of respective automatically-generated visual media items are displayed. In some embodiments, this container has a different shape based on the visual style of the automatically-generated visual media item as described above with reference to FIGS. 6E and 6M. In FIG. 6M, the electronic device 500 displays indicator 610c corresponding to the number of automatically-generated visual media items currently available based on the prompt, as described in more detail with reference to FIG. 6E. In FIG. 6M, the electronic device 500 detects a navigation input with contact 604m (e.g., a tap or long press input) directed to the preview 620a of the fifth automatically-generated visual media item followed by movement of contact 604, and a lifting of contact 604f from the display generation component 504. In some embodiments, this navigation input has one or more characteristics of the navigation input with contact 604f directed to the preview 610a of the second automatically-generated visual media item described in FIG. 6F.

In some embodiments, in response to detecting the navigation input with contact 604m directed to the preview 620a of the fifth automatically-generated visual media item, the electronic device 500 ceases to display the preview 620a of the fifth automatically-generated visual media item or moves the preview 620a of the fifth automatically-generated visual media item off a display area of the variants user interface 600j and moves a preview 620b of a sixth automatically-generated visual media item into the display area as shown in FIG. 6N. In FIG. 6N, the electronic device 500 updates indicator 610c such that the dot image corresponding to the preview 620b of a sixth automatically-generated visual media item includes a solid visual appearance indicative of the preview 620b of a sixth automatically-generated visual media item being currently displayed. The electronic device 500 also updates the dot image corresponding to the preview 620a of the fifth automatically-generated visual media item with an outline visual appearance indicative the preview 620a of the fifth automatically-generated visual media item not being currently displayed. In some embodiments, while displaying preview 620b of a sixth automatically-generated visual media item in FIG. 6N, the electronic device 500 detects a selection input with contact 604n (e.g., a tap or long press input) directed to the save user interface element 600d. Other selection inputs are supported and described in more detail below at least with reference to method 700. In some embodiments, in response to detecting this selection input directed to save user interface element 600d in FIG. 6N, the electronic device 500 makes the sixth automatically-generated visual media item accessible at a second location, different from the location of the automatically-generated visual media library user interface 624a of the automatically-generated visual media application described in more detail with reference to FIG. 6R.

In some embodiments, the electronic device 500 saves automatically-generated visual media to different locations based on the prompt as described in FIGS. 6O-6S, and in more detail, in method 700. In some embodiments, in response to detecting the selection input with contact 604n directed to the save user interface element 600d, the electronic device 500 changes the appearance of the save user interface element 600d to an in-progress indicator 600m indicative of the on-going action of saving the automatically-generated visual media item, as shown in FIG. 6O. In some embodiments, the electronic device 500 also displays an animation. For example, in FIGS. 6P and 6Q, the electronic device 500 displays an animated effect 622 in which the fifth automatically-generated visual media item appears to be moving from a location within the variants user interface 600j to the second location (e.g., the soft keyboard user interface element 622a), as shown in FIG. 6Q. In some embodiments, the soft keyboard user interface element 622a is operating in the emoji mode and displays a plurality of automatically-generated emoji, such automatically-generated visual media 622b through 622d and automatically-generated visual media 622g through 622i. In some embodiments, the soft keyboard user interface element 622a also includes other media items, such as stickers 622e and 622f, as well as the standard emojis (e.g., not automatically-generated emojis). In some embodiments, after displaying the animated effect 622, the electronic device 500 displays the fifth automatically-generated visual media item within the soft keyboard user interface element 622a, as shown in FIG. 6R with a representation 622j of the fifth automatically-generated visual media item accessible within the soft keyboard user interface element 622a. Thus, in some embodiments, the electronic device 500 provides quick access to the saved automatically-generated visual media in appropriate locations at which the saved automatically-generated visual media is most likely to be used/accessed by the user of the electronic device. For example, and as shown in FIG. 6S, the electronic device 500 displays the automatically-generated visual media library user interface 624a of the automatically-generated visual media application that includes a plurality of saved automatically-generated visual media items 624b through 624g. In some embodiments, the plurality of saved automatically-generated visual media items accessible in the automatically-generated visual media library user interface 624a do not include emoji-based automatically-generated visual media items as described in more detail in method 700.

In some embodiments, while displaying the automatically-generated visual media library user interface 624a, the electronic device 500 detects a selection input with contact 604s directed to an option 624h, and in response, the electronic device 500 displays the visual media creation user interface 600a of an automatically-generated visual media application, as shown in FIG. 6T. The visual media creation user interface 600a in FIG. 6T has one or more characteristics of the visual media creation user interface 600a in FIG. 6A. In some embodiments, while displaying the visual media creation user interface 600a, the electronic device 500 detects a selection input with contact 604t directed to subject prompt component option 600g. Although contact 604s and 604t are illustrated as touch inputs, it should be understood that selection inputs are not limited to touch inputs. Other types of selection inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 700, are possible. In some embodiments, in response to detecting selection input with contact 604t directed to the subject prompt option 600g, the electronic device 500 displays in the visual media creation user interface 600a a subject personalization user interface component 626a in FIG. 6U. In some embodiments, the subject personalization user interface component 626a includes one or more options for selecting a subject as the focus or basis of the automatically-generated visual media. For example, in FIG. 6U, the subject personalization user interface component 626a includes a plurality of representations 626g through 626l corresponding to subjects selectable to be the focus of the automatically-generated visual media. The subject personalization user interface component 626a also includes additional options: option 626d that, when selected, causes the electronic device 500 to initiate a process to create a subject; option 626e that, when selected, causes the electronic device 500 to initiate a process to take a photo of a subject; option 626f that, when selected, causes the electronic device 500 to initiate a process to select a photo of a subject from a photo library; option 626b that, when selected, clears any selections or removes any prompt components from the prompt used for generating the automatically-generated visual media; and option 626c that, when selected, closes or ceases to display the subject personalization user interface component 626a.

In FIG. 6U, the electronic device 500 detects a selection input with contact 604u directed to representation 626n of a subject (e.g., Zach), and in response to detecting this selection input, the electronic device 500 displays a subject personalization user interface 628a of the automatically-generated visual media application, as shown in FIG. 6V. In some embodiments, the subject personalization user interface 628a includes a preview 628b of the subject that is based on a first visual reference 626l of the subject (e.g., a first photo of a set of one or more photos and/or videos of the subject as described in more detail in method 700). In some embodiments, the subject personalization user interface 628a also includes a preview 628c of the subject that is based on second visual reference of the subject, different from the first visual reference 626l of the subject. In some embodiments, the subject personalization user interface 628a also includes a first option 628d that, when selected, causes the electronic device 500 to display the subject personalization user interface element 630a in FIG. 6X. The subject personalization user interface 628a also includes a second option 628e that, when selected, causes the electronic device 500 to initiate a process to select a different visual reference of the subject (e.g., different set of one or more photos from the set of photos currently used as visual reference(s) for the subject).

In FIG. 6V, the electronic device 500 detects a selection input with contact 604v directed to the first option 628d, and in response to detecting this selection input, the electronic device 500 displays in the subject personalization user interface 628a the subject personalization user interface element 630a, as shown in FIG. 6W. In some embodiments, the subject personalization user interface element 630a includes a plurality of selectable options to customize the appearance of the subject, such as selectable options 630b through 630e corresponding to a respective category in which to customize the appearance of the subject (e.g., hair, facial hair, head wear, and/or accessories). In some embodiments, the subject personalization user interface element 630a also includes content entry field 630f for entering user-defined customization(s). In FIG. 6W, the electronic device 500 detects a selection input with contact 604 directed to selectable option 630b. Although contact 604w is illustrated as a touch input, it should be understood that selection inputs are not limited to touch inputs. Other types of selection inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 700, are possible. In some embodiments, in response to detecting this selection input in FIG. 6W, the electronic device 500 displays user interface sub-component 630bb (e.g., sub-menu) that includes particular selectable options 632a through 632e for the hair category in FIG. 6X. In some embodiments, in response to detecting a selection input with contact 604x directed to selectable option 632d in FIG. 6X, the electronic device 500 displays the preview 628b of the subject with a visual appearance corresponding to the selectable option 632d (e.g., curlier hair), also shown in FIG. 6X. In another example, in FIG. 6Y, the electronic device 500 detects a selection input with contact 604y directed to selectable option 634b, and in response to detecting this selection input, the electronic device 500 displays the preview 628b of the subject with a visual appearance corresponding to the selectable option 634b (e.g., beard).

In some embodiments, the electronic device 500 detects a selection input, such as contact 604w, for example, directed to content entry field 630f, and in response to detecting this input the electronic device 500 displays the soft keyboard user interface element 650 in FIG. 6Z. In some embodiments, and as shown in FIG. 6Z, the electronic device 500 detects one or more text entry inputs (e.g., selection input 604z) directed to the soft keyboard user interface element 650 corresponding to a request to add user-defined custom appearance that includes content 636 and in response, the electronic device 500 displays the preview 628b of the subject with a visual appearance corresponding to the selectable option 632d (e.g., bow tie), as shown in FIG. 6AA. In some embodiments, the electronic device 500 also updated the subject personalization user interface element 630a to indicate the selected and/or entered customizations (e.g., curlier, beard, and bow tie), as shown in FIG. 6AA. In some embodiments, the electronic device 500 applies a default automatic selection that is based on the first visual reference 626l of the subject as described in more detail in method 700. For example, when the electronic device 500 determines that the first visual reference 626l includes a hat or jewelry, the electronic device 500 includes in the preview 628b of the subject, the subject with a hat or jewelry.

In FIG. 6AA, the electronic device 500 detects a navigation input with contact 604aa (e.g., a tap or long press input) directed to the preview 628b of the subject based on the first visual reference 626l followed by movement of contact 604aa, and a lifting of contact 604aa from the display generation component 504. In some embodiments, this navigation input has one or more characteristics of the navigation input with contact 604f directed to the preview 610a of the second automatically-generated visual media item described in FIG. 6F. In some embodiments, in response to detecting the navigation input with contact 604a directed to the preview 628b of the subject based on the first visual reference 626l, the electronic device 500 ceases to display the preview 628b of the subject based on the first visual reference 626l or moves the preview 628b of the subject based on the first visual reference 626l off a display area of the subject personalization user interface 628a and moves a preview 628c of the subject based on a second visual reference 626m into the display area as shown in FIG. 6AB. In some embodiments, the second visual reference 626m is different from the first visual reference 626l. For example, the second visual 626m reference includes an object (e.g., tree) in the background while the first visual reference 626l does not. Other differences may relate to the facial expression of the subject, a pose of the subject, a degree of lighting or other attribute described in more detail in method 700. Because the second visual reference 626m is different from the first visual reference 626l, the preview 628c of the subject based on a second visual reference 626m is also different, as shown in FIG. 6AB. For example, the preview 628c of the subject includes a different curly hair style than the curly hair style included in the preview 628b of the subject. In some embodiments, although the second visual reference 626m includes an object (e.g., tree) in the background, the electronic device 500 does not display the object in the preview 628c.

In some embodiments, while the electronic device 500 displays the preview 628c of the subject based on a second visual reference 626m, the electronic device 500 determines that an amount of time that has elapsed since an input was last detected exceeds a time threshold (e.g., 5, 10, 20, 30, 40, 60, or 120 seconds). In some embodiments, in accordance with this determination, the electronic device 500 displays the visual media creation user interface 600a of the automatically-generated visual media application, as shown in FIG. 6AC. For example, the visual media creation user interface 600a includes a preview 656 of the subject with the customizations selected and/or entered with reference to FIGS. 6W-6AB. In some embodiments, while displaying the preview 656 of the subject, the electronic device detects a dragging input with contact 604ac (e.g., a tap or long press input) directed to prompt component 640a followed by movement of the contact 604ac corresponding to a request to add prompt component 640a to the prompt for generating automatically-generated visual media. In some embodiments, this dragging input with contact 604ac has one or more characteristics of the dragging input with contact 604a in FIG. 6A. Although contact 604ac is illustrated as a touch input, it should be understood that dragging inputs are not limited to touch inputs. Other types of dragging inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 700, are possible.

In some embodiments, in response to detecting this dragging input corresponding to a request to add prompt component 640a to the prompt for generating automatically-generated visual media in FIG. 6AC, the electronic device 500 displays a notification 638a, as shown in FIG. 6AD. For example, the electronic device 500 determines that the prompt that includes prompt component 640a is provided by an ML model different from the current ML model being used to generate automatically-generated visual media. For example, prior to detecting the request to add prompt component 640a, the selected ML model for generating automatically-generated visual media is on-device ML model as indicated by the placeholder content in content entry field 600f in FIG. 6AC. In some embodiments, in accordance with this determination, the electronic device 500 displays the notification 638a in FIG. 6AD. In some embodiments, the notification 638a includes information identifying the ML (e.g., model alpha) and a first option 638b that, when selected, causes the electronic device 500 to transmit the prompt including the preview 656 of the subject to the ML model. In some embodiments, the notification 638a includes a second option 638c that, when selected causes the electronic device 500 to forgo initiating the process to generate automatically-generated visual media using the entered prompt (e.g., maintain using the currently selected ML model). In some embodiments, the electronic device 500 detects a selection input with contact 604ad (e.g., a tap or long press input) directed to the first option 638b. Other selection inputs are supported and described in more detail below at least with reference to method 700. In some embodiments, in response to detecting this selection input directed to the first option 638b, the electronic device 500 generates an automatically-generated visual media item featuring the customized subject including displaying in the visual media creation user interface 600a preview 656 of the automatically-generated visual media item and prompt component 640a using the ML model associated with prompt component 640a. In some embodiments, the electronic device 500 also changes the placeholder text of the content entry field 600f to include this ML model (e.g., model alpha) used for generating the preview 656 of the automatically-generated visual media item, as shown in FIG. 6AE.

In some embodiments, access to automatically-generated visual media items and/or features provided by the automatically-generated visual media application are provided by the electronic device 500 on other applications, different from the automatically-generated visual media application as described in more detail in method 1200. For example, FIG. 6AF illustrates a messaging user interface 642a of a messaging application. In some embodiments, the messaging user interface 642a includes one or more user interface elements, components, options, and/or affordances, such as a first message 642e, a soft keyboard user interface element 642b that includes a plurality of soft keys corresponding to respective input values. In some embodiments, the soft keyboard user interface element 642b also includes an emoji mode option 642d that, when selected, causes the electronic device 500 to display the soft keyboard user interface element 642b in the emoji mode, as described in the that figures that follow. For example, in FIG. 6AF, the electronic device 500 detects a selection input with contact 604af directed to the emoji mode option 642d, and in response to detecting this selection input, the electronic device 500 displays the soft keyboard user interface element 642b in the emoji mode, as shown in FIG. 6AG.

For example, in FIG. 6AG, the soft keyboard user interface element 642b in the emoji mode includes a plurality of selectable emojis 642j for insertion into content entry field 600f. In some embodiments, the electronic device 500 determines content 642g entered in the content entry field 600f triggers generation of an automatically-generated visual media (e.g., the content satisfies one or more criteria as described in more detail with reference to method 700). For example, the electronic device 500 determines that the content 642g includes at least two emojis 642h and 642i. In some embodiments, in response to this determination, the electronic device 500 displays, in the soft keyboard user interface 642b, option 644d that, when selected, causes the electronic device 500 to generate automatically-generated visual media using the two emojis 642h and 642i. For example, in response to detecting a selection input with contact 604ag directed to the option 644d in FIG. 6AG, the electronic device 500 displays in the messaging user interface 642a the visual media creation user interface 600a of the automatically-generated visual media application (e.g., without closing the messaging application including the messaging conversation), as shown in FIG. 6AH.

In some embodiments, in FIG. 6AH, the visual media creation user interface 600a includes a preview 644a of an automatically-generated visual media item (e.g., kissing panda) based on the two emojis 642h and 642i including prompt components corresponding to the two emojis 642h and 642i, such as prompt component 644b corresponding to emoji 642h and prompt component 644c corresponding to emoji 642i. In some embodiments, the preview 644a of an automatically-generated visual media item is an emoji because the prompt includes emojis 642h and 642i. In some embodiments, the visual media creation user interface 600a includes the set of emoji prompt components 618b through 618i corresponding to standard emojis selectable to add to the prompt as described in more detail with reference to FIG. 6L. In some embodiments, the electronic device 500 is configured to generate automatically-generated visual media items using the prompt components 644b and 644c, and/or any of the prompt components 618b through 618i in response to detecting one or more selection inputs to add, remove, or edit the prompt as described above with reference to FIGS. 6A-6L and/or in method 700. In some embodiments, while displaying the preview 644a of the automatically-generated visual media item, the electronic device 500 detects a selection input with contact 604ah directed to an add user interface element 600l, and in response to detecting this selection input, the electronic device 500 inserts the automatically-generated visual media item (e.g., automatically-generated emoji 646) into the content entry field 644, as shown in FIG. 6AI.

In some embodiments, while displaying the messaging user interface 642a, the electronic device 500 suggests one or more automatically-generated visual media items accessible via the soft keyboard user interface element 642b. In some embodiments, the electronic device 500 recognizes one or more keywords associated with one or more automatically-generated visual media items (e.g., automatically-generated emojis). For example, in FIG. 6AJ, the electronic device 500 determines that keywords 648a entered in content entry field 600f are associated with a previously generated and saved automatically-generated emoji 648c, and in accordance with this determination the electronic device 500 displays automatically-generated emoji 648c in the soft keyboard user interface element 642b. In some embodiments, the electronic device also displays other standard emojis (e.g., emoji 648b) and/or text (e.g., “laughing out loud”) associated with the keywords 648a.

FIG. 7 illustrates a flow diagram illustrating a method in which an electronic generates automatically-generated visual media using a machine learning (ML) model in accordance with some embodiments of the disclosure. The method 700 is optionally performed at first electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

In some embodiments, method 700 is performed at an electronic device (e.g., electronic device 500 in FIG. 5A and/or FIG. 6A) in communication with one or more display generation components (e.g., display generation component 504 in FIG. 5A and/or FIG. 6A) and one or more input devices. For example, a mobile device (e.g., a tablet, a smartphone, a media player, or a wearable device), a computer, a smart home device, an in-vehicle computer (e.g., vehicle on-board computer, vehicle information and entertainment system or infotainment system), or other electronic device. In some embodiments, the one or more display generation components are one or more displays integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include a second electronic device or component capable of receiving a user input (e.g., capturing a user input, and/or detecting a user input.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, a motion sensor (e.g., a hand tracking device, a hand motion sensor), and/or a microphone for capturing voice commands or other audio input. In some embodiments, the electronic device is in communication with a hand tracking device (e.g., one or more cameras, depth sensors, proximity sensors, touch sensors (e.g., a touch screen, trackpad)). In some embodiments, the hand tracking device is a wearable device, such as a smart glove. In some embodiments, the hand tracking device is a handheld input device, such as a remote control or stylus.

In some embodiments, while displaying, via the one or more display generation components, a user interface of an automatically-generated visual media application for generating automatically-generated visual media using a respective machine learning (ML) model (e.g., a first ML model, a second ML model, or other ML model), such as visual media creation user interface 600a of an automatically-generated visual media application in FIG. 6A, the electronic device detects (e.g., 702), via the one or more input devices, a sequence of one or more inputs directed to the user interface corresponding to a request to generate an automatically-generated visual media item based on a prompt, such as a dragging input with contact 604a directed to prompt component 602c in FIG. 6A. In some embodiments, the user interface of the automatically-generated visual media application is a user interface for receiving (or, optionally, detecting) a prompt for use in generating automatically-generated visual media (e.g., images, videos, animations, and/or other visual media described in more detail below) that is generated at least partially using a respective ML model (e.g., the first ML model, a second ML model described herein, or other ML model). In some embodiments, the respective ML model is a model of the electronic device (e.g., built-in the electronic device or part of the operating system of the electronic device). In some embodiments, the respective ML model is associated with a system distinct from the electronic device. For example, the electronic device optionally enables access to the respective ML model for generating visual media. Thus, in some embodiments, the respective ML model is integrated into the electronic device for extending visual media generation services or capabilities from the respective ML model to the electronic device. In some embodiments, and as described in more detail below, while the electronic device displays the user interface of the automatically-generated visual media application, the electronic device receives (or, optionally, detects), via the one or more input devices, a prompt including one or more prompt components. In some embodiments, a prompt component includes text, keywords, images, video, special characters, visual media, and/or other inputs describing a concept (e.g., style, theme, mood, activity, costume, accessory, places, graphics, or visual characteristic that will influence the generation of the visual media). In some embodiments, the prompt component includes a computer-generated suggested concept (or, optionally referred to as a predefined concept) or a recognized concept. For example, the electronic device optionally uses the respective ML model and/or language/image understanding capabilities (e.g., built-in the electronic device or part of the operating system of the electronic device) to recognize the prompt component as a particular concept. In some embodiments, and as described in more detail below, in response to receiving (or, optionally, detecting) the prompt including one or more prompt components, the electronic device presents one or more respective ML models capable of generating visual media based on the prompt. In some embodiments, generation of visual media using the respective ML model optionally includes the use of one or more program(s) and/or algorithm(s) applied to one or more datasets to recognize patterns, and/or make predictions based on the prompt received to result in generated visual media, and optionally includes the use of machine learning algorithms.

In some embodiments, the user interface of the automatically-generated visual media application includes one or more prompt components, , such as style prompt component option 600e and/or prompt components 602a through 602h in FIG. 6A; and/or prompt components 602a through 602d in FIG. 6B. In some embodiments, a first prompt component of the one or more prompt components corresponds to a first predefined concept (e.g., described herein) that will influence the generation of the visual media. In some embodiments, the first prompt component includes an indication of a respective ML model (e.g., first ML model) capable of generating visual media based on the first predefined concept. In some embodiments, the electronic device automatically generates the visual media based on the first prompt component (e.g., without receiving or detecting user input corresponding to a request to generate the visual media based on the first prompt component). In some embodiments, the electronic device receives (or, optionally, detects) a user input corresponding to a request to change the first prompt component to a second prompt component, different from the first prompt component. For example, the second prompt component optionally corresponds to a second predefined concept, different from the first predefined concept associated with the first prompt component. In some embodiments, the second prompt component is associated with the first ML model or a second ML model, different from the first ML model. For example, the electronic device optionally receives or detects the second prompt component associated with the second ML model, and in response to receiving or detecting the second prompt component associated with the second ML model, the electronic device uses the second ML model in generating automatically-generated visual media (e.g., the electronic device selects the second ML model as the ML model that will influence the generation of the visual media instead of the first ML model).

In some embodiments, the sequence of one or more inputs directed to the user interface of the automatically-generated visual media application include one or more selection inputs directed to the first prompt component, such as sequence of selection inputs that include contact 604b directed to style prompt component option 600e in FIG. 6B and selection input with contact 604c directed to style option 608f in FIG. 6C. In some embodiments, a selection input includes a tap gesture including contact (e.g., using a finger or stylus) on a touch-sensitive surface corresponding to the first prompt component, an air pinch gesture while the gaze of the user of the electronic device is directed to the first prompt component, a forward pointing in-air gesture directed to the first prompt component, actuation of an indirect input device, such as a mouse, trackpad, or controller while a cursor is directed to the first prompt component (or, optionally, while the first prompt component has input focus), and/or voice input from the user corresponding to the request to change the first prompt component to a second prompt component. In some embodiments, in response to detecting the sequence of one or more inputs directed to the first prompt component, the electronic device presents an option (e.g., one or more selectable user interface elements, such as list of options) to select the second prompt component or select one or more other prompt components, different from the first prompt component and the second prompt component as will be described in more detail below. In some embodiments, the sequence of one or more inputs directed to the user interface include one or more text entry (or handwritten) inputs using a soft (or virtual) keyboard user interface element, a physical (or hardware) keyboard, touchpad, stylus, and/or dictation corresponding to a request to add the first prompt component to the prompt and/or edit the first prompt component. In some embodiments, the sequence of one or more inputs directed to the user interface include one or more selection inputs as described above corresponding to a request to remove the first prompt component from the prompt. For example, the request to remove the first prompt component from the prompt optionally includes a tap gesture or any of the gestures or any of the inputs described above directed to a remove user interface element that, when selected, causes the electronic device to remove the first prompt component from the prompt. In some embodiments, the sequence of one or more inputs directed to the user interface include one or more selection inputs as described above corresponding to a request to generate an automatically-generated visual media item based on the prompt. For example, the request to generate an automatically-generated visual media item based on the prompt optionally includes a tap gesture or any of the gestures or any of the inputs described above directed to a generate user interface element that, when selected, causes the electronic device to generate an automatically-generated visual media item based on the prompt. In some embodiments, the electronic device automatically (e.g., without detecting further inputs, such as, for example, a selection input directed to the generate user interface element) generates an automatically-generated visual media item based on the prompt after a predetermined amount of time (e.g., 0.1, 0.2, 0.3, 0.5, 1, 3, 5, 10, 15, 20, or 30 seconds) optionally, without detecting further inputs to add, remove, and/or edit one or more prompt components of the prompt as described herein.

In some embodiments, in response to detecting the sequence of one or more inputs directed to the user interface of the automatically-generated visual media application, the electronic device generates (e.g., 704) an automatically-generated visual media item based on the prompt, such as a preview 606e of a first automatically-generated visual media item in FIG. 6B, including, in accordance with a determination that the sequence of one or more inputs specified a first ML model for use in generating the automatically-generated visual media item, such as a selection input with contact 604c directed to style option 608f in FIG. 6C, the electronic device generates (e.g., 706) the automatically-generated visual media based on the prompt using the first ML model, such as a preview 606f of a second automatically-generated visual media item in FIG. 6D. In some embodiments, the first ML model is specified via the prompt (e.g., the prompt component described herein and below). In some embodiments, generating the automatically-generated visual media based on the prompt using the first ML model is performed in response to detecting that the sequence of one or more inputs specified the first ML model and/or specified a style supported by the first ML model as described in more detail below. For example, the electronic device detects that the sequence of one or more inputs optionally correspond to a request to add or select a prompt component associated with the first ML model to the prompt. In some embodiments, detecting the sequence of one or more inputs corresponding to the request to add or select the prompt component associated with the first ML model has one or more characteristics as detecting any of the selection inputs, gestures, or other inputs corresponding to adding, selecting, and/or revising the prompt component described above. In some embodiments, the electronic device detects that the sequence of one or more inputs correspond to a request to change the prompt component to the prompt component associated with the first ML model as described above and, in more detail, below. In some embodiments, generating the automatically-generated visual media based on the prompt using the first ML model is performed automatically, without (e.g., independent of) detecting an input directly specifying selection of or the addition of the first ML model or detecting an action corresponding to adding or selecting the first ML model as described herein and, in more detail, below. In some embodiments, using the first ML model to generate the automatically-generated visual media is initiated by the sequence of one or more inputs (e.g., provided by the user) as described above, but subsequent actions performed by the electronic device are performed automatically (e.g., without detecting input from the user to specify the use of the first ML model) as described in more detail below.

In some embodiments, in response to detecting the sequence of one or more inputs directed to the user interface of the automatically-generated visual media application, the electronic device generates an automatically-generated visual media item based on the prompt, including, in accordance with a determination that the sequence of one or more inputs specified a second ML model for use in generating the automatically-generated visual media item (e.g., different from the first ML model), such as one or more text entry inputs directed to the keyboard user interface element 650 corresponding to a request to add a prompt component that includes content 612 in FIG. 6H, the electronic device generates (e.g., 708) the automatically-generated visual media based on the prompt using the second ML model, such as preview 606h of the fourth automatically-generated visual media item in FIG. 6J. In some embodiments, the electronic device detects, via the one or more input devices, the sequence of one or more inputs correspond to a request to change the AI model used to generate the visual media from one ML model (e.g., the first ML model) to the second ML model. For example, the user input corresponding to the request to change the one AI model used to generate the visual media optionally includes one or more selection inputs (e.g., similar to and/or including one or more characteristics of the selection inputs described herein) directed to a representation of a respective prompt component associated with setting the ML model used for generating the visual media as described in more detail below. In some embodiments, the sequence of one or more inputs are directed to a representation of a prompt component associated with the second AI model, different from the respective prompt component associated with the one (e.g., first) ML model, that, when selected, causes the electronic device to change the one ML model to the second ML model used to generate the visual media. In some embodiments, in response to detecting the sequence of one or more inputs, the electronic device updates the one ML model to the second ML model (e.g., the electronic device selects the second ML model as the ML model used to generate the automatically-generated visual media instead of the one ML model). In some embodiments, updating the one ML model to the second ML model includes updating a respective predefined concept (e.g., first predefined concept, first style) that will influence the generation of the visual media. For example, while the electronic device is optionally generating automatically-generated visual media based on a first prompt component including a first predefined concept (e.g., first style) using the first ML model, the electronic device detects the sequence of one or more inputs, and in response to detecting the sequence of one or more inputs, the electronic device generates visual media based on a second prompt component including a second predefined concept (e.g., second style) using the second ML model. In some embodiments, the second predefined concept of the second ML model is different from the first predefined concept of the first ML model. In some embodiments, the second predefined concept of the second ML model is similar to or the same as the first predefined concept of the first ML model.

In some embodiments, the electronic device detects, via the one or more inputs, a user input corresponding to a request to perform an action other than an action to change the one ML model to the second ML model (or, optionally, another ML model, different from the one ML model), such as selection input with contact 604a directed to prompt component 602c in FIG. 6A. For example, the action includes detecting a sequence of one or more second inputs (e.g., similar to and/or including one or more characteristics of the sequence of one or more inputs directed to the automatically-generated visual media application described herein) corresponding to a request to add, remove, edit one or more prompt components, change a subject or person of the visual media, or select a predefined prompt component (e.g., style) associated with the one ML model (e.g., same ML model of the current ML model used to generate visual media). In some embodiments, the sequence of one or more second inputs correspond to a request to update a visual appearance (e.g., size) of the visual media as described in more detail below. Updating the one ML model to a different ML model in response to detecting a sequence of one or more inputs directed to the user interface of the automatically-generated visual media application specifying the different ML model provides quick access to different ML models capable of generating visual media without having to leave the automatically-generated visual media application, thereby reducing further inputs to navigate away from the user interface of the automatically-generated visual media application to a user interface of the different ML model, and avoiding erroneous inputs related to navigating to the user interface of the different ML model which reduces power usage and improves battery life of the electronic device by enabling the user to access the different ML model and use the electronic device more quickly and efficiently.

In some embodiments, the first ML model is associated with a first provider, such as shown by style option 608f in FIG. 6C and the second ML model is associated with the first provider, such as shown by style option 608g in FIG. 6C. The first provider optionally refers to an entity that develops, manages, and makes ML models, such as the first ML model, the second ML model, and/or another model available to the electronic device. For example, the first provider optionally hosts one or more ML models on their servers, receives one or more requests to generate automatically-generated visual media from the electronic device and/or the automatically-generated visual media application, and responds to the request with one or more automatically-generated visual media based on the request. In some embodiments, the request includes the prompt as described above. In some embodiments, the second ML model is associated with a second provider, different from the first provider associated with the first ML model. In some embodiments, the electronic device displays an indication of the first provider. For example, and as described in more detail below, displaying the user interface of the automatically-generated visual media application for generating automatically-generated visual media using the respective ML model (e.g., the first ML model, the second ML model, or other ML model) optionally includes displaying, via the one or more display generation components, a representation of a respective prompt component (e.g., a first prompt component, a second prompt component, or other prompt component) associated with the respective ML model including one or more selectable options for specifying the respective ML model for use in generating the automatically-generated visual media item. In some embodiments, the one or more selectable options include a first option corresponding to the first ML model associated with the first provider and a second option corresponding to the second ML model associated with the first provider. Thus, in some embodiments, the electronic device displays a respective prompt component that includes a variety of ML models provided by a single provider (e.g., the first provider, the second provider, or other provider) for generating automatically-generated visual media as described herein and above.

In some embodiments, the first ML model specifies a first visual style used as a stylistic basis for generating the automatically-generated visual media item, such as the first visual style associated with style option 608b in FIG. 6C and the second ML model specifies a second visual style used as the stylistic basis for generating the automatically-generated visual media item, different from the first visual style, such as the second visual style associated with style option 608h in FIG. 6C. In some embodiments, the stylistic basis for generating the automatically-generated visual media refers to a particular aesthetic appearance or overall artistic look of the automatically-generated visual media. A respective visual style (e.g., the first visual style, the second visual style, or other visual style) optionally includes animation, illustration, photograph, sketch, emoji, cartoon, natural, black and white, painting, anime, pixel art, pop art, watercolor, oil painting, cyberpunk, or other image style described below and/or in method 800.

In some embodiments, displaying the user interface of the automatically-generated visual media application for generating automatically-generated visual media using the respective ML model (e.g., the first ML model, the second ML model, or other ML model) includes displaying (e.g., concurrently displaying), via the one or more display generation components, a representation of a respective prompt component (e.g., a first prompt component, a second prompt component, or other prompt component) associated with the respective ML model including one or more selectable options for specifying the respective ML model for use in generating the automatically-generated visual media item, such as style selection user interface component 608a including style options 608b through 608h in FIG. 6C. In some embodiments, the respective prompt component is a dropdown, selector, picker, or menu-type user interface element that includes one or more (or, optionally, a plurality) of mutually exclusive selectable options as described herein. In some embodiments, the respective prompt component is automatically displayed in the user interface of the automatically-generated visual media application upon opening or launching the automatically-generated visual media application (e.g., without detecting input corresponding to a request to display the respective prompt component). In some embodiments, the electronic device opens the automatically-generated visual media in response to detecting input corresponding to a request to open the automatically-generated visual media as described in more detail in method 1200. In some embodiments, the electronic device displays the respective prompt component with a default or preselected option. For example, the default option optionally corresponds to an ML model of the electronic device (e.g., built-in the electronic device or part of the operating system of the electronic device) and a respective visual style (e.g., a first visual style, a second visual style, or other visual style). In some embodiments, one option (e.g., ML model and visual style) is selected at a time. Thus, in some embodiments, the electronic device applies one ML model and one visual style in generating the automatically-generated visual media item. In some embodiments, and as described herein, the electronic device detects, via the one or more input devices, a sequence of one or more selection inputs (e.g., as described above) directed to the representation of the respective prompt component corresponding to a request to select an option, different from the default or previous option. In some embodiments, in response to detecting this sequence of one or more selection inputs, the electronic device selects the option and deselects the default option. In some embodiments, selecting the option causes the electronic device to automatically generate the automatically-generated visual media based on the selected option (e.g., the first option, the second option, the third option, or other option described herein). In some embodiments, automatically generating the automatically-generated visual media is performed without detecting one or more inputs corresponding to a request to generate the automatically-generated visual media based on the selected option.

In some embodiments, the one or more selectable options include a first option selectable to select the first ML model associated with a first provider, such as shown by style option 608e; a second option selectable to select the second ML model associated with a second provider, different from the first provider, such as show by style option 608f in FIG. 6C; and a third option selectable to select a third ML model associated with a third provider, different from the second provider, such as shown by style option 608g in FIG. 6C. In some embodiments, the third ML model has one or more characteristics of the first ML model described above. In some embodiments, the first provider, the second provider, and the third provider have one or more characteristics of the first provider described above. In some embodiments, a respective option (e.g., the first option, the second option, the third option, or other option) includes an indication (e.g., name, icon, or other identifier) of a respective ML model (e.g., the first ML model, the second ML model, the third ML model, or other ML model) and/or an indication (e.g., name, icon, or other identifier) of a respective provider (e.g., the first provider, the second provider, the third provider, or other provider). In some embodiments, the electronic device detects, via the one or more input devices, one or more inputs (e.g., selection inputs as described above) directed to the respective option. In some embodiments, in response to detecting the one or more inputs directed to the respective option, the electronic device select the respective ML model associated with the respective provider. Thus, in some embodiments, the electronic device displays a representation of a respective prompt component that includes a variety of ML models provided by a variety of providers (e.g., the first provider, the second provider, the third provider, or other provider) for generating automatically-generated visual media as described herein and above.

In some embodiments, the first ML model is associated with an entity (e.g., a company or organization) that is responsible for maintaining an operating system of the electronic device (e.g., integrated with the operating system of the electronic device and/or services accessible via the operating system of the electronic device), such as shown by style option 608e in FIG. 6C. In some embodiments, the services include private cloud computing services. For example, when the electronic device determines that the request to generate automatically-generated visual media requires more computational capacity than the computational capacity provided by the electronic device (e.g., requires access to server-based models larger than the on-device models), the electronic device transmits the request to a cloud computing service such as privacy-preserving cloud computing service.

In some embodiments, the second ML model is not associated with the entity (e.g., a company or organization) that is responsible for maintaining the operating system of the electronic device (e.g., not integrated with the operating system of the electronic device and/or services accessible via the operating system of the electronic device), such as shown by style option 608g in FIG. 6C. In some embodiments, the second ML model not associated with the entity that is responsible for maintaining the operating system of the electronic device includes a visual indication or description (e.g., name, icon, or other identifier) of the second ML model and/or the provider associated with the second ML model as described above, a visual indication of a respective visual style (e.g., the first visual style, the second visual style, or other visual style) provided by the second ML model, and/or other information identifying the second ML model, and/or the provider associated with the second ML model as described above. In some embodiments, the second ML model is hosted by one or more remote servers as described above. In some embodiments, the second ML model is associated with an entity different from the entity that is responsible for maintaining the operating system of the electronic device. In some embodiments, the visual indication or description of the second ML model includes information identifying the entity associated with the second ML model. In some embodiments, the entity associated with the second ML model refers to a company or organization using, maintaining, and/or providing access to the second ML model. In some embodiments, in response to detecting, via the one or more input devices, a sequence of one or more selection inputs (e.g., as described above) directed to the user interface of the interface of the automatically-generated visual media application corresponding to a request to use the second ML model in generating automatically-generated visual media as described above and/or in method 800, the electronic device displays, via the one or more display generation components, an alert associated with using the second ML model as described in more detail below. For example, the electronic device optionally identifies a request to use the second ML model in response to detecting, via the one or more input devices, one or more inputs to select an option corresponding to the second ML model (e.g., described above), one or more inputs specifying the second ML model for use in generating the automatically-generated visual media item (e.g., described above), one or more inputs to add a prompt component that defines a visual characteristic (e.g., visual style) of the first automatically-generated visual media as described in more detail in method 800, or one or more other inputs corresponding to the request to use the ML model described below and/or in method(s) 800 and/or 1200. In some embodiments, the electronic device selects the first ML model in response to one or more inputs as described herein specifying the first ML model (e.g., optionally, while the electronic device is configured to use the second ML model or another ML model). Thus, in some embodiments, the electronic device provides a variety of ML models (e.g., associated with or not associated with an entity that is responsible for maintaining the operating system of the electronic device) for use in generating automatically-generated visual media as described herein.

In some embodiments, the second ML model is an ML model that has been selected (e.g., based on one or more user inputs) for use by a functionality of the electronic device, other than the automatically-generated visual media application, to provide one or more automatically-generated (e.g., ML-based) responses to one or more second inputs, such as communicating with a digital assistant to reply to a message that includes automatically-generated emoji 648c within a messaging user interface 642a as shown in FIG. 6AJ in response to one or more voice inputs directed to the digital assistant. For example, the functionality is optionally an intelligent service (e.g., that uses the second ML model) accessible on and/or implemented by the electronic device, such as a virtual assistant described in more detail below, a proofing tool, or other intelligent service or assistance. In some embodiments, the electronic device detects, via one or more input devices, one or more inputs to use this functionality, and in response, the electronic device generates a response using the second ML model. For example, the second ML model is used by the virtual assistant in response to detecting invocation of the virtual assistant for use in the automatically-generated visual media application. In some embodiments, the second ML model is used in the automatically-generated visual media in response to detecting the use of the second ML for generating automatically-generated visual media. In some embodiments, the second ML model is used in the automatically-generated visual media in response to detecting the use of the second ML model independent of whether or not the second ML model is selected for use in the automatically-generated visual media application. Additionally or alternatively, in some embodiments, the electronic device optionally detects the sequence of one or more inputs that specified the second ML model for use in generating the automatically-generated visual media item is directed to a virtual assistant. In some embodiments, the electronic device implements the virtual assistant, optionally as an interface of the electronic device’s operating system. In some embodiments, this interaction with the virtual assistant to generate the automatically-generated visual media item using the second ML model is enabled by the electronic device independent of the automatically-generated visual media application running on the electronic device (e.g., the electronic device displaying the user interface of the automatically-generated visual media application as described above). Thus, in some embodiments, the electronic device implements the virtual assistant to provide access to one or more processes of generating automatically-generated visual media item using the second ML model without first launching the automatically-generated visual media application. In some embodiments, the electronic device automatically (e.g., without detecting or receiving additional user input) provides a prompt that specifies the second ML model for use in generating the automatically-generated visual media item along with other information or parameters from the sequence of one or more inputs to the virtual assistant to define the request to generate the automatically-generated visual media item and generate a response that satisfies the request. For example, the request to generate the automatically-generated visual media item is optionally inferred by the electronic device implementing the virtual assistant based on the sequence of one or more inputs.

The terms “virtual assistant,” “digital assistant,” “intelligent automated assistant,” or “automatic virtual assistant” optionally refer to any information processing system that interprets natural language input in spoken and/or textual form to infer user intent, and performs actions based on the inferred user intent. For example, to act on an inferred user intent, the virtual assistant optionally performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form. Specifically, a virtual assistant is optionally capable of accepting a user request at least partially in the form of a natural language command, request, statement, narrative, and/or inquiry. Typically, the user request optionally seeks either an informational answer or performance of a task by the virtual assistant. A satisfactory response to the user request optionally includes a provision of the requested informational answer, a performance of the requested task, or a combination of the two. For example, a user asks the virtual assistant a question, such as “Where am I right now?” Based on the user's current location, the virtual assistant optionally answers, “You are in Central Park near the west gate.” The user optionally also requests the performance of a task, for example, “Please invite my friends to my girlfriend's birthday party next week.” In response, the virtual assistant can acknowledge the request by optionally saying “Yes, right away,” and then optionally send a suitable calendar invite on behalf of the user to each of the user's friends listed in the user's electronic address book. During performance of a requested task, the virtual assistant sometimes interacts with the user in a continuous dialogue involving multiple exchanges of information over an extended period of time. There are numerous other ways of interacting with a virtual assistant to request information or performance of various tasks. In addition to providing verbal responses and taking programmed actions, the virtual assistant also optionally provides responses in other visual or audio forms, e.g., as text, alerts, music, videos, animations, etc. In some embodiments, a virtual assistant is optionally implemented according to a client-server model. The virtual assistant optionally includes a client-side portion executed on the electronic device and server-side portion executed on a server system in communication with the electronic device through one or more networks.

In some embodiments, generating the automatically-generated visual media based on the prompt using the respective ML model (e.g., the first ML model, the second ML model, or other ML model) includes, in accordance with a determination the respective ML model is a first type of ML model, displaying, via the one or more display generation components, an alert associated with using the respective ML model before allowing the generation of the automatically-generated visual media using the respective ML model, such as notification 638a in FIG. 6AD. In some embodiments, generating the automatically-generated visual media based on the prompt using the respective ML model includes, in accordance with a determination the respective ML model is a second type of ML model, different from the first type of model, forgoing displaying the alert (e.g., allowing the generation of the automatically-generated visual media using the respective ML model without displaying the alert), such as forgoing displaying the notification 638a in FIG. 6AD. A first type of ML model optionally refers to an ML model not associated with the operating system of the electronic device as described above. A second type of ML model optionally refers to an ML model associated with an operating system of the electronic device. In some embodiments, the electronic device displays the alert prior to generating the automatically-generated visual media. In some embodiments the alert includes content notifying the user that the prompt will be shared to the respective ML model of the first type. In some embodiments, the alert requests approval from the user to share the prompt with the respective ML model of the first type prior to generating the automatically-generated visual media. In some embodiments, in response to detecting input, via the one or more input devices, corresponding to granting approval to share the prompt with the respective ML model of the first type, the electronic device generates the automatically-generated visual media based on the prompt using the respective ML model of the first type. In some embodiments, after a predetermined time has elapsed (e.g., 5, 10, 30, 40, 50, or 60 seconds) without detecting the input corresponding to granting approval to share the prompt with the respective ML model of the first type, the electronic device forgoes generating the automatically-generated visual media based on the prompt using the respective ML model of the first type. In some embodiments, the alert includes an option that, when selected, causes the electronic device to change the prompt, such as select a different visual style associated with the respective ML model of the second type. In some embodiments, the alert includes a second option that, when selected, causes the electronic device to cancel generating the automatically-generated visual media based on the prompt using the respective ML model of the first type. In some embodiments, in accordance with a determination that a setting to automatically approve sharing the prompt with the respective ML model of the first type or any other ML models of the first type is on or active, the electronic device forgoes displaying the alert. Thus, in some embodiments, the electronic device does not require repeated approval to share the prompt with the respective ML model of the first type to generate the automatically-generated visual media based on the prompt.

In some embodiments, generating the automatically-generated visual media based on the prompt using the respective ML model (e.g., the first ML model, the second ML model, or other ML model) includes, in accordance with a determination that the prompt indicates a first visual style, displaying, via the one or more display generation components, a notification indicating a third ML model that is available for use in generating the automatically-generated visual media item based on the first visual style, such as notification 614a in FIG. 6I.

In some embodiments, generating the automatically-generated visual media based on the prompt using the respective ML model includes, in accordance with a determination that the prompt indicates a second visual style, different from the first visual style, displaying, via the one or more display generation components, a notification indicating a fourth ML model that is available for use in generating the automatically-generated visual media based on the second visual style, such as notification having one or more characteristics of the notification 614a in FIG. 6I. In some embodiments, the third ML model and the fourth ML model have one or more characteristics of the first ML model described above, such as being an ML model not associated with the operating system of the electronic device as described above. In some embodiments, the electronic device determines that the prompt indicates a respective visual style (e.g., the first visual style, the second visual style, or other visual style) associated with a respective ML model (e.g., the third ML model, the fourth ML model, or other ML model) when a value or data of the respective visual style in the prompt is supported by the respective model. In some embodiments, the notification includes a first option that, when selected, causes the electronic device to generate the automatically-generated visual media based on the prompt using the respective ML model. In some embodiments, the notification includes a second option that, when selected, causes the electronic device to change the prompt, such as select a different visual style associated with the currently selected ML model. In some embodiments, the notification includes a third option that, when selected, causes the electronic device to cancel generating the automatically-generated visual media based on the prompt using the respective ML model in accordance with a determination that the currently selected respective ML model does not support the visual style included in the prompt.

In some embodiments, the notification includes an indication of a provider associated with the third ML model (e.g., an entity that is responsible for maintaining the ML model and determining performance and/or safety parameters associated with inputs and/or outputs of the ML model), such as shown in notification 614a in FIG. 6I. In some embodiments, the provider associated with the third ML model has one or more characteristics of the first provider described above. In some embodiments, the indication of the provider associated with the third ML model includes a name, icon, and/or other identifier corresponding to the provider.

In some embodiments, the notification includes an indication of the visual style and the indication of the third ML model capable of generating the automatically-generated visual media item based on the visual style, such as for example, notification 614a that includes an indication of the ML model and the visual style corresponding to content 612 in FIGS. 6H and 6I. For example, the indication of the visual style optionally includes a label, description, graphic, and/or other identifier corresponding to the visual style. In some embodiments, the indication of the third model includes a name, icon, and/or other identifier corresponding to the third ML model.

In some embodiments, the respective ML model specifies an emoji style used as a stylistic basis for generating the automatically-generated visual media item, such as shown by style option 608e in FIG. 6K. In some embodiments, the stylistic basis for generating the automatically-generated visual media refers to a particular aesthetic appearance or overall artistic look of the automatically-generated visual media as described above. In some embodiments, the emoji style includes emoji characters (e.g., still and/or animated picture characters that are not text characters in written human languages) as described in more detail in method 800. In some embodiments, the automatically-generated visual media item that is generated using the emoji style (e.g. optionally referred to as automatically-generated emojis) includes a digital representation, such as an avatar or icon, that is created or customized to express a range of emotions, actions, or personal attributes. In some embodiments, unlike standard emojis that exist in predefined forms, automatically-generated emojis are designed to reflect specific features of an individual user or character, including customizable aspects such as physical attributes, attire, accessories, and/or any other personal attributes that define the user or character as described in more detail in method 800.

In some embodiments, displaying the user interface of the automatically-generated visual media application for generating automatically-generated visual media using the respective ML model (e.g., the first ML model, the second ML model, or other ML model) includes concurrently displaying, via the one or more display generation components, a representation of a respective prompt component (e.g., a first prompt component, a second prompt component, or other prompt component) associated with the respective ML model including a first visual style for use in generating the automatically-generated visual media item, such as style prompt component option 600e in FIG. 6B. In some embodiments, the respective prompt component associated with the respective ML model including the first visual style has one or more characteristics of the respective prompt component (e.g., a first prompt component, a second prompt component, or other prompt component) associated with the respective ML model including one or more selectable options for specifying the respective ML model for use in generating the automatically-generated visual media item as described above. In some embodiments, the respective prompt component is a dropdown, selector, picker, or menu-type user interface element that includes one or more (or, optionally, a plurality) selectable options corresponding to one or more visual styles as described in more detail above (e.g., the selectable options are optionally mutually exclusive, but can alternatively be multiple options that can be selected together to combine styles). In some embodiments, the respective prompt component is automatically displayed in the user interface of the automatically-generated visual media application upon opening or launching the automatically-generated visual media application (e.g., without detecting input corresponding to a request to display the respective prompt component). In some embodiments, the respective prompt component is accessible in other locations, user interfaces, or user interface elements of the automatically-generated visual media application. For example, the electronic device optionally concurrently displays the respective prompt component with a preview of the automatically-generated visual media item in a preview mode-type user interface element where representations of different automatically-generated visual media items are displayed within a frame or container user interface element in accordance with a movement component of a navigation input as described in more detail below and/or in method 800.

In some embodiments, while displaying the representation of the respective prompt component, the electronic device detects, via the one or more input devices, a sequence of one or more second inputs corresponding to a request to change the first visual style, such as selection input with contact 604h directed to the style prompt component 600e in FIG. 6B. In some embodiments, the sequence of one or more second inputs has one or more characteristics of the sequence of one or more inputs described above with reference to the electronic device detecting one or more selection inputs directed to a prompt component that includes one or more selectable options for specifying the respective ML model for use in generating the automatically-generated visual media item. In some embodiments, detecting the sequence of one or more second inputs corresponding to the request to change the first visual style has one or more characteristics as detecting, via the one or more input devices, the sequence of one or more inputs corresponding to the request to change the ML model used to generate the visual media from one ML model (e.g., the first ML model) to the second ML model described above.

In some embodiments, in response to detecting the sequence of one or more second inputs corresponding to a request to change the first visual style (e.g., from the first visual style to a second visual style), the electronic device initiates a process to change the first visual style (e.g., from the first visual style to a second visual style), such as displaying the style selector user interface component 608a in FIG. 6C. In some embodiments, initiating the process to change the first visual style from the first style to the second style includes selecting the second visual style and deselecting the first visual style. In some embodiments, changing the first visual style optionally includes changing the ML model. In some embodiments, changing the first visual style does not include changing the ML model. In some embodiments, changing the first visual style causes the electronic device to automatically generate the automatically-generated visual media based on the selected visual style (e.g., the second visual style).

In some embodiments, the process to change the first visual style includes regenerating the automatically-generated visual media item based on the prompt including a second visual style, different from the first visual style, such as shown by preview 606f of a second automatically-generated visual media item in FIG. 6D that is based on a visual style different from the visual style associated with the preview 606e of the first automatically-generated visual media item in FIG. 6B. In some embodiments, the prompt used for regenerating the automatically-generated visual media item in the second visual style is the same prompt used to generate the automatically-generated visual media item in the first visual style apart from the different visual styles. In some embodiments, the regenerated automatically-generated visual media item based on the prompt including the second visual style differs from the automatically-generated visual media item based on the prompt including the first visual style. For example, the regenerated automatically-generated visual media item is based on the second visual style and optionally includes a second composition of subjects different from the first composition of subjects in the automatically-generated visual media item based on the prompt including the first visual style; a second size/scale of subject(s) larger or smaller than a first size/scale of subject(s) in the automatically-generated visual media item; and/or a second perspective that emphasizes subject(s) more or less than the first perspective in the automatically-generated visual media item. In some embodiments, the electronic device and/or the respective ML model extrapolates from the same prompt and/or the same recognized concepts (e.g., described above) used for generating the automatically-generated visual media item. In some embodiments, the electronic device optionally expands upon the recognized concepts and/or generates additional details.

In some embodiments, while displaying the user interface of the automatically-generated visual media application for generating automatically-generated visual media using the respective ML model (e.g., the first ML model, the second ML model, or other ML model), such as visual media creation user interface 600a in FIG. 6U, the electronic device detects, via the one or more input devices, a sequence of one or more second inputs corresponding to a request to customize an appearance of a subject of the prompt using the respective ML model, such as selection inputs with respective contacts 604u and 604v directed to representation 626n and first option 628d, respectively in FIGS. 6U and 6V. In some embodiments, the sequence of one or more second inputs has one or more characteristics of the sequence of one or more inputs described above. In some embodiments, the subject of the prompt refers to the main focus or key entity around which the automatically-generated visual content is generated. In some embodiments, the subject is an anthropomorphic FIGURE(e.g., a human, humanoid character, or an anthropomorphized creature or object), meaning a figure or entity that is attributed human characteristics or behaviors. In some embodiments, the subject is a virtual representation of a real individual, whose likeness is generated based on data inputs such as photographs of the individual or biometric information of the individual. In some embodiments, the electronic device detects, via one or more input devices, one or more inputs (e.g., selection inputs described above) corresponding to a request to select one or more photographs and/or videos of the individual. In some embodiments, in response to detecting the one or more inputs corresponding to the request to select the one or more photographs and/or videos of the individual, the electronic device selects the one or more photographs and/or video as the basis for the appearance of the subject. In some embodiments, the electronic device detects, via one or more input devices, one or more inputs (e.g., selection inputs described above) corresponding to a request to select a set of photographs and/or videos of the individual, and in response, the electronic device uses the set of photographs and/or videos as the basis for the appearance of the subject. In some embodiments, the set of photographs and/or videos of the individual include photographs and/or videos captured within a predetermined time frame (e.g., one month, six months, 1 year, 5 years, or 10 years). In some embodiments, the set of photographs and/or videos of the individual refers to a specific grouping or collection of photographs and/or videos selected by the electronic device from the media library of the user of the electronic device. In some embodiments, the set of photographs and/or videos selected by the electronic device include portraits, selfies, and/or other photographs and/or videos in which the individual is the focus of the photograph and/or video. In some embodiments, the set of photographs and/or videos selected by the electronic device differ slightly in the subject’s pose, facial expression, clothing, lighting, background, activity, age, time, and/or other characteristic. In some embodiments, and as described in more detail below with reference to displaying representations of the subject based on the one or more photographs and/or videos, the electronic device uses the one or more selected photographs and/or videos of the individual or the selected set of photographs and/or videos in generating automatically-generated visual content.

In some embodiments, the subject is a fictional character designed according to user specifications or selected from a database of pre-existing character designs the user can modify. In some embodiments, the subject is a virtual representation of a group of characters (e.g., two or more individuals), where the prompt allows customization of each individual within the group. In some embodiments, the appearance of the subject refers to one or more visual characteristics of the subject as depicted in the automatically-generated visual media. Some examples of visual characteristics include, but are not limited to, physical features such as facial structure, facial features, facial expressions, gender, body shape, body movements/position, skin tone, skin complexion, hair style/color, eye color/shape/size, age, height, build, tattoos/piercings/body art, cosmetic features (e.g., eyeshadow, lipstick, blush, and/or nail color), prosthetics, and any other feature which defines a physical characteristic of the subject. In some embodiments, the appearance of the subject includes clothing, head wear, accessories, and/or other stylistic details that define how the subject is presented visually within the automatically-generated visual media application. In some embodiments, the appearance is altered to fit different visual styles, such as realistic, cartoonish, or abstract, depending on the user’s preferences, and/or one or more characteristics of the prompt and/or the automatically-generated visual media. In some embodiments, the appearance of the subject is adapted automatically to different environmental contexts shown within the automatically-generated visual media (e.g., changing the subject’s attire automatically to match a specific historical era, geographic location, or action specified by the prompt and/or a user input).

In some embodiments, in response to detecting the sequence of one or more second inputs corresponding to the request to customize the appearance of the subject of the prompt using the respective ML model, the electronic device displays, via the one or more display generation components, an editing user interface element including one or more selectable options for customizing the appearance of the subject of the prompt using the respective ML model, such as subject personalization user interface element 630a that includes selectable options 630b through 630e and content entry field 630f in FIG. 6W. In some embodiments, the one or more selectable options are displayed within a menu user interface element or other interactive element that allow the user to visualize the selected options for customizing the appearance of the subject in real-time or near real-time and applying a variety of modifications to the subject’s appearance as a preview of the automatically-generated visual media. In some embodiments, the one or more selectable options for customizing the appearance of the subject refer to a variety of tools and/or choices that are interactable through the editing user interface (e.g., in response to input detected by the electronic device), which allow for the modification of visual elements of the subject in the automatically-generated visual media. In some embodiments, the editing user interface is displayed prior to the generation of the automatically-generated visual media (e.g., while the electronic device is displaying and/or generating a preview of the automatically-generated visual content). In some embodiments, the automatically-generated visual media that is generated is based on a customized appearance of the subject described below. The one or more selectable options include any of physical features and/or stylistic details described above and, in more detail, below.

In some embodiments, while displaying the editing user interface element including the one or more selectable options for customizing the appearance of the subject of the prompt using the respective ML model, such as subject personalization user interface element 630a in FIG. 6W, the electronic device detects, via the one or more input devices, a sequence of one or more third inputs directed to a respective selectable option (e.g., a first selectable option, a second selectable option, or other selectable option) of the one or more selectable options. In some embodiments, the sequence of one or more third inputs has one or more characteristics of the sequence of one or more second inputs described herein. In some embodiments, in response to detecting the sequence of one or more third inputs directed to the respective selectable option, the electronic device customizes the appearance of the subject based on the respective selectable option as described in more detail below with reference to one or more predetermined appearance characteristics for the subject and/or user-defined appearance characteristic entered via one or more content entry fields for customizing the appearance of the subject.

In some embodiments, the one or more selectable options include one or more options to select one or more predetermined appearance characteristics for the subject of the prompt, such as selectable options 630b through 630e in FIG. 6W. In some embodiments, the electronic device displays the one or more selectable options categorized into types of physical features (e.g., hair, facial hair, and/or other physical feature described above) and/or types of stylistic details (e.g., head wear, accessories, eyewear, jewelry, and/or other appearance details described above). The one or more predetermined appearance characteristics optionally refer to values for the categories. For example, the electronic device optionally includes options such as short, long, curly, and bald for the hair category. In another example, the electronic device optionally includes options such as mustache, goatee, beard, stubble, and sideburns for the facial hair category. In some embodiments, the electronic device detects, via one or more input devices, one or more inputs (e.g., selection inputs described above) directed to the one or more selectable options corresponding to a request to select one or more of the predetermined appearance characteristics. In some embodiments, in response to detecting the one or more inputs directed to the one or more selectable options corresponding to the request to select one or more of the predetermined appearance characteristics, the electronic device generates the subject using the one or more predetermined appearance characteristics. In some embodiments, the electronic device provides an automatic option that, when selected causes the electronic device to automatically select the option/value without requiring user selection. In some embodiments, electronic device automatically selects the option based on a photograph or other image of the subject as described in more detail below. In some embodiments, the electronic device provides an option to enter a specific appearance characteristic via a content entry field as described in more detail below.

In some embodiments, the one or more selectable options include one or more content entry fields for inputting content (e.g., text or font-based content) for customizing the appearance of the subject of the prompt using the respective ML model, such as content entry field 630f in FIG. 6W. For example, the electronic device optionally detects one or more content entry (or handwritten) inputs using a soft (or virtual) keyboard user interface element, a physical (or hardware) keyboard, touchpad, stylus, and/or dictation corresponding to a request to add content for customizing the appearance of the subject of the prompt and/or edit the prompt. In some embodiments, detecting entry of content into the one or more content entry fields refers to a process by which the electronic device recognizes and captures information that the user input into the one or more content entry fields. In some embodiments, the content refers to specific data, commands, and/or parameters entered by the user into the one or more content entry fields. For example, when the content specifies an accessory, such as a bow tie, sunglasses, a hat, the electronic device optionally generates the appearance of the subject wearing the accessory. Thus, in some embodiments, the electronic device enables a user of the electronic device to specify a customization (e.g., add a user-defined appearance characteristic) that is not constrained by the one or more predetermined appearance characteristics for the subject of the prompt described above.

In some embodiments, while displaying the editing user interface element including the one or more selectable options for customizing the appearance of the subject of the prompt using the respective ML model, such as subject personalization user interface element 630a in FIG. 6AA, the electronic device detects, via the one or more input devices, a sequence of one or more third inputs corresponding to a selection of a respective option of the one or more selectable options for customizing the appearance of the subject (e.g., a first option, a second option, or other option), such as the selection inputs described with reference to FIGS. 6X-6AA directed to the subject personalization user interface element 630a and the resulting customization values as shown by the subject personalization user interface elements 630a in FIG. 6AA. In some embodiments, the one or more selectable options for customizing the appearance of the subject have one or more characteristics of the one or more selectable options for customizing the appearance described above.

In some embodiments, in response to detecting the sequence of the one or more third inputs corresponding to the selection of the respective option of the one or more selectable options for customizing the appearance of the subject, the electronic device displays, via the one or more display generation components, a first representation of the subject that is based on a first visual reference for the subject (e.g., a first set of one or more photos and/or videos of the subject) and has been modified based on the respective option, such as preview 628b of the subject that is based on the first visual reference 626l in FIG. 6AA. In some embodiments, the first representation of the subject corresponds to a first photo and/or video of a first set of photos and/or videos used as the basis for the appearance of the subject. In some embodiments, the first set of one or more photos and/or videos is provided by the electronic device and selected by the user of the electronic device (e.g., via one or more selections inputs described above). In some embodiments, when customizing the appearance of the subject of the prompt, the electronic device provides a number of representations of the subject corresponding to a number of photos and/or videos in the first set. In some embodiments, these representations include the same subject and same customization based on the respective option. In some embodiments, the first set of photos and/or videos include variations in visual attributes (e.g., pose, facial expression, clothing, lighting, background, activity, age, time, and/or other attribute). In some embodiments, because the first set of photos and/or videos used by the electronic device as a visual reference for the subject include some minor differences, the representations generated and displayed by the electronic device also differ slightly in the one or more ways described herein. In some embodiments, the electronic device displays the first representation of the subject that is based on the first visual reference for the subject and has been modified based on the respective option as a first candidate or potential subject to become the focus or basis of the automatically-generated visual media. In some embodiments, the electronic device provides for display one or more other representations of the subject corresponding to the subject and based on the respective option. In some embodiments, the first representation of the subject that is based on the first visual reference for the subject and has been modified based on the respective option refers to the visual depiction or illustration of the first visual reference for the subject within a user personalization or editing user interface or user interface element of the automatically-generated visual media application. Some examples of the first representation of the subject that is based on the first visual reference for the subject and has been modified based on the respective option include, but are not limited to, an image, an emoji, a sketch, a digital model, or any other form of visual media that conveys the respective option, the appearance and/or one or more other characteristics of the subject.

In some embodiments, while displaying the first representation of the subject, the electronic device detects, via the one or more input devices, a navigation input (e.g., including a movement component or a directional component that indicates moving to a next or previous option or representation of the subject), such as navigation input with contact 604aa in FIG. 6AA. For example, the navigation input optionally includes a swipe gesture, a drag gesture, contact and movement on a touch-sensitive surface (e.g., touchscreen, trackpad, or touchpad), movement of a physical input device (e.g., movement of a hand held input device, such as a mouse, stylus, controller, or other motion tracking device that detects direction and/or magnitude of movement of the physical input device while it is being held in the hand of the user and/or rotating a physical click wheel or a rotatable input device, such as rotation of a digital crown), a voice input, a gaze of the user of the electronic device, and/or other predefined gesture or input. In some embodiments, the navigation input includes a movement component, such as movement of contact in a direction (e.g., horizontal, vertical, or diagonal) on a touch-sensitive surface. For example, the navigation input includes touchdown of a contact on the touch-sensitive surface, movement of the contact, and liftoff of the contact from the touch-sensitive surface after the movement of the contact. In some embodiments, the movement component corresponds to movement within a predetermined area of the user interface, such as directed to the first representation of the subject. In some embodiments, the predetermined area is an area of the user interface that includes the user interface element (e.g., frame) described above and, in more detail, below. In some embodiments, the movement component corresponds to movement of a portion of the user (e.g., hand, arm, and/or finger) of the electronic device in space as will be described in more detail below. In some embodiments, the navigation input is optionally indirect and does not require contact on the touch-sensitive surface and/or contact within the predetermined area of the user interface described herein. In some embodiments, and as will be described herein, in response to detecting the navigation input including the movement component, the electronic device navigates to a second representation of the subject that is based on a second visual reference for the subject that is different from the first visual reference for the subject (e.g., described herein), and has been modified based on the respective option. In some embodiments, generating the first subject modified based on the respective option and displaying the first representation of the subject includes generating a predetermined number of different representations of the subject modified based on the respective option.

In some embodiments, in response to detecting the navigation input, the electronic device displays, via the one or more display generation components, a second representation of the subject that is based on a second visual reference for the subject that is different from the first visual reference for the subject (e.g., a second set of one or more photos and/or videos of the subject that is different from the first set of one or more photos and/or videos of the subject) and has been modified based on the respective option, such as preview 628c of the subject that is based on the second visual reference 626m in FIG. 6AB. In some embodiments, the second representation of the subject has one or more characteristics of the first representation of the subject described herein. In some embodiments, the second visual reference has one or more characteristics of the first visual reference described herein. In some embodiments, the first representation of the subject and the second representation of the subject are optionally displayed as previews for the subject that is based on the first visual reference and modified based on the respective option and on the second visual reference and modified based on the respective option, respectively. For example, the electronic device optionally displays the first representation of the subject and the second representation of the subject (e.g., and, optionally, other representations of the subject) contained within a carousel user interface element, such as in a row that the user can navigate by the navigation input described herein. For example, the electronic device optionally displays respective representations of the subject (e.g., the first representation, the second representation, or other representation) in accordance with the movement component of the navigation input as described herein. In some embodiments, displaying the second representation of the subject includes replacing the display of the first representation of the subject. In some embodiments, the electronic device ceases to display the first representation of the subject. In some embodiments, the electronic device displays the second representation of the subject (e.g., or a portion of the second representation) adjacent to the first representation of the subject. In some embodiments, the electronic device ceases to display the first representation of the subject and displays the second representation of the subject at a location at which the first representation of the subject had been displayed. In some embodiments, the first visual reference for the subject and the second visual reference for the subject are based on the same subject (e.g., albeit derived from different sets of photos and/or videos as described herein) including the same respective option used for customizing the appearance of the subject as described above. For example, the first visual reference has a first visual attribute (e.g., first pose, first facial expression, first clothing, first degree of lighting, first background, first activity, first age, first time, and/or other first attribute) different from the second visual attribute associated with the second visual reference (e.g., second pose, second facial expression, second clothing, second degree of lighting, second background, second activity, second age, second time, and/or other second attribute). For example, the first facial expression associated with the first visual reference includes a smile and the second facial expression associated with the second visual reference includes a neutral, or non-smiling expression. In another example, the first age associated with the first visual reference includes the subject in their early twenties, and the second age associated with the second visual reference includes the subject in their late twenties. In some embodiments, the second representation of the subject that is based on the second visual reference for the subject and has been modified based on the respective option differs from the first representation of the subject that is based on the first visual reference for the subject and has been modified based on the respective option. For example, the electronic device extrapolates (e.g., in a same style, mood, or direction) from the same respective option used for customizing the appearance of the subject. In some embodiments, the electronic optionally expands upon the respective option and/or generates additional details. For example, when the respective option corresponds to “curly hair”, the electronic device optionally generates a second representation of the subject that includes a different hair curl shape (e.g., spiral shape) than a respective hair curl shape (e.g., zig-zag shape) associated with the first representation of the subject.

In some embodiments, the one or more selectable options include a reset option that, when selected, causes the electronic device to reset the appearance of the subject of the prompt to a state prior to detecting the sequence of one or more second inputs corresponding to the request to customize the appearance of the subject of the prompt using the respective ML model, such as option 630g in FIG. 6AB. For example, the electronic device optionally cancels or undoes any of the changes or customizations applied to the appearance of the subject. In some embodiments, the electronic device resets the appearance of the subject to a default or original state of the appearance of the subject. In some embodiments, resetting the appearance includes the electronic device setting the one or more selectable options to the automatic option as described above, such that, the electronic device automatically selects the one or more appearance characteristics without requiring user selection. In some embodiments, electronic device automatically selects the one or more appearance characteristics based on a photograph or other image of the subject.

In some embodiments, displaying the user interface of the automatically-generated visual media application for generating automatically-generated visual media using the respective ML model (e.g., the first ML model, the second ML model, or other ML model) includes displaying, via the one or more display generation components, one or more respective selectable options (e.g., first selectable options, second selectable options, or other selectable options) selectable to add, to the prompt, a plurality of suggested prompt components based on a respective style (e.g., a first style, a second style, or other style) associated with the respective ML model, such as the set of prompt components 602a through 602h in FIG. 6J. In some embodiments, the electronic device displays a subset of the plurality of suggested prompt components based on the respective style associated with the respective ML model being used for generating automatically-generated visual media as described herein. In some embodiments, the one or more respective selectable options include computer-generated suggested concepts (or, optionally referred to as a predefined concept) or recognized concepts (e.g., style, theme, mood, activity, costume, accessory, places, graphics, or visual characteristic that will influence the generation of the visual media). In some embodiments, in response to detecting one or more inputs to select a respective selectable option, the electronic device makes the plurality of suggested prompt component available for addition, to the prompt (e.g., the electronic device displays, via the one or more display generation components, the plurality of suggested prompt components. In some embodiments, the electronic device displays the plurality of suggested prompt components concurrently with the automatically-generated visual media item. In some embodiments, the plurality of suggested prompt components have one or more characteristics of the prompt component described above. In some embodiments, the respective style associated with the respective ML model has one or more characteristics of the visual style described above.

In some embodiments, displaying the plurality of suggested prompt components includes, in accordance with a determination that the respective ML model is the first ML model, such as the first ML model represented by style prompt component option 600e in FIG. 6J, displaying a first set of prompt components with a first appearance (e.g., an appearance that corresponds to the first ML model), such as the set of prompt components 602a through 602h in FIG. 6J. For example, when the electronic device determines that the respective ML model being used for generating automatically-generated visual media is the first ML model including a first style (e.g., animation, illustration, sketch, pixel art, anime, emoji, or other visual style described above), the electronic device presents a first set of prompt components. In some embodiments, the first set of prompt components include shared stylistic characteristics with the first style, are thematically related to the first style, and/or are consistent with the aesthetic or mood of the first style. For example, while the electronic device is set to generate automatically-generated visual media based on the first style (e.g., emoji) using the first ML model, the electronic device optionally displays one or more first selectable options to add one or more first prompt components from the first set of prompt components with the first visual appearance (e.g., emoji-based prompt components as described in more detail in method 800).

In some embodiments, displaying the plurality of suggested prompt components includes, in accordance with a determination that the respective ML model is the second ML model, such as the second ML model represented by style prompt component option 600e in FIG. 6L, displaying a second set of prompt components with a second appearance (e.g., an appearance that corresponds to the second ML model), different from the first set of prompt components, such as the set of emoji prompt components 618b through 618i in FIG. 6L. For example, while the electronic device optionally displays the one or more first selectable options to add one or more first prompt components from the first set of prompt components, the electronic device detects, via the one or more input devices, a sequence of one or more inputs (e.g., selection inputs described above) corresponding to a request to change the respective style being used to generate the automatically-generated visual media from the first style as described herein to a second style (e.g., a style other than the emoji style, such as an animation style or other style described above). In some embodiments, in response to detecting the sequence of one or more inputs corresponding to the request to change the respective style from the first style to the second style, the electronic device ceases to display the first set of prompt components with the first appearance and displays the second set of prompt components with the second appearance. In some embodiments, the concepts of the first set of prompt components and the second set of prompt components are the same, but the visual styles differ (e.g., rendered for display in different styles, such as emoji-based style and non-emoji, standard-based style). In some embodiments, in response to detecting the sequence of one or more inputs corresponding to the request to change the respective style from the first style to the second style, the electronic device ceases to display the first set of prompt components with the first appearance and displays the second set of prompt components with the second appearance. In some embodiments, the first set of prompt components with the first appearance are different from the second set of prompt components with the second appearance. For example, the first set of prompt components with the first appearance optionally include first computer-generated suggested concepts or first recognized concepts (e.g., emojis, stickers, and/or other graphics). In some embodiments, the second set of prompt components with the second appearance optionally include second computer-generated suggested concepts or second recognized concepts (e.g., style, theme, mood, activity, costume, accessory, places, graphics, or any of the other visual characteristics described above). In some embodiments, processes and/or characteristics described above with respect to the first set of prompt components with the first appearance apply to other prompt components, such as the second set of prompt components with the second appearance.

In some embodiments, the respective ML model specifies an emoji style used as a stylistic basis for generating the automatically-generated visual media item, as shown by style prompt component option 600e in FIG. 6L. In some embodiments, using an emoji style as a stylistic basis for generating the automatically-generated visual media item has one or more characteristics as using an emoji style as a stylistic basis for generating the automatically-generated visual media item described in more detail above and/or in method 800.

In some embodiments, displaying the user interface of the automatically-generated visual media application for generating automatically-generated visual media using the respective ML model (e.g., the first ML model, the second ML model, or other ML model) includes displaying, via the one or more display generation components, a plurality of suggested prompt components based on a respective style (e.g., a first style, a second style, or other style) associated with the respective ML model, such as the set of emoji prompt components 618b through 618i in FIG. 6L. In some embodiments, the plurality of suggested prompt components have one or more characteristics of the plurality of suggested prompt components based on the respective style (e.g., a first style, a second style, or other style) associated with the respective ML model described above.

In some embodiments, displaying the plurality of suggested prompt components includes, in accordance with a determination that the respective ML model is the first ML model, displaying one or more prompt suggested components (e.g., a plurality of suggested prompt components) that correspond to previously (e.g., frequently and/or recently) used emoji prompt components, such as previously used emoji prompt components 618f through 618i in FIG. 6L. In some embodiments, the previously used emoji prompt components include previously used emojis from the automatically-generated visual media application or another application (e.g., messaging application, whiteboarding application, drawings application, or other application) or a soft keyboard application of the electronic device (e.g., a built-in component of the electronic device or input method of the operating system of the electronic device). Recently used optionally refers to utilized or accessed within a predetermined period of time (e.g., three days, one week, one month, six months, or one year). Previously used optionally refers to prompt components used most frequently and/or last used by the user of the electronic device irrespective of a time since the prompt components were last used. Previously used optionally refers to utilized or accessed within the automatically-generated visual media application or any of the other applications described herein. In some embodiments, the previously used emojis include standard emojis, previously generated and saved automatically-generated emojis, stickers, and/or other image. In some embodiments, the respective prompt components include previously generated and saved automatically-generated emojis.

In some embodiments, displaying the user interface of the automatically-generated visual media application for generating automatically-generated visual media using the respective ML model (e.g., the first ML model, the second ML model, or other ML model) includes displaying, via the one or more display generation components, a content entry field for inputting a prompt component, such as content entry field 600f in FIG. 6A.

In some embodiments, while displaying the content entry field for inputting the prompt component, the electronic device detects, via one or more input devices, one or more second inputs (e.g., one or more selection inputs as described above in more detail with reference to the sequence of one or more inputs directed to the user interface corresponding to the request to generate the automatically-generated visual media item based on the prompt) directed to the content entry field, such as selection with contact 604af in FIG. 6AF.

In some embodiments, in response to detecting the one or more second inputs directed to the content entry field, displaying, via the one or more display generation components, a soft keyboard operating in an emoji mode for entering emoji content into the content entry field, such as shown by soft keyboard user interface element 642b that includes a plurality of selectable emojis 642j in FIG. 6AG. In some embodiments, the content entry field has one or more characteristics of the one or more content entry fields described above and/or in method 800. For example, while the electronic device is set to generate automatically-generated visual media based on the first style (e.g., emoji) using the respective ML model as described above, the electronic device optionally provides direct access to the soft keyboard operating in the emoji mode (e.g., instead of displaying the soft keyboard in a standard (e.g., non-emoji) mode that includes characters such as letters, numbers, and special characters other than emojis). In some embodiments, a standard keyboard optionally refers to a keyboard having a QWERTY layout, an AZERTY layout, or other common layout. For example, while operating in the emoji mode, the soft keyboard user interface includes saved automatically-generated emojis, standard emojis and/or stickers, which are available for selection and insertion into the prompt. In some embodiments, this soft keyboard user interface including the saved automatically-generated emojis is a component of the operating system of the electronic device, universally accessible across various applications, different from the automatically-generated visual media application.

In some embodiments, displaying the user interface of the automatically-generated visual media application for generating automatically-generated visual media using the respective ML model (e.g., the first ML model, the second ML model, or other ML model) includes displaying, via the one or more display generation components, respective suggested prompt components (e.g., first prompt components, second prompt components, or other prompt components) based on a respective style (e.g., a first style, a second style, or other style) associated with the respective ML model, such as the set of emoji prompt components 618b through 618i in FIG. 6AH. In some embodiments, the respective prompt components have one or more characteristics of the first prompt components described above. In some embodiments, the respective prompt components have one or more characteristics of the one or more respective selectable options selectable to add, to the prompt, the first prompt components described above.

In some embodiments, in accordance with a determination that the respective ML model is the first ML model, the respective suggested prompt components are emotive emoji prompt components, such as emoji prompt components 618f through 618i in FIG. 6AH. In some embodiments, the electronic device determines that the first ML model specifies an emoji style as the stylistic basis for generating the automatically-generated visual media item. Thus, in some embodiments, when the electronic device determines this, the electronic device displays a first subset of emoji prompt components (e.g., the emotive emoji prompt components). Emotive emoji prompt components optionally correspond to emojis that express feelings and/or emotions. In some embodiments, the electronic device displays other subsets of emoji prompt components, different from the first subset, such as emojis related to objects, animals, activities, symbols, locations, hand gestures, and/or other emojis that do not necessarily convey a feeling. In some embodiments, in accordance with a determination that the respective ML model is the second ML model (e.g., an ML model specifying a style other than the emoji style, such as an illustration style, photographic style, charcoal style, sketch style, or any of the other styles described above not including an emoji-based style), the respective suggested prompt components include styles and/or concepts that are not based on the emoji style. For example, the respective suggestive prompt components include themes (e.g., adventure, birthday, spring, party, love, and/or other themes), costumes (e.g., artist, astronaut, hiker, farmer, royalty, and/or other costumes), accessories (e.g., baseball cap, beanie, scarf, sunglasses, and/or other accessories), places (e.g., city, mountains, volcano, stage, space, and/or other places) and/or other concepts described above that will influence the generation of the automatically-generated visual media.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800, 1000, and/or 1200) are also applicable in an analogous manner to method 700 described above with respect to FIG. 7. For example, the operation of the electronic device generating automatically-generated visual media using a machine learning (ML) model described above with reference to method 700 optionally has one or more of the characteristics of making automatically-generated visual media accessible in different locations, displaying an automatically-generated visual media item at a new size, and/or displaying an automatically-generated visual media item with a different appearance based on an appearance parameter described herein with reference to other methods described herein (e.g., methods 800, 1000, and/or 1200). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, displaying and detecting operation 702 and determining operations 706 and 708 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

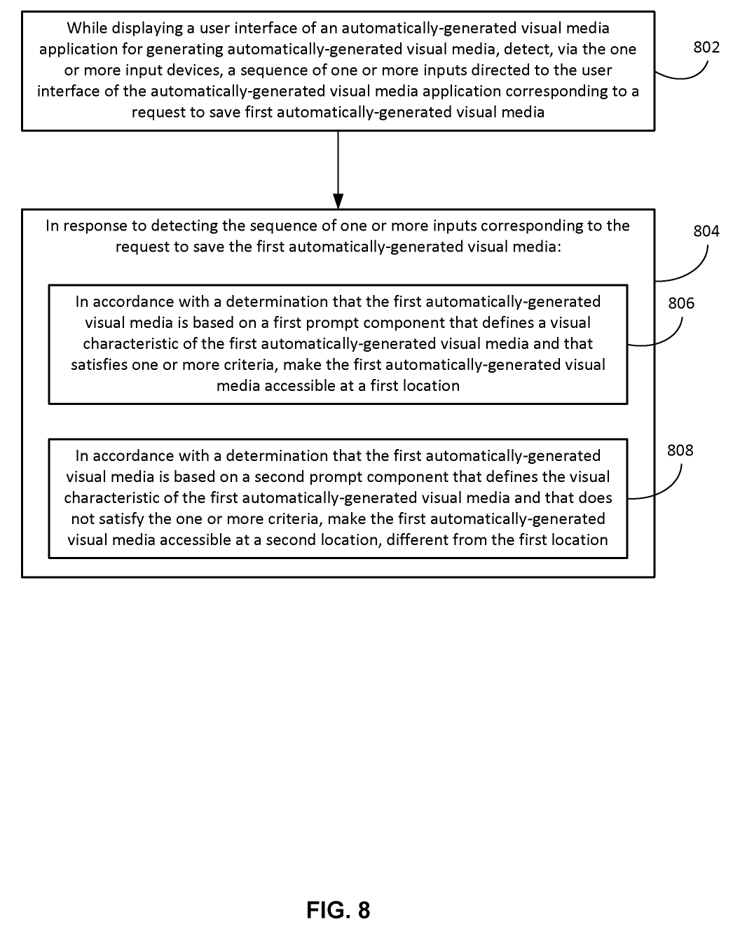

FIG. 8 illustrates a flow diagram illustrating a method in which an electronic device makes automatically-generated visual media accessible in different locations in accordance with some embodiments of the disclosure. The method 800 is optionally performed at first electronic device and/or electronic devices such as device 100, device 300, or device 500 as described above with reference to FIGS. 1A-1B, 2-3, 4A-4B and 5A-5H. Some operations in method 800 are, optionally combined and/or order of some operations is, optionally, changed.

In some embodiments, method 800 is performed at an electronic device (e.g., electronic device 500 in FIGS. 5A and/or 6A) in communication with one or more display generation components (e.g., display generation component 504 in FIGS. 5A and/or 6A) and one or more input devices. In some embodiments, the electronic device has one or more characteristics of the electronic device described in method 700. In some embodiments, the one or more display generation components have one or more characteristics of the display generation component described in method 700. In some embodiments, the one or more input devices have one or more characteristics of the one or more input devices described in method 700.

In some embodiments, while displaying a user interface of an automatically-generated visual media application for generating automatically-generated visual media, the electronic device detects (e.g., 802), via the one or more input devices, a sequence of one or more inputs directed to the user interface of the automatically-generated visual media application corresponding to a request to save first automatically-generated visual media, such as selection input with contact 604e directed to save user interface element 600d in FIG. 6E. In some embodiments, the automatically-generated visual media application has one or more characteristics of the automatically-generated visual media application described in method 700. In some embodiments, the first automatically-generated visual media has one or more characteristics of the automatically-generated visual media described in method 700. In some embodiments, the sequence of one or more inputs directed to the automatically-generated visual media application corresponding to the request to save the automatically-generated visual media have one or more characteristics of the sequence of one or more inputs directed to the automatically-generated visual media application described in method 700. For example, the sequence of one or more inputs directed to the automatically-generated visual media application corresponding to the request to save the first automatically-generated visual media optionally include one or more selection inputs directed to a user interface element that, when selected, causes the electronic device to save the first automatically-generated visual media as described herein. In some embodiments, a selection input includes a tap gesture including contact (e.g., using a finger or stylus) on a touch-sensitive surface corresponding to the user interface element, an air pinch gesture while attention (e.g., based on gaze) of the user of the electronic device is directed to the user interface element, a forward pointing in-air gesture directed to the user interface element, actuation of an indirect input device, such as a mouse, trackpad, or controller while a cursor is directed to the user interface element (or, optionally, while the first prompt component has input focus), and/or voice input from the user corresponding to the request to save the automatically-generated visual media as described herein. In some embodiments, in response to detecting the sequence of one or more inputs directed to the user interface element, the electronic device changes a visual appearance of the user interface element and/or displays the user interface element with an animated visual effect as will be described in more detail below. In some embodiments, in response to detecting the sequence of one or more inputs directed to the user interface element, the electronic device changes a visual appearance of a second user interface element associated with the automatically-generated visual media and/or displays the second user interface element with an animated visual effect as described in more detail below. In some embodiments, the second user interface element is a container user interface element that appears to visually contain the first automatically-generated visual media.

In some embodiments, while the automatically-generated visual media application is currently active on the electronic device for generating automatically-generated visual media, such as shown with the display of the visual media creation user interface 600a of the automatically-generated visual media application in FIG. 6A, the electronic device displays, via the one or more display generation components, a user interface for receiving a prompt for use in generating automatically-generated visual media as described in method 700 and in more detail below. In some embodiments, the user interface includes a representation of first generative visual content based on the prompt. In some embodiments, and as will be described in more detail below, the electronic device displays the preview of the first automatically-generated visual media in a manner (e.g., in a preview mode-type of display view), such as contained within a frame or the container user interface element described herein. For example, the electronic device optionally displays representations of different automatically-generated visual media including the first generative visual media (e.g., a collection or set of a plurality of different visual media variants generated by an ML model) within the frame. In some embodiments, and as will be described in more detail below, the electronic device saves one or more of the plurality of different automatically-generated visual media. In some embodiments, the electronic device generates the automatically-generated visual media in any of the ways or manners described in method 700.

In some embodiments, in response to detecting the sequence of one or more inputs corresponding to the request to save the first automatically-generated visual media (e.g., 804), in accordance with a determination that the first automatically-generated visual media is based on a first prompt component that defines a visual characteristic of the first automatically-generated visual media and that satisfies one or more criteria, the electronic device makes (e.g., 806) the first automatically-generated visual media accessible at a first location, such as the automatically-generated visual media library user interface 624a in FIG. 6S. In some embodiments, the first prompt component has one or more characteristics of the one or more prompt components described in method 700. In some embodiments, the first prompt component includes text, keywords, images, video, special characters, visual media, and/or other inputs describing a concept (e.g., style, theme, mood, activity, costume, accessory, places, graphics, or visual characteristic that will influence the generation of the visual media). In some embodiments, the first prompt component that defines a visual characteristic includes a style used to give the first automatically-generated visual media a particular aesthetic appearance or overall artistic look. Styles optionally include animation, illustration, sketch, emoji, cartoon, natural, black and white, painting, anime, pixel art, pop art, watercolor, oil painting, cyberpunk, or other image style. In some embodiments, the one or more criteria include a requirement that the first prompt component includes a style associated with the first location in order for the one or more criteria to be satisfied. For example, the electronic device optionally determines that the one or more criteria are satisfied when the first prompt component that defines the visual characteristic of the first automatically-generated visual media includes a style other than an emoji style or emoji characters (e.g., still and/or animated picture characters that are not text characters in written human languages). Alternatively or additionally, the requirement that the first prompt component includes the concept associated with the first location is optionally based on the detected input mechanism or mode. For example, the electronic device detects entry (or, optionally, input) of the first prompt component via a standard (soft) keyboard (e.g., not an emoji (soft) keyboard) and/or while the keyboard is operating in standard mode (e.g., not emoji mode). In some embodiments, the first location is associated with the automatically-generated visual media application. In some embodiments, making the first automatically-generated visual media accessible at a first location includes displaying, via the one or more display generation components, an automatically-generated visual media library user interface of the automatically-generated visual media application that includes a collection of saved automatically-generated visual media. In some embodiments, the electronic device displays the automatically-generated visual media library user interface in response to detecting an input corresponding to a request to open the automatically-generated visual media application. In some embodiments, the electronic device displays the automatically-generated visual media library user interface in response to detecting an input corresponding to a request to display the automatically-generated visual media library user interface. In some embodiments, the electronic device stores the automatically-generated visual media application to memory or internal storage of the electronic device and/or cloud storage. In some embodiments, the storage of the automatically-generated visual media is managed by a database of the automatically-generated visual media application or other media library application. In some embodiments, a storage location associated with the automatically-generated visual media application includes a plurality of saved visual media.

In some embodiments, the automatically-generated visual media library user interface is accessible by a second application, different from the automatically-generated visual media application, such as a messaging application shown in FIG. 6AJ, a notes application, an email application, a presentation application, a word processing application, a whiteboarding application, a sketching application, a spreadsheet application, a journaling application, and/or other content processing application. In some embodiments, the automatically-generated visual media is accessible at a location, different from the first location associated with the automatically-generated visual media application (e.g., the automatically-generated visual media library user interface), such as a location associated with a photo and/or video management application of the electronic device. In some embodiments, this location associated with the photo and/or video management application includes a plurality of images and/or videos captured using one or more camera(s) of the electronic device. In some embodiments, the automatically-generated visual media, the images and/or videos in this location and/or the first location associated with the automatically-generated visual media application are saved on the electronic device and/or on a server (e.g., cloud server) in communication with the electronic device. In some embodiments and as will be described in more detail below, the electronic device displays in the user interface of the automatically-generated visual media application the automatically-generated visual media library user interface and/or element that, when accessed (or, optionally, selected or displayed), causes the electronic device to display the automatically-generated visual media and optionally, the plurality of images and/or videos (e.g., without navigating away from the automatically-generated visual media application).

In some embodiments, in response to detecting the sequence of one or more inputs corresponding to the request to save the first automatically-generated visual media (e.g., 804),in accordance with a determination that the first automatically-generated visual media is based on a second prompt component that defines the visual characteristic of the first automatically-generated visual media and that does not satisfy the one or more criteria, the electronic device makes (e.g., 808) the first automatically-generated visual media accessible at a second location, different from the first location, such as the soft keyboard user interface element 622a in FIG. 6R. In some embodiments, the second location is not associated with the automatically-generated visual media application. In some embodiments, the second prompt component has one or more characteristics of the one or more prompt components described in method 700. In some embodiments, the first prompt component defines a first style for the visual characteristic and the second prompt component defines a second style, different from the first style, for the visual characteristic. In some embodiments, the electronic device determines that the one or more criteria are not satisfied when the second prompt component that defines the visual characteristic of the first automatically-generated visual media includes a style corresponding to an emoji, emoji characters, or indicates an emoji style for the automatically-generated visual media. Alternatively or additionally, the electronic device optionally determines that the one or more criteria are not satisfied when the electronic device detects entry (or, optionally, input) of the second prompt component via an emoji keyboard (e.g., not a standard keyboard) and/or while the keyboard is operating in emoji mode (e.g., not standard mode). In some embodiments, the automatically-generated visual media generated based on the second prompt component is an automatically-generated emoji. In some embodiments, the automatically-generated emoji refers to a digital representation, such as an avatar or icon, that is created or customized to express a range of emotions, actions, or personal attributes. In some embodiments, unlike standard emojis that exist in predefined forms, automatically-generated emojis are designed to reflect specific features of an individual user or character, including customizable aspects such as physical attributes, attire, accessories, and/or any other personal attributes that define the user or character. In some embodiments, the automatically-generated emoji is generated based on one or more user inputs and/or preferences or automatically based on a human subject or candidate subject. Other characteristics of automatically-generated emojis will be described in more detail below. In some embodiments, the second location that is not associated with the automatically-generated visual media application is a keyboard user interface of a soft keyboard application of the electronic device (e.g., a built-in component of the electronic device or input method of the operating system of the electronic device). In some embodiments, the electronic device displays, via the one or more display generation components, the keyboard user interface of the soft keyboard application in response to detecting one or more inputs corresponding to a request to enter text, characters, and/or emojis. In some embodiments, the keyboard user interface is displayed in the automatically-generated visual media application, the messaging application, any of the applications described herein, and/or other applications where text entry is provided. In some embodiments, the keyboard user interface includes one or more selectable options that, when selected, causes the electronic device to display the saved automatically-generated emojis, standard emojis and/or stickers, which are available for selection and insertion into any of the applications described herein. In some embodiments, the keyboard user interface is a component of the operating system of the electronic device, universally accessible across the various applications described herein. In some embodiments, access to the saved automatically generated emojis via the keyboard user interface is a capability or feature integrated within the automatically-generated visual media application and/or the soft keyboard application. Saving the automatically-generated visual media to different locations based on a prompt component, and in response to detecting a sequence of one or more inputs corresponding to a request to save the automatically-generated visual media, provides quick access to the saved visual media in appropriate locations at which the saved visual media is most likely to be used/accessed by the user, which reduces power usage and improves battery life of the electronic device by making generated visual media accessible at different locations to the user and in a manner that is quick and efficient.

In some embodiments, the first prompt component indicates that the first automatically-generated visual media should use an emoji style (e.g., based on two emoji being selected as prompt components or based on an explicit request to use an “emoji” style for the output of the automatically-generated visual media), such as style prompt component option 600e in FIG. 6L. In some embodiments, the first automatically-generated visual media is an automatically-generated emoji generated based on two or more (e.g., not automatically generated, predetermined, or existing) emojis, such as, for example, the two emojis 642h and 642i in FIG. 6AG. In some embodiments, the visual characteristic includes an emoji style as described above. In some embodiments, when the visual characteristic is the emoji style, the electronic device requires one or more criteria to be satisfied before generating the automatically-generated visual media based on the emoji style (e.g., optionally referred to as an automatically-generated emoji). For example, the one or more criteria includes a requirement that the respective prompt (e.g., the first prompt, the second prompt, or the third prompt) includes a combination of standard, predefined emojis (e.g., not automatically generated) that satisfy a predefined format in order for the one or more criteria to be satisfied. In some embodiments, the predefined format optionally includes a first requirement that the respective prompt includes two or more emojis. In some embodiments, the predefined format includes a second requirement that a prompt component of the respective prompt does not include multiple (e.g., more than one) emoji. In some embodiments, the predefined format optionally includes a third requirement that the prompt component does not include a combination of one or more emojis and text. In some embodiments, the predefined format optionally includes a fourth requirement that at least two prompt components of the respective prompt include one, single emoji. In some embodiments, the electronic device determines that the one or more criteria are satisfied when the prompt includes two or more prompt components (e.g., optionally, referred to as two or more emoji prompt components), with each prompt component including an emoji resulting in the electronic device combining the two or more prompt components (e.g., the two or more emojis) into one automatically-generated visual media (e.g., automatically-generated emoji). In some embodiments, combining the two or more emoji prompt components include combining emojis from different categories, such as objects, expressions, animals, people, activities, travel, nature, symbols, locations, hand gestures, and/or other category. For example, combining a panda emoji and a kissing emoji optionally results in a kissing panda automatically-generated emoji. In another example, combining a ballerina emoji and a cat emoji optionally results in a cat ballerina automatically-generated emoji. In some embodiments, the one or more criteria are not satisfied when the respective prompt includes a combination of characters that do not satisfy the predefined format as described above with reference to first, second, third, and fourth requirements. For example, the electronic device, using one or more language models or any of the ML models described above and/or in method 700, optionally determines that the combination of characters included in the respective prompt have more than one meaning or interpretation. In some embodiments, forgoing generating the automatically-generated visual media based on the respective prompt includes displaying, via the one or more display generation components, an indication that the respective prompt component does not satisfy the one or more criteria to generate the automatically-generated visual media. In some embodiments, while running another application, different from the automatically-generated visual media application, such as a messaging application or any of the other applications described below, the electronic device enforces one or more of the respective criteria (e.g., the first criteria, the second criteria, the third criteria, or other criteria) described herein. In some embodiments, while running the other application, the electronic device considers one or more other criteria or requirements when generating automatically-generated visual media described in more detail below. In some embodiments, while running the other application, the electronic device performs one or more other actions or functions related to the other application, such as combining at least two emojis to generate an automatically-generated visual media as described in more detail below.

In some embodiments, the first location is associated with the automatically-generated visual media application (e.g., as described above), such as the automatically-generated visual media library user interface 624a in FIG. 6S. In some embodiments, the second location is associated with an operating system of the electronic device (e.g., as described above), such as the soft keyboard user interface element 622a in FIG. 6R. In some embodiments, in response to detecting the sequence of one or more inputs corresponding to the request to save the first automatically-generated visual media, in accordance with a determination that the first automatically-generated visual media is based on a third prompt component that defines the visual characteristic of the first automatically-generated visual media and that satisfies one or more second criteria (e.g., the prompt is received from a messaging application or the third prompt component and/or the first automatically-generated visual media that is based on the third prompt component indicates a background wallpaper), making the first automatically-generated visual media accessible at a third location that is different from the first location and the second location, such as the automatically-generated visual media library user interface 624a in FIG. 6S. For example, the third location is optionally associated with the messaging application or an automatically-generated visual media library user interface of the automatically-generated visual media application that includes a collection of saved automatically-generated visual media. In some embodiments, the electronic device generates different types of automatically-generated visual media based on the user interface and/or application requesting the automatically-generated visual media described in more detail in method 1200. In some embodiments, the electronic device generates background wallpaper or a messaging conversation background (e.g., automatically-generated background wallpaper) that is based on the content of a messaging conversation of the messaging application as described in more detail below. For example, when the electronic device determines that the messaging conversation includes content related to “beach”, “sunny”, “swimsuit”, and/or “surf”, the electronic device generates automatically-generated background wallpaper that includes corresponding visual elements such as beach balls, sunglasses, and/or surfboards.

In some embodiments, in response to detecting the sequence of one or more inputs corresponding to the request to save the first automatically-generated visual media, in accordance with the determination that the first automatically-generated visual media is based on the first prompt component that defines the visual characteristic of the first automatically-generated visual media and that satisfies the one or more criteria, the electronic device displays, via the one or more display generation components, a first visual effect indicative of saving the first automatically-generated visual media (e.g., without displaying a second visual effect and/or a third visual effect described below), such as changing the appearance of the save user interface element 600d as shown in FIGS. 6E and 6F. In some embodiments, the electronic device displays a variety of visual effects indicative of the respective location (e.g., the first location, the second location, the third location, or other location) at which to access the saved first automatically-generated visual media as described herein. In some embodiments, after generating the first automatically-generated visual media, the electronic device displays, via the one or more display generation components, a save user interface element that, when selected, causes the electronic device to save the first automatically-generated visual media. In some embodiments, the electronic device changes a state including a visual appearance and/or content of the save user interface element based on a status of the process of generating automatically-generated visual media. For example, when the electronic device determines that the automatically-generated visual media application is in an idle state (e.g., waiting for a prompt for use in generating the automatically-generated visual media), the electronic device disables the save user interface element such that the save user interface element is not selectable perform a save operation. In some embodiments, the electronic device displays the disabled save user interface element with a dimmed visual appearance. In some embodiments, when the electronic device receives or detects a prompt, the electronic device initiates the process to generate an automatically-generated visual media. In some embodiments, after generating the automatically-generated visual media based on the prompt (e.g., displaying a preview of the automatically-generated visual media based on the prompt), the electronic device enables the save user interface element such that the save user interface element is selectable perform a save operation (e.g., save the automatically-generated visual media based on the prompt). In some embodiments, the electronic device applies a visual effect to the save user interface element and/or the electronic device changes the content and/or visual characteristic of the save user interface element to indicate saving the automatically-generated visual media and/or to indicate the location at which to access the saved automatically-generated visual media as described in more detail below.

In some embodiments, the one or more criteria have one or more characteristics of the one or more criteria described above. For example, the one or more criteria include a requirement that the first prompt component that defines the visual characteristic of the first automatically-generated visual media includes a style other than an emoji style in order for the one or more criteria to be satisfied as described above, such as a pixel art style, animation style, steampunk style, or other style. In some embodiments, the first visual effect indicative of saving the first automatically-generated visual media is a visual effect applied when performing the process of saving an automatically-generated visual media that is based on the style other than the emoji style. For example, while the electronic device displays a preview of the first automatically-generated visual media, the electronic device displays the save user interface element selectable to save the first automatically-generated visual media. In some embodiments, in response to detecting the sequence of one or more inputs corresponding to the request to save the first automatically-generated visual media as described above, the electronic device displays the first visual effect that includes displaying a progress indicator while the process of saving the first automatically-generated visual media is ongoing (e.g., replacing the save user interface element with the progress indicator). In some embodiments, after the process of saving the first automatically-generated visual media is complete, the electronic device replaces the progress indicator with a completion indicator, such as a checkmark and/or content confirming the first automatically-generated visual is saved. In some embodiments, and as will be described in more detail below, the electronic device displays the save user interface element in the enabled state in response to a request to regenerate the automatically generated visual media based on the prompt or generate a second automatically-generated visual media based on the prompt (e.g., variant).

In some embodiments, in response to detecting the sequence of one or more inputs corresponding to the request to save the first automatically-generated visual media, in accordance with the determination that the first automatically-generated visual media is based on the second prompt component that defines the visual characteristic of the first automatically-generated visual media and that does not satisfy the one or more criteria, the electronic device displays, via the one or more display generation components, a second visual effect indicative of saving the first automatically-generated visual media, different from the first visual effect (e.g., without displaying the first visual effect described above and/or a third visual effect described below), such as the animated effect 622 shown in FIGS. 6N-6R.

In some embodiments, the electronic device determines that the one or more criteria are not satisfied when the second prompt component that defines the visual characteristic of the first automatically-generated visual media includes a style corresponding to an emoji, emoticon, emoji characters, or indicates an emoji style for the automatically-generated visual media. In some embodiments, the second visual effect indicative of saving the first automatically-generated visual media is a visual effect applied when performing the process of saving an automatically-generated visual media that is based on the emoji style. For example, while the electronic device displays a preview of the first automatically-generated visual media, the electronic device displays the save user interface element selectable to save the first automatically-generated visual media. In some embodiments, the save user interface element includes content based on the emoji style as described in more detail below and/or in method 700. In some embodiments, in response to detecting the sequence of one or more inputs corresponding to the request to save the first automatically-generated visual media as described above, the electronic device displays the second visual effect that includes displaying a progress indicator while the process of saving the first automatically-generated visual media is ongoing (e.g., replacing the save user interface element with the progress indicator). In some embodiments, when the electronic device determines that the process of saving the first automatically-generated visual media is nearing completion or after the process of saving the first automatically-generated visual is complete, the second visual effect includes displaying, via the one or more display generation components, a soft keyboard operating in the emoji mode (e.g., instead of displaying the soft keyboard in a standard (e.g., non-emoji) mode) as described in more detail below. In some embodiments, the second visual effect gives the preview of the first automatically-generated visual media an appearance of moving from a location within the user interface of the automatically-generated visual media application to a location within the soft keyboard as described in more detail below. In some embodiments, after the process of saving the first automatically-generated visual media is complete, the electronic device displays a preview of the first automatically-generated visual media within the soft keyboard and/or replaces the progress indicator with a completion indicator, such as a checkmark and/or content confirming the first automatically-generated visual is saved.

In some embodiments, in accordance with the determination that the first automatically-generated visual media is based on the third prompt component that defines the visual characteristic of the first automatically-generated visual media and that satisfies the one or more second criteria, displaying, via the one or more display generation components, a third visual effect indicative of saving the first automatically-generated visual media, different from the second visual effect and the first visual effect (e.g., without displaying the first visual effect and/or the third visual effect described above). In some embodiments, the one or more second criteria have one or more characteristics of the one or more second criteria described above. For example, the one or more second criteria include a requirement that the prompt is received from a messaging application or the third prompt component and/or the first automatically-generated visual media that is based on the third prompt component indicates a background wallpaper in order for the one or more second criteria to be satisfied as described in more detail with reference to method(s) 1000 and/or 1200. In some embodiments, the third visual effect indicative of saving the first automatically-generated visual media is a visual effect applied when performing the process of saving an automatically-generated visual media that includes background wallpaper as described in more detail with reference to method(s) 1000 and/or 1200. For example, while the electronic device displays a preview of the first automatically-generated visual media, the electronic device displays the save user interface element selectable to save the first automatically-generated visual media. In some embodiments, in response to detecting the sequence of one or more inputs corresponding to the request to save the first automatically-generated visual media as described above, the electronic device displays the third visual effect that includes displaying a progress indicator while the process of saving the first automatically-generated visual media is ongoing (e.g., replacing the save user interface element with the progress indicator). In some embodiments, after the process of saving the first automatically-generated visual media is complete, the electronic device replaces the progress indicator with a completion indicator, such as a checkmark and/or content confirming the first automatically-generated visual is saved. In some embodiments, the third visual effect includes other effects and/or animations as described in more detail with reference to method(s) 1000 and/or 1200.

In some embodiments, prior to detecting the sequence of one or more inputs corresponding to the request to save the first automatically-generated visual media, in accordance with the determination that the first automatically-generated visual media is based on the first prompt component that defines the visual characteristic of the first automatically-generated visual media and that satisfies the one or more criteria (e.g., described above), the electronic device displays, via the one or more display generation components, a user interface element including first content indicative of making the first automatically-generated visual media accessible at the first location, such as shown by save user interface element 600d in FIG. 6D. In some embodiments, the electronic device displays a variety of content (e.g., content of a user interface element described herein) indicative of the respective location (e.g., the first location, the second location, the third location, or other location) at which to access the saved first automatically-generated visual media as described herein. In some embodiments, the user interface element has one or more characteristics of the save user interface element described above. In some embodiments, the first content indicative of making the first automatically-generated visual media accessible at the first location includes standard, recognizable text (e.g., “Save” and/or other text) and/or graphics (e.g., progress indicator, checkmark, and/or other graphic) that enables the user to infer that the first automatically-generated visual media is accessible at the first location.

In some embodiments, in accordance with the determination that the first automatically-generated visual media is based on the second prompt component that defines the visual characteristic of the first automatically-generated visual media and that does not satisfy the one or more criteria (e.g., described above), the electronic device displays, via the one or more display generation components, the user interface element including second content indicative of making the first automatically-generated visual media accessible at the second location, such as shown by the save user interface element 600d in FIG. 6L. In some embodiments, the second content indicative of making the first automatically-generated visual media accessible at the second location includes text (e.g., “Add Emoji”, “Add to Keyboard”, and/or other text) and/or graphics (e.g., progress indicator, checkmark, and/or other graphic) that enables the user to infer that the first automatically-generated visual media is accessible at the second location. In some embodiments, in accordance with the determination that the first automatically-generated visual media is based on the third prompt component that defines the visual characteristic of the first automatically-generated visual media and that satisfies the one or more second criteria (e.g., described above), displaying, via the one or more display generation components, a user interface element including third content indicative of making the first automatically-generated visual media accessible at the third location. In some embodiments, the third content indicative of making the first automatically-generated visual media accessible at the third location includes text (e.g., “Add Background”, “Save”, and/or other text) and/or graphics (e.g., progress indicator, checkmark, and/or other graphic) that enables the user to infer that the first automatically-generated visual media is accessible at the third location.

In some embodiments, displaying the user interface of the automatically-generated visual media application for generating automatically-generated visual media includes displaying, via the one or more display generation components, a preview of the first automatically-generated visual media, such as the preview 610a of the second automatically-generated visual media item in FIG. 6E. In some embodiments, the preview (or, optionally, referred to as the representation) of the first automatically-generated visual media has one or more characteristics of the preview of the first automatically-generated visual media described above. In some embodiments, the preview of the first automatically-generated visual media optionally refers to a preview of the first automatically-generated visual media. In some embodiments, the preview of the first automatically-generated visual media has a level of fidelity lower than the saved first automatically-generated visual media or a second preview of the first automatically-generated visual media. For example, the representation of first automatically-generated visual media does not include all the elements, features, and/or characteristics that are included in the saved first automatically-generated visual media or the second preview of the first automatically-generated visual media. For example, the preview of the first automatically-generated visual media leaves out or does not represent some aspects or components of the prompt (e.g., some details/nuances of the prompt or one or more prompt components are not present). In some embodiments, the second preview of the first automatically-generated visual media optionally refers to an enlarged version of the preview of the first automatically-generated visual media. In some embodiments, the electronic device displays, via the one or more display generation components, the second preview of the first automatically-generated visual media in response to detecting one or more inputs (e.g., one or more selection inputs as described above) directed to the preview of the first automatically-generated visual media.

In some embodiments, in accordance with the determination that the first automatically-generated visual media is based on the first prompt component that defines the visual characteristic of the first automatically-generated visual media and that satisfies the one or more criteria (e.g., described above), the electronic device displays the preview of the first automatically-generated visual media with a visual characteristic having a first value, such as shown by the preview 610a of the second automatically-generated visual media item in FIG. 6E. In some embodiments, the electronic device displays the preview of the first automatically-generated visual media with a visual characteristic having a respective value (e.g., a first value, a second value, or other value) based on the visual characteristic (e.g., style) of the first automatically-generated visual media as described herein. For example, the visual characteristic at which the electronic device displays the preview of the first automatically-generated visual media optionally includes the preview of the first automatically-generated visual media contained within a frame or a container user interface element. In some embodiments, the first value corresponds to a quadrilateral or square shape. In some embodiments, the electronic device displays the preview of the first automatically-generated visual media with the square shape independent of the shape of the frame containing the preview of the first automatically-generated visual media. In some embodiments, the visual characteristic includes a size, an aspect ratio, and/or other characteristic described in method 1000.

In some embodiments, in accordance with the determination that the first automatically-generated visual media is based on the second prompt component that defines the visual characteristic of the first automatically-generated visual media and that does not satisfy the one or more criteria (e.g., described above), the electronic device displays the preview of the first automatically-generated visual media with the visual characteristic having a second value, different from the first value, such as the preview 620a of the fifth automatically-generated visual media item in FIG. 6M.. In some embodiments, the second value corresponds to a circular shape. For example, when the visual characteristic does not satisfy the one or more criteria as described above (e.g., the visual characteristic corresponds to an emoji style), the electronic device displays the preview of the first automatically-generated visual media contained within a circular container. Thus, in some embodiments, the electronic device displays the preview of the first automatically-generated visual media within a container suitable for the particular style (e.g., shape selection is style dependent). For example, automatically-generated visual media with an emoji style representing an emotion and/or object with minimal context/background are optionally contained in circular-shaped containers. In another example, automatically-generated visual media with an animation style (e.g., or other style not including the emoji style) including a background or scene are optionally contained in square-shaped containers.

In some embodiments, after making the first automatically-generated visual media accessible at a respective location (e.g., the first location, the second location, the third location, or other location), the electronic device detects, via one or more input devices, a sequence of one or more second inputs corresponding to a request to input content into a second user interface that is not a user interface of the automatically-generated visual media application, such as keywords 648a entered in content entry field 600f in FIG. 6AG. In some embodiments, the second user interface is a user interface of a messaging application, a notes application, an email application, a presentation application, a word processing application, a whiteboarding application, a sketching application, a spreadsheet application, a journaling application, and/or other content processing application. In some embodiments, the sequence of one or more second inputs includes one or more content entry (or handwritten) inputs using one or more content entry user interface elements described herein, a physical (or hardware) keyboard, a touch-sensitive surface (e.g., via typing inputs on a virtual keyboard), touchpad, stylus, and/or dictation corresponding to a request to add content to the second user interface. In some embodiments, the electronic device optionally identifies a request to input content via the second user interface in response to detecting, via the one or more input devices, a sequence of one or more inputs to navigate to the second user interface and select an option to access one or more content entry user interface elements (e.g., the soft keyboard user interface element) as described herein.

In some embodiments, in response to detecting the sequence of one or more second inputs corresponding to the request to input content into the second user interface, the electronic device displays, via the one or more generation components, one or more content entry user interface elements that include the first automatically-generated visual media, such as soft keyboard user interface element 642b in FIG. 6AJ. In some embodiments, the one or more content user interface elements include the soft keyboard user interface element operating in the emoji mode (e.g., instead of displaying the soft keyboard in a standard (e.g., non-emoji) mode). In some embodiments, the soft keyboard user interface element operating in the emoji mode includes saved automatically-generated visual media (e.g., automatically-generated emojis), standard emojis and/or stickers, which are available for selection and insertion into the second user interface. For example, the electronic device optionally detects, via one or more input devices, one or more inputs (e.g., selection inputs described above) directed to the one or more content entry user interface elements, and in response, the electronic device enters the first automatically-generated visual media into the second user interface. Thus, in some embodiments, the saved automatically-generated emojis are accessible across a variety of user interfaces and applications, different from the automatically-generated visual media application.

In some embodiments, the entry of content into the one or more content entry user interface elements optionally refers to a process by which the electronic device recognizes and captures information that the user inputs into the one or more content entry user interface elements. In some embodiments, the content refers to specific data, commands, and/or parameters entered by the user into the one or more content entry user interface elements. In some embodiments, the saved automatically-generated visual media is associated with metadata. In some embodiments, the electronic device recognizes the content entered and displays one or more saved automatically-generated visual media including the first automatically-generated visual media associated with metadata matching and/or satisfying the content entered. In some embodiments, the electronic device uses one or more large language models (LLMs) and/or any of the ML models described above and/or below to identify the one or more saved automatically-generated visual media in response to detecting the sequence of one or more second inputs (e.g., one or more content entry inputs) described herein.

In some embodiments, in response to detecting the sequence of one or more second inputs corresponding to the request to input content via the second user interface (e.g., described above with reference to the one or more content entry (or handwritten) inputs using one or more content entry user interface elements, a physical (or hardware) keyboard, a touch-sensitive surface (e.g., via typing inputs on a virtual keyboard), touchpad, stylus, and/or dictation corresponding to a request to add content to a user interface), such as one or text entry inputs as described with reference to FIG. 6AG. For example, the sequence of one or more seconds inputs include one or more text entry inputs using the soft keyboard user interface element, a physical (or hardware) keyboard, touchpad, stylus, and/or dictation corresponding to the request to add one or more emojis, emoticons, and/or emoji characters.

In some embodiments, in accordance with a determination that the request to input content satisfies one or more third criteria, including a requirement that the sequence of one or more second inputs includes one or more inputs to enter a plurality of adjacent emoji into a text entry field in order for the one or more third criteria to be satisfied, the electronic device displays, via the one or more generation components, an option that, when selected causes the electronic device to generate automatically-generated visual media based on the content using the automatically-generated visual media application, such as option 644d in FIG. 6AG. In some embodiments, the one or more third criteria have one or more characteristics of the one or more second criteria including the requirement that the respective prompt (e.g., the request to input content described herein) includes a combination of characters that satisfy the predefined format described above in order for the one or more second criteria to be satisfied. For example, the predefined format optionally includes a requirement that the content input includes a plurality (e.g., at least two) adjacent emojis. In some embodiments, the option that, when selected, causes the electronic device to generate automatically-generated visual media based on the content (e.g., the plurality of adjacent emojis) includes content indicative of performing the process of generating automatically-generated visual media based on the content. In some embodiments, in response to detecting one or more inputs (e.g., one or more selections inputs described above) directed to this option, the electronic device displays the user interface of the automatically-generated visual media application described above. In some embodiments, the user interface of the automatically-generated visual media application is displayed overlaid the second user interface (e.g., without closing the application associated with the second user interface and/or ceasing the process of inputting content into the second user interface). In some embodiments, the user interface of the automatically-generated visual media includes a preview of the automatically-generated visual media based on the content (e.g., automatically-generated emoji) and representations of prompt components corresponding to the content entered (e.g., the emojis). For example, the electronic device optionally displays in the user interface of the automatically-generated visual media application the preview of the automatically-generated visual media that is based on the plurality of adjacent emojis entered from the second user interface. In some embodiments, the preview of the automatically-generated visual media has one or more characteristics of the preview of the automatically-generated visual media described in method(s) 1000 and/or 1200. In some embodiments, the user interface includes an insertion option that, when selected, causes the electronic device to insert the automatically-generated visual media into the second user interface. For example, the electronic device optionally ceases to display the user interface of the automatically-generated visual media and displays the second user interface. In some embodiments, inserting the automatically-generated visual media into the second user interface includes replacing the emojis entered with the automatically-generated emoji generated based on the emojis entered. In some embodiments, in accordance with a determination that the request to input content does not satisfy the one or more third criteria, the electronic device forgoes displaying, via the one or more generation components, the option that, when selected causes the electronic device to generate automatically-generated visual media based on the content using the automatically-generated visual media application.

In some embodiments, the electronic device displays, via the one or more display generation components, a selectable option that, when selected, causes the electronic device to add a respective prompt component (e.g., the first prompt component, the second prompt component, or other prompt component) that specifies a first visual characteristic (e.g., first visual style described above) to the prompt for use in generating the first automatically-generated visual media, such as a style displayed by style prompt component option 600e in FIG. 6D, wherein while the first automatically-generated visual media is based on the first prompt component, the selectable option is a first type, such as shown by prompt components 606a through 606d. In some embodiments, the first prompt component has one or more characteristics of the first prompt component that defines the visual characteristic of the first automatically-generated visual media described above. In some embodiments, the selectable option has one or more characteristics of the one or more respective selectable options (e.g., first selectable options, second selectable options, or other selectable options) selectable to add the respective prompt components (e.g., first prompt components, second prompt components, or other prompt components) based on a respective style (e.g., a first style, a second style, or other style) associated with the respective ML model (e.g., the first ML model, the second ML model, or other ML model) described in method 700. In some embodiments, a first type of selectable option includes a selectable option of a style other than the emoji style, such as an animation style or other style described in method 700.

In some embodiments, while the first automatically-generated visual media is based on the first prompt component, the electronic device detects, via the one or more input devices, one or more inputs corresponding to a request to change the first prompt component, such as shown by selection input with contact 604k directed to style option 608e in FIG. 6K. In some embodiments, the electronic device identifies a request to change the first prompt component in response to detecting, via the one or more input devices, one or more inputs (e.g., one or more selection inputs described above) to select an option corresponding to a respective prompt component other than the first prompt component (e.g., a second prompt component, a third prompt component, or other prompt component) as described above and/or in method 700, one or more inputs specifying the respective prompt component for use in generating the automatically-generated visual media item as described above and/or in method 700, one or more inputs to add the respective prompt component that defines a visual characteristic (e.g., visual style) of the first automatically-generated visual media as described above and/or in method 700, or one or more other inputs corresponding to the request to change the first prompt component described below and/or in method(s) 700 and/or 1200.

In some embodiments, in response to detecting the one or more inputs corresponding to the request to change the first prompt component. in accordance with a determination that the request to change the first prompt component is a request to change the first prompt component to the second prompt component (e.g., that specifies a visual characteristic corresponding to the emoji style as described above), such as shown by selection input with contact 604k directed to style option 608e in FIG. 6K, the electronic device generates the first automatically-generated visual media based on the second prompt component (e.g., optionally as described above with respect to other generations of automatically-generated visual media based on prompt components), such as shown by prompt components 616a through 616d in FIG. 6L. In some embodiments, in accordance with a determination that the request to change the first prompt component is a request to change the first prompt component to the second prompt component, the electronic device displays a second selectable option of a second type, different from the selectable option of the first type, such as shown by style prompt component option 600e in FIG. 6L. In some embodiments, the second prompt component has one or more characteristics of the second prompt component that defines the visual characteristic of the first automatically-generated visual media described above. In some embodiments, the second visual appearance of the selectable option includes an emoji style described in method 700. In some embodiments, generating the first automatically-generated visual media based on the second prompt component include displaying, via the one or more display generation component, a preview of the first automatically-generated visual media based on the second prompt component. In some embodiments, the preview of the first automatically-generated visual media based on the second prompt component has a visual characteristic (e.g., emoji style) different from the visual characteristic of a preview of the first automatically-generated visual media while the first automatically-generated visual media is based on the first prompt component (e.g., visual style other than the emoji style described in method 700). In some embodiments, displaying the second selectable option of the second type includes displaying this option with a plurality of other different selectable options of the same second type. In some embodiments, these different selectable options including the selectable option are suggested by the electronic device based on recent and/or frequent usage. In some embodiments, these different selectable options include emojis of a particular type or category, such as expressions or emoticons or other category.

In some embodiments, in response to detecting the one or more inputs corresponding to the request to change the first prompt component, such as with the entry of content 612 in FIG. 6H. in accordance with a determination that the request to change the first prompt component is a request to change the first prompt component to a third prompt component that specifies a second visual characteristic different from the first prompt component and different from the second prompt component the electronic device generates the first automatically-generated visual media based on the third prompt component and maintains display of the selectable option of the first type, such as shown by prompt components 606a through 606d and style prompt component option 600e in FIG. 6J. In some embodiments, the third prompt component has one or more characteristics of the first prompt component that defines the visual characteristic of the first automatically-generated visual media described above. For example, the third prompt component defines a visual characteristic or style other than the emoji style described in method 700. For example, when the electronic device determines that the request changes from a first non-emoji style (e.g., animation) to a second non-emoji style (e.g., anime), the selectable option that is displayed optionally stays the same (e.g., does not change to an emoji style) and does not include emojis of a particular category, such as the expressions-type emojis described above, Thus, in some embodiments, the electronic device displays a variety of selectable options with a variety of visual appearances (e.g., associated with a respective visual style- emoji style or another style) for use in generating automatically-generated visual media as described herein.

In some embodiments, the user interface of the automatically-generated visual media application is a user interface for editing the first automatically-generated visual media, such as visual media creation user interface 600a in FIG. 6J. In some embodiments, the user interface for editing the first automatically-generated visual media (e.g., optionally referred to as an editing user interface) has one or more characteristics of the editing user interface described in method 700. In some embodiments, after making the first automatically-generated visual media accessible at a respective location (e.g., a first location, a second location, a third location, or other location), the electronic device maintains the display of the user interface for editing the first automatically-generated visual media (e.g., without navigating away from the editing user interface, such as by displaying, via the one or more display generation components, a user interface associated with the respective location), such as continuing to display visual media creation user interface 600a in FIG. 6K. In some embodiments, the user interface associated with the respective location includes an automatically-generated visual media library user interface of the automatically-generated visual media application, a soft keyboard user interface, or other user interface described above.

In some embodiments, before making the first automatically-generated visual media accessible at the respective location (e.g., a first location, a second location, a third location, or other location), displaying the user interface of the automatically-generated visual media application includes displaying, via the one or more display generation components, a user interface element including first content indicating that the first automatically-generated visual media can be made accessible at a respective location, such as save user interface element 600d in FIG. 6L. In some embodiments, after making the first automatically-generated visual media accessible at the respective location, the electronic device displays, via the one or more display generation components, the user interface element including second content confirming the first automatically-generated visual media is accessible at the respective location, such as confirmation indicator 600k in FIG. 6R. In some embodiments, the user interface element has one or more characteristics of the save user interface element described above. In some embodiments, the first content includes standard, recognizable text (e.g., “Save” and/or other text), graphics, and/or colors that enables the user to infer that the first automatically-generated visual media can be made accessible at the respective location (e.g., capable of being saved to the respective location) in response to input directed to the user interface element as described in more detail above. For example, the second content includes a checkmark graphic and/or content confirming the first automatically-generated visual is saved and accessible at the respective location as described in more detail above.

In some embodiments, displaying the user interface of the automatically-generated visual media application includes displaying, via the one or more display generation components, a preview of the first automatically-generated visual media along with a user interface element that, when selected, causes the electronic device to make the first automatically-generated visual media accessible at a respective location, such as preview 610a of the second automatically-generated visual media item and save user interface element 600d in FIG. 6E. In some embodiments, the preview of the first automatically-generated visual media has one or more characteristics of the preview of the first automatically-generated visual media described above.

In some embodiments, while displaying the preview of the first automatically-generated visual media, the electronic device detects, via the one or more input devices, a navigation input (e.g., including a movement component or other navigation input that indicates a direction of navigation such as indicating a next input with selection of a right arrow key and a previous input with selection of a left arrow key), such as navigation input with contact 604f in FIG. 6F. In some embodiments, detecting the navigation input including the movement component has one or more characteristics of detecting the navigation input including the movement component described in method 700. For example, the electronic device optionally detects the navigation input directed to the preview of the first automatically-generated visual media.

In some embodiments, in response to detecting the navigation input, the electronic device displays, via the one or more display generation components, a preview of a second automatically-generated visual media based on a respective prompt component (e.g. the first prompt component, the second prompt component, or other prompt component), wherein the second automatically-generated visual media is different from the first automatically-generated visual media, such as the preview 610b of a third automatically-generated visual media item in FIG. 6G. In some embodiments, the preview of the second automatically-generated visual media has one or more characteristics of the preview of the first automatically-generated visual media. In some embodiments, the preview of the first automatically-generated visual media and the preview of the second automatically-generated visual media have one or more characteristics of the preview of the automatically-generated visual media described in method(s) 1000 and/or 1200. For example, the second automatically-generated visual media is based on the same prompt including the same visual style as described above. In some embodiments, the second automatically-generated visual media differs from the first automatically-generated visual media. For example, the electronic device extrapolates (e.g., in a same style, mood, or direction) from the same prompt used for generating the automatically-generated visual media. In some embodiments, the computer system optionally expands upon the one or more concepts of the prompt and/or generates additional details as described in more detail in method 700. In another example, the second automatically-generated visual media includes a second composition of objects or subjects different from the first composition of objects or subjects in the first automatically-generated visual media; a second size/scale of subject(s) larger or smaller than a first size/scale of subject(s) in the automatically-generated visual media; and/or a second perspective that emphasizes subject(s) more or less than the first perspective in the first automatically-generated visual media.

In some embodiments, the preview of the first automatically-generated visual media and the preview of the second automatically-generated visual media are optionally displayed as previews as descried in more detail above. For example, the electronic device optionally displays the preview of the first automatically-generated visual media and the preview of the second automatically-generated visual media (e.g., and, optionally, representations of other automatically-generated visual media) contained within a frame (or, optionally, display area) of the user interface that the user can navigate by the navigation input described herein. For example, the electronic device optionally displays respective representations of the different automatically-generated visual media including the preview of the second automatically-generated visual media in accordance with the movement component of the navigation input as described herein. In some embodiments, displaying the preview of the second automatically-generated visual media includes replacing the display of the preview of the first automatically-generated visual media. In some embodiments, the electronic device ceases to display the preview of the first automatically-generated visual media. In some embodiments, the electronic device ceases to display the preview of the first automatically-generated visual media and displays the preview of the second automatically-generated visual media at a location at which the preview of the first automatically-generated visual media had been displayed.

In some embodiments, in response to detecting the navigation input, the electronic device displays, via the one or more display generation components, a user interface element that, when selected, causes the electronic device to make the second automatically-generated visual media accessible at the respective location (e.g., a first location, a second location, a third location, or other location), such as save user interface element 600d in FIG. 6G. In some embodiments, the user interface element has one or more characteristics of the save user interface element described above. For example, the electronic device optionally displays the user interface element with the first content indicating that the second automatically-generated visual media can be made accessible at the respective as described in more detail above. Thus, in some embodiments, the electronic device makes a plurality of different automatically-generated visual media (e.g., based on the same prompt including the same visual style) accessible at the respective location. For example, the electronic device optionally detects, via the one or more input devices, one or more inputs (e.g., selection inputs described above) directed to the user interface element, and in response, the electronic device makes the second automatically-generated visual media accessible at the respective location as described above. In some embodiments, while displaying the preview of the second automatically-generated visual media, the electronic device detects, via the one or more input devices, a second navigation input including a second movement component. In some embodiments, detecting the second navigation input including the second movement component has one or more characteristics as detecting the navigation input including the movement component described herein. In some embodiments, the second navigation input including the movement component corresponds to a request to view the preview of the first automatically-generated visual media. In some embodiments, in response to detecting the second navigation input including the second movement component, the electronic device displays the preview of the first automatically-generated visual media in a manner similar to displaying the preview of the second automatically-generated visual media described above. In some embodiments, while the electronic device displays the preview of the first automatically-generated visual media, the electronic device displays the save user interface element including content indicative of the saved status of the first automatically-generated visual media (e.g., accessible at the respective location). For example, this content optionally includes a checkmark graphic confirming the first automatically-generated visual media is saved as described above.

It should be understood that the particular order in which the operations in FIG. 8 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 1000, and/or 1200) are also applicable in an analogous manner to method 800 described above with respect to FIG. 8. For example, the operation of the electronic device making automatically-generated visual media accessible in different locations described above with reference to method 800 optionally has one or more of the characteristics of generating automatically-generated visual media using a machine learning (ML) model, displaying an automatically-generated visual media item at a new size, and/or displaying an automatically-generated visual media item with a different appearance based on an appearance parameter described herein with reference to other methods described herein (e.g., methods 700, 1000, and/or 1200). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 8 are, optionally, implemented by components depicted in FIGS. 1A-1B. For example, displaying and detecting operations 802 and determining operations 806 and 808 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

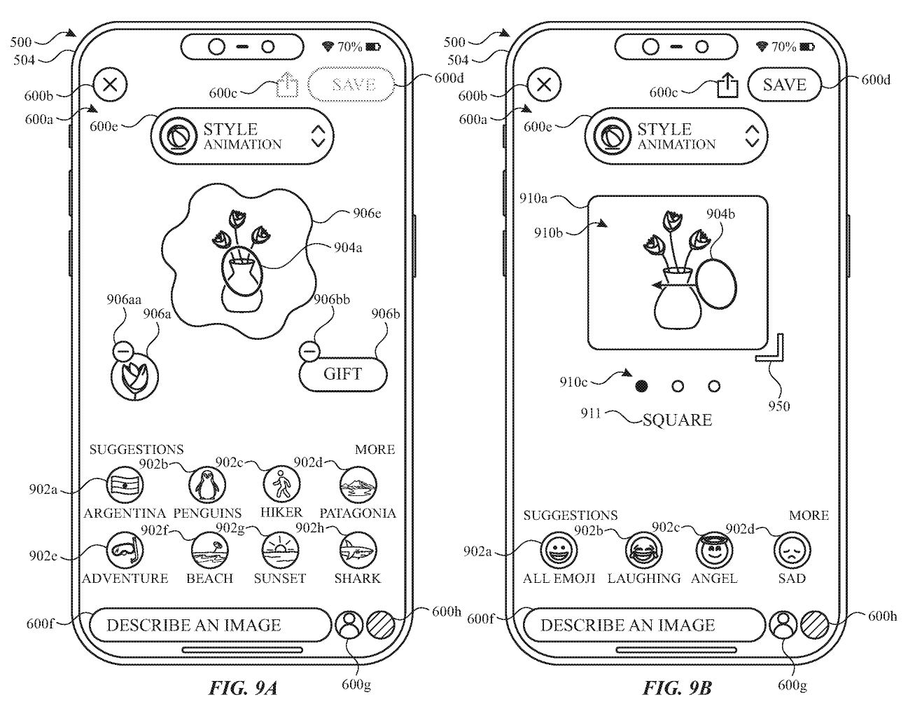

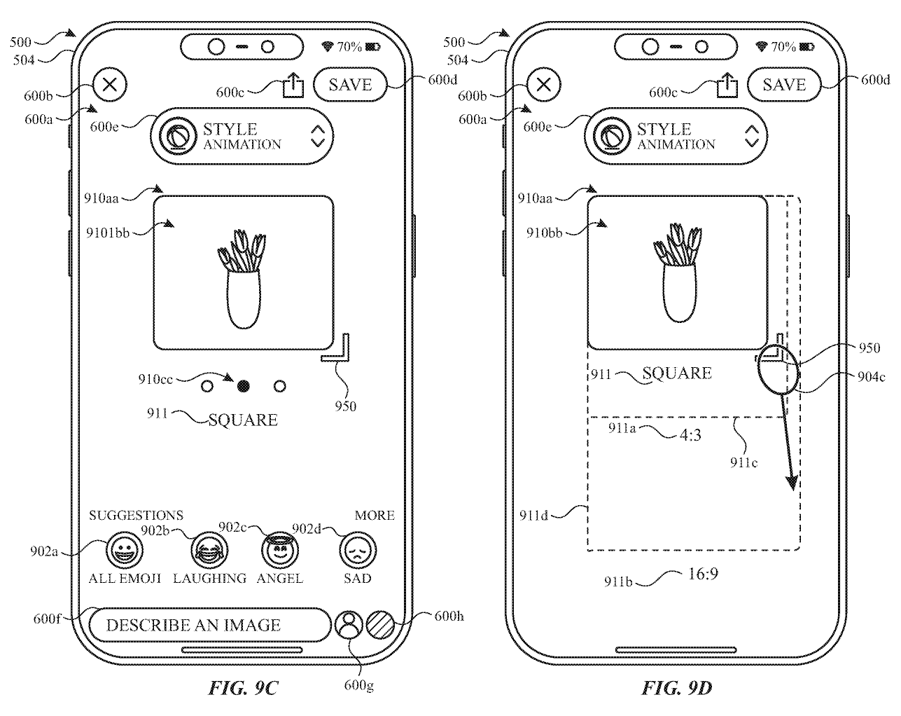

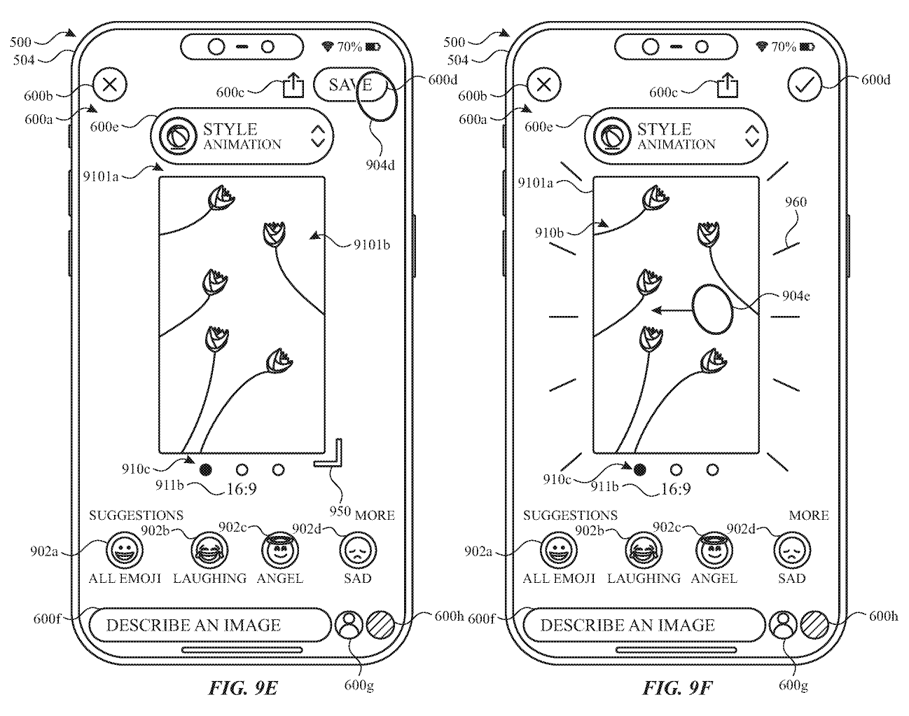

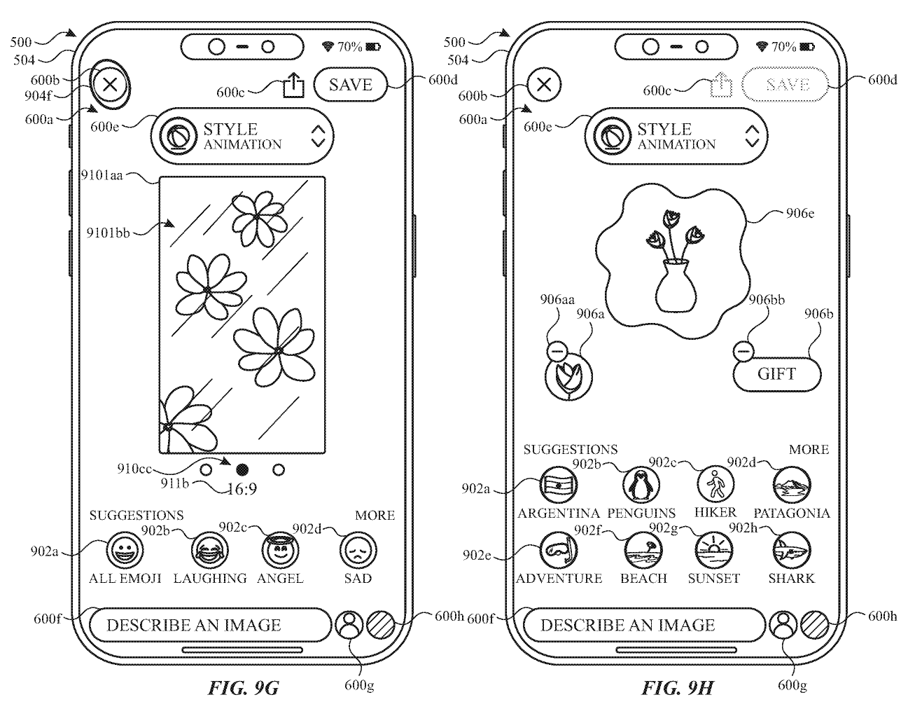

FIGS. 9A-9H illustrate exemplary ways in which an electronic device generates automatically-generated visual media using a machine learning (ML) model in accordance with some embodiments of the disclosure. The embodiments in these figures are used to illustrate the processes described below, including the processes described with reference to FIG. 10. Although FIGS. 9A-9H illustrate various examples of ways an electronic device is able to perform the processes described below with respect to FIG. 10, it should be understood that these examples are not meant to be limiting, and the electronic device is able to perform one or more processes described below with reference to FIG. 10 in ways not expressly described with reference to FIGS. 9A-9H.

Users interact with electronic devices in many different manners. In some embodiments, an electronic device 500 is in communication with one or more display generation components 504 and one or more input devices described in detail with reference to method 1000 in FIG. 10. The embodiments described below provide ways in which the electronic device 500 generates automatically-generated visual media using a ML model (e.g., described in more detail below and with reference to method 1000). For example, displaying a user interface for generating automatically-generated visual media using one or more ML models enables a user to quickly and conveniently access different ML models, without having to use additional inputs to navigate to a user interface of a ML model, thereby providing more direct interaction with the ML model to the user, reducing the need for additional inputs to display a user interface of the ML model, and avoiding erroneous inputs related to searching for the ML model which reduces power usage and improves battery life of the electronic device by enabling the user to use the electronic device more quickly and efficiently. It is understood that people use devices. When a person uses a device, that person is optionally referred to as a user of the device.

FIG. 9A illustrates an electronic device 500 with a display generation component 504 (e.g., a touchscreen). In some embodiments, the electronic device 500 is a mobile device, such as a smartphone, tablet, wearable device, or any of the devices described in method 1000. In some embodiments, the electronic device 500 displays, via the display generation component 504, a plurality of different user interfaces of applications associated with the electronic device 500. For example, in FIG. 9A, the electronic device 500 displays, via display generation component 504, a visual media creation user interface 600a of an automatically-generated visual media application. In some embodiments, the visual media creation user interface 600a of an automatically-generated visual media application includes a plurality of user interface components or user interface elements (e.g., menus, fields, icons, buttons, options, or other element) that are selectable to initiate a process for generating automatically-generated visual media based on a prompt using a ML model. In some embodiments, the electronic device 500 initiates the process for generating automatically-generated visual media in response to detecting (or, optionally, receiving) a prompt for use in generating automatically-generated visual media. In some embodiments, the prompt includes one or more prompt components, and these prompt components include text, keywords, images, video, special characters, visual media, and/or other inputs describing a concept (e.g., style, theme, mood, activity, costume, accessory, places, graphics, or visual characteristic that will influence the generation of the automatically-generated visual media). In some embodiments, the one or more prompt components include computer-generated suggested concepts (or, optionally referred to as predefined concepts) or recognized concepts. For example, in FIG. 9A, the visual media creation user interface 600a includes a set of suggested prompt components 902a through 902h corresponding to computer-generated suggested concepts. For example, a respective prompt component (e.g., prompt component 902a, prompt component 902b, prompt component 902c, prompt component 902d, prompt component 902e, prompt component 902f, prompt component 902g, or prompt component 902h) is selectable (e.g., via various input methods described below, and in more detail, in method 700) to cause the electronic device 500 to use a corresponding computer-generated suggested concept (e.g., Argentina, penguins, dog, Patagonia, adventure, beach, sunset, or shark) as basis or influence for generating an automatically-generated visual media. In some embodiments, the set of suggested prompt components 902a through 902h share one or more characteristics with prompt components 602a through 602h, respectively.

The visual media creation user interface 600a also includes content entry field 600f that, when selected (e.g., via various input methods described below, and in more detail, in method 700), causes the electronic device 500 to display, via display generation component 504, a soft keyboard (e.g., described in more detail below with reference to FIG. 6H) for inputting a textual description and/or one or more emojis that is used as a prompt component for use in generating an automatically-generated visual media.

The visual media creation user interface 600a also includes subject prompt component option 600g that, when selected, causes the electronic device 500 to display a user interface component. In some embodiments, in response to detecting selection of the subject prompt component option 600g, the electronic device 500 initiates a process to select and/or edit a subject of the automatically-generated visual media according to the techniques described above with reference to method 700. In some embodiments, the visual media creation user interface 600a also includes add photo prompt component option 600h that, when selected, causes the electronic device 500 to initiate a process to take a photo of a subject for inclusion in the prompt for generating the automatically-generated visual media; or initiate a process to select a photo of a subject from a photo library for inclusion in the prompt for generating the automatically-generated visual media.

The visual media creation user interface 600a also includes style prompt component option 600e that, when selected, causes the electronic device 500 to display a user interface component. In some embodiments, the automatically-generated visual media has an associated style as described above with reference to method(s) 700 and/or 800. In some embodiments, the visual media creation user interface 600a also includes close user interface element 600b that, when selected, causes the electronic device 500 to close (e.g., cease to display) the visual media creation user interface 600a; a share user interface element 900c that, when selected, causes the electronic device 500 to initiate a process to share, copy, or print the automatically-generated visual media; and a save user interface element 600d that, when selected, causes the electronic device 500 to make the automatically-generated visual media accessible at a respective location (e.g., a first location, a second location, or other location described in more detail with reference to FIGS. 6E-6S and method 700).

In some embodiments, the electronic device 500 detects a request to generate an automatically-generated visual media item based on a prompt that includes one or more prompt components. For example, the electronic device 500 identifies the request to generate an automatically-generated visual media item in response to detecting a sequence of one or more inputs to add one or more prompt components to a prompt for automatically-generated visual media generation. FIG. 9A illustrates a result of detecting the sequence of one or more inputs to add the one or more prompt components, as two prompt components 906a and 906b are displayed as bubbles in the central portion of the visual media creation user interface 600a. In some embodiments, the one or more inputs to add the first prompt component 906a and the second prompt component 906b shares one or more characteristics with the one or more inputs to add the prompt components 606a, 606b, and 606b described above. In some embodiments, and as shown in FIG. 9A, in response to detecting the sequence of one or more inputs, the electronic device 500 generates a first automatically-generated visual media item (e.g., a first automatically-generated visual media item at a first size) based on a prompt that includes prompt component 902a and prompt component 906b. For example, in FIG. 9A, the electronic device 500 displays in the visual media creation user interface 600a a preview 906e of the first automatically-generated visual media. In some embodiments, preview 906e shares one or more characteristics with preview 606e described above with reference to FIG. 6B (and preview 606f described above with reference to FIG. 6D). Thus, it should be understood that, in some embodiments, the electronic device 500 combines techniques described with reference to preview 606e with techniques described with reference to preview 906e.

The visual media creation user interface 600a also includes a deletion user interface element 906aa associated with the prompt component 906a that, when selected, causes the electronic device 500 to remove the prompt component 906a from the prompt for generating automatically-generated visual media. The visual media creation user interface 600a also includes deletion user interface element 906bb that, when selected, causes the electronic device 500 to remove the prompt component 906b from the prompt for generating automatically-generated visual media. In some embodiments, the deletion user interface element 906aa shares one or more characteristics with deletion user interface element 606aa described above, and the deletion user interface element 906bb shares one or more characteristics with the deletion user interface element 606bb described above.

In some embodiments, this prompt also specified a first style (e.g., animation) provided by a first ML model used to give the first automatically-generated visual media a particular aesthetic appearance or overall artistic look, such as the animation inspired aesthetic shown in the preview 906e of the first automatically-generated visual media in FIG. 9A. In some embodiments, the prompt also includes other prompt components added in a manner similar to adding prompt component 902a and prompt component 902b described in FIG. 9A. As illustrated in FIG. 9A, the automatically-generated visual media application generates a preview 906e for an automatically-generated visual media item 910a that includes a vase with roses, based on the first prompt component 906a having an image of a rose and based on the second prompt component 906b including the text “Gift”, which was previously provided via user input directed towards the content entry field 600f. As discussed above, preview 906e is generated with an animation style based on the currently selected style from the style prompt component option 600e.

In some embodiments, as illustrated in FIG. 9A, the electronic device 500 detects one or more user inputs directed towards the preview 906e, such as contact 904a (which optionally shares one or more characteristics with contacts 604a through 604ah, described above). Although contact 904a is illustrated as a touch input, it should be understood that contact 904a is not limited to touch inputs. Other types of inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible.

In response to detecting contact 904a directed towards preview 906e, the electronic device 500 displays a new view of the visual media creation user interface 600a as depicted in FIGS. 9B to 9G. In this view, the visual media creation user interface 600a displays a first automatically generated visual media item 910a (which optionally shares one or more characteristics with preview 610a). As illustrated, the first automatically-generated visual media item 910a includes one or more graphical elements 910b.

The first automatically-generated visual media item 910a is generated and displayed in FIG. 9B with a square aspect ratio, as indicated by an indication of the aspect ratio (e.g., the aspect ratio label 911). Although the first automatically-generated visual media item 910a that is displayed in FIG. 9B in response to contact 904a has a square aspect ratio, it should be understood that the default aspect ratio when viewing the first automatically-generated visual media item 910a in the view of FIG. 9B is not limited to a square aspect ratio (e.g., the default aspect ratio is optionally an aspect ratio discussed further in relation to method 1000 below).

As shown in FIG. 9B, the electronic device 500 enables and updates the display of the save user interface element 600d and the share user interface element 600c. Therefore, in response to receiving a selection directed towards the save user interface element 600d and/or the share user interface element 600c, the electronic device initiates a process to share and/or share the currently displayed automatically-generated visual media item, as discussed in further detail in relation to FIGS. 9E and 9F and/or method(s) 800 and/or 1000.

As is illustrated in FIG. 9B, a plurality of automatically-generated visual media items are associated with the same prompt. As depicted, the first automatically-generated visual media item 910a is the first displayed automatically-generated visual media item. In FIG. 9B, icon 910c is displayed to indicate that a first of three automatically-generated visual media items at the square aspect ratio is displayed. It is to be understood that the icons for indicating which automatically-generated visual media item is displayed is not limited in number, shape, and/or size (e.g., there may be more or fewer icons displayed, and/or the icons may have a different style). FIG. 9B also illustrates that a resizing affordance 950 is displayed at one corner of the automatically-generated visual media item 910a. As will be described further in relation to FIGS. 9D and 9E, manipulation of the resizing affordance provides a mechanism for modifying the aspect ratio of the currently displayed automatically-generated visual media item, such as automatically-generated visual media item 910a in FIG. 9B.

FIGS. 9B and 9C depict a method for viewing different alternatives of the first automatically-generated visual media item 910a, based on the same prompt and at the same aspect ratio. In some embodiments, the electronic device 500 identifies a request to view an alternative automatically-generated visual media item at the same aspect ratio. As illustrated in FIG. 9B, the sequence of one or more inputs to view an alternative automatically-generated visual media item at the same aspect ratio includes a drag input with contact 904b (e.g., a tap or long press input) directed to first automatically-generated visual media item 910a followed by movement of the contact 904b (e.g., towards the left of the electronic device 500). Although contact 904b is illustrated as a touch input, it should be understood that drag inputs are not limited to touch inputs. Other types of drag inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible.

In response to detecting the drag input as illustrated in FIG. 9B, the electronic device 500 displays an alternative first automatically-generated visual media item 910aa in FIG. 9C. As illustrated, the alternative first automatically-generated visual media item 910aa includes one or more graphical elements 910bb. Similar to the first automatically-generated visual media item 910a, the alternative first automatically-generated visual media item 910aa is also generated based on the same prompt components (e.g., 906a and 906b), and therefore the graphical elements 910bb of the alternative first automatically-generated visual media item 910aa have one or more similarities with the graphical elements 910b of the first automatically-generated visual media item 910a. In some embodiments, the alternative first automatically-generated visual media item 910aa is generated in response to detecting the drag input illustrated in FIG. 9B. As a result, a user is able to select one of multiple automatically-generated visual media items generated based on the same prompt and save and/or share the individual items desired.

FIGS. 9D to 9E illustrate methods for modifying an aspect ratio of the currently displayed automatically-generated visual media item. In some embodiments, the electronic device 500 identifies a request to view an automatically-generated visual media item at a different aspect ratio (e.g., a second automatically-generated visual media item at a second size). As illustrated in FIG. 9D, the sequence of one or more inputs to view an automatically-generated visual media item at a different aspect ratio includes a drag input with contact 904c (e.g., a tap or long press input) directed to resizing affordance 950 followed by movement of the contact 904c (e.g., towards the second aspect ratio outline 911d the bottom-right corner of the electronic device 500). Although contact 904c is illustrated as a touch input, it should be understood that drag inputs are not limited to touch inputs. Other types of drag inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible.

In response to detecting contact 904c directed towards resizing affordance 950, the electronic device determines that the user intends to update the aspect ratio of the currently displayed automatically-generated visual media item 910aa. In some embodiments, as illustrated in FIG. 9D, in response to detecting contact 904c, one or more elements displayed within the visual media creation user interface 600a are removed from display temporarily (e.g., suggested prompt components 902a to 902d shown in FIG. 9C). Further in response to detecting contact 904c, one or more outlines associated with fixed aspect ratios are outlined (e.g., a first aspect ratio outline 911c associated with a 4:3 aspect ratio and a second aspect ratio outline 911d associated with a 16:9 aspect ratio). Furthermore, as illustrated the first aspect ratio outline 911c is labelled with first aspect ratio label 911a (“4:3”) and second aspect ratio outline 911d is labelled with second aspect ratio label 911b.

The illustrated aspect ratio outlines 911c and 911d and associated aspect ratio labels 911a and 911b are presented to guide the user in selecting a certain respective aspect ratio. In some embodiments, the first and/or second aspect ratio outlines 911c and 911d are not visible in the visual media creation user interface 600a shown in FIG. 9D. In some embodiments, the first and/or second aspect ratio labels are not visible to the user in the visual media creation user interface 600a shown in FIG. 9D. In some embodiments, the electronic device 500 detects when contact 904c is released, and determines an aspect ratio for resizing the currently displayed automatically-generated visual media item, as is discussed further in relation to method 1000. In some embodiments, the electronic device snaps the resizing affordance to the closest aspect ratio outline when contact 904c is released, as is discussed further in relation to method 1000. In response to detecting the termination of the drag input shown in FIG. 9D, in FIG. 9E (where the resizing affordance 950 was dragged towards the second aspect ratio outline 911d associated with a 16:9 aspect ratio), the electronic device generates a second automatically-generated visual media item 9101a based on the same prompt components (e.g., 906a, 906b). Second automatically-generated visual media item 9101a includes one or more one or more graphical elements 9101b. Similar to the first automatically-generated visual media item 910a and the alternative automatically-generated visual media item 910aa, the second automatically-generated visual media item 9101a is also generated based on the same prompt components (e.g., 906a and 906b), and therefore the graphical elements 9101a of the second automatically-generated visual media item 9101a have one or more similarities with the graphical elements 910b and 910bb of the first automatically-generated visual media item 910a and the alternative first automatically-generated visual media item 910aa. In some embodiments, the second automatically-generated visual media item 9101a is generated in response to detecting the drag input illustrated in FIG. 9C.

In some embodiments, the selected aspect ratio is provided to the automatically-generated visual media application to control the generation of an automatically-generated visual media item. As a result, as shown in FIG. 9E, although the same prompt components were used to generate the second automatically-generated visual media item 9101a, the visual appearance of the graphical elements 9101b is different as the automatically-generated visual media application generated the second automatically-generated visual media 9101a with the additional context of a 16:9 aspect ratio. For example, as illustrated in FIG. 9E, the second automatically-generated visual media item 9101a is generated to be suitable for a user interface background, and therefore has a different amount or number of graphical elements 9101b, as is further described in relation to method 1000.As illustrated in FIG. 9E, the second aspect ratio label 911b is displayed to reflect the changed aspect ratio. Furthermore, as the aspect ratio of the currently-displayed second automatically-generated visual media item 9101a has changed from the aspect ratio of the first alternative automatically-generated visual media item 910aa, the icon 910c is displayed to indicate that a first of three automatically-generated visual media items at the 16:9 aspect ratio is displayed.

FIGS. 9E and 9F illustrate a method for saving the currently displayed automatically-generated visual media item. In some embodiments, as illustrated in FIG. 9E, the electronic device detects one or more user inputs directed towards the save user interface element 900d, such as contact 904d (which optionally shares one or more characteristics with contacts 604a through 604ah, described above). Although contact 904d is illustrated as a touch input, it should be understood that contact 904d is not limited to touch inputs. Other types of inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible. In response to detecting contact 904d directed towards save user interface element 600d, the electronic device initiates a process to save the currently displayed automatically-generated visual media item (e.g., second automatically-generated visual media item 9101a), as described in relation to method(s) 800 and/or 1000. As illustrated in FIG. 9F, in response to detecting contact 904d in FIG. 9E, the electronic device 500 updates the display of save user interface element 600d to a checkmark to reflect that the currently displayed second automatically-generated visual media item 9101a has been saved to a first location. Furthermore, one or more graphical effects, such as the sparkle effect 960 are displayed by the electronic device 500 surrounding the second automatically-generated visual media item 9101a, in response to selection of the save user interface element 600d.

Similar to FIGS. 9B and 9C, FIGS. 9F and 9G depict a method for viewing different alternatives of the second automatically-generated visual media item, based on the same prompt and at the same aspect ratio. In some embodiments, the electronic device 500 identifies a request to view an alternative automatically-generated visual media item at the same aspect ratio (e.g., 16:9). As illustrated in FIG. 9F, the sequence of one or more inputs to view an alternative automatically-generated visual media item at the same aspect ratio includes a drag input with contact 904e (e.g., a tap or long press input) directed to second automatically-generated visual media item 9101a followed by movement of the contact 904e (e.g., towards the left of the electronic device 500). Although contact 904e is illustrated as a touch input, it should be understood that drag inputs are not limited to touch inputs. Other types of drag inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible.

In response to detecting the drag input as illustrated in FIG. 9F, the electronic device 500 displays an alternative second automatically-generated visual media item 9101aa. As illustrated, the alternative second automatically-generated visual media item 9101aa includes one or more graphical elements 9101bb. Similar to the second automatically-generated visual media item 9101a, the alternative second automatically-generated visual media item 9101aa is also generated based on the same prompt components (e.g., 906a and 906b) and based on the aspect ratio, and therefore the graphical elements 9101bb of the alternative second automatically-generated visual media item 9101aa have one or more similarities with the graphical elements 9101b of the second automatically-generated visual media item 9101a. In some embodiments, the alternative second automatically-generated visual media item 9101aa is generated in response to detecting the drag input illustrated in FIG. 9F. As a result, a user is able to select one of multiple automatically-generated visual media items generated based on the same prompt and save and/or share the individual items desired. As illustrated in FIG. 9G, as the alternative second automatically-generated visual media item 9101aa has not yet been saved, the save user interface element 600d reverts to a “Save” button appearance, and selection of the save user interface element 600d in FIG. 9G would result in the electronic device 500 saving the second alternative automatically-generated visual media item 9101aa (in the same way as is described previously).

In some embodiments, the electronic device 500 identifies a request to return to the user interface depicted in FIG. 9A (e.g., to allow the user to modify the prompt). As illustrated in FIG. 9G, the sequence of one or more inputs to return to the user interface depicted in FIG. 9A includes a contact 904f (e.g., a tap or long press input) directed to close user interface element 600b. Although contact 904f is illustrated as a touch input, it should be understood that drag inputs are not limited to touch inputs. Other types of drag inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible.

In response to detecting the contact 904f as illustrated in FIG. 9G, the electronic device 500 reverts the display of the visual media creation user interface 600a to the appearance depicted in FIG. 9A, as shown in FIG. 9H. While not illustrated, in some embodiments, the appearance of the preview 906e displayed in FIG. 9H retains one or more elements of the last visual media item which was displayed when the contact 904f was received (e.g., preview 906e in FIG. 9H being a preview of the second alternative automatically-generated visual media item 9101aa). In other embodiments, as displayed in FIG. 9H, the preview 906e reverts back to its default appearance as seen in FIG. 9A (described in further detail above), including display of the first prompt component 906a and second prompt component 906b.

FIG. 10 illustrates a flow diagram illustrating a method in which an electronic device updates the size of an automatically-generated visual media item after generation of the automatically-generated visual media item in accordance with some embodiments of the disclosure. The method 1000 is optionally performed at first electronic device and/or electronic devices such as device 100, device 300, or device 500 as described above with reference to FIGS. 1A-1B, 2-3, 4A-4B and 5A-5H. Some operations in method 1000 are, optionally combined and/or order of some operations is, optionally, changed.

Updating the size of an automatically-generated visual media item after generation of the automatically-generated visual media item allows a user greater control over a size and/or aspect ratio of an AI generated media item. It may be computationally more efficient for an AI model to generate initially a visual media item having a certain size (e.g., a square size) and then allow the user to modify the size of the visual media item, rather than requiring an AI model capable of generating a visual media item having any size. Therefore, one advantage of this method is a reduction in the complexity of the AI model associated with generating the visual media item (therefore reducing the processing power required by the electronic device) while ensuring a higher degree of flexibility and user-control for the automatically-generated visual media item.

In some embodiments, a method 1000 is performed at an electronic device, such as electronic device 500 in FIG. 9A, in communication with one or more display generation components, such display generation component 504, and one or more input devices. In some embodiments, the electronic device, the one or more display generation components, and/or the one or more input devices, share one or more characteristics with the electronic device, one or more display generation components, and/or input devices described with respect to methods 700, 800, and/or 1200.

In some embodiments, while a first automatically-generated visual media item is displayed, via the one or more display generation components, at a first size (e.g., aspect ratio and/or resolution), wherein (1004) the first automatically-generated visual media item was generated based on a first prompt, and wherein (1006) at the first size, the first automatically generated visual media includes a first amount of content, the electronic device 500 detects (1002), via the one or more input devices, a drag input directed to the first automatically-generated visual media item, such as is depicted by the selection and movement of resizing affordance 950 as illustrated in FIG. 9D. In some embodiments, an automatically-generated visual media item is a visual media item that was previously generated by an automatically-generated visual media application and/or one or more artificial intelligence (AI) or machine learning (ML) models. In some embodiments, the automatically-generated visual media application shares one or more characteristics with the automatically-generated visual media application described with respect to method 700 and/or 800. In some embodiments, the one or more AI or ML models share one or more characteristics with the first AI or ML models described with respect to method 700, 800, and/or 1200. In some embodiments, the one or more AI or ML models share one or more characteristics with the second AI or ML model described with respect to method 1200. In some embodiments, the automatically-generated visual media item has one or more characteristics of the automatically-generated visual media described in method 700, 800, and/or 1200.

In some embodiments, the first-automatically-generated visual media item is displayed within a user interface of the automatically-generated visual media application, such as is illustrated by visual media creation user interface 600a in FIG. 9B. In some embodiments, the user interface of the automatically-generated visual media application shares one or more characteristics with the user interface described with respect to method 700.

In some embodiments, displaying the first automatically-generated visual media item at the first size comprises a first representation (e.g., a preview) of the first automatically-generated visual media item. In some embodiments, the first size at which the first automatically-generated visual media item is displayed corresponds to a physical size of the visual media item (e.g., in units of distance, such as centimeters) in one or more dimensions, area, surface area, and/or volume, as displayed via the one or more display generation components. In some embodiments, the first size at which the first automatically-generated visual media item is currently displayed corresponds to a first amount of pixels used to display the media item on the one or more displays integrated with the electronic device or on the external display in one or more dimensions, area, surface area, and/or volume. In some embodiments, the first automatically-generated visual media item is a two-dimensional media item or a three-dimensional media item. In some embodiments, the size of the first automatically-generated visual media item comprises a physical size in a first dimension (e.g., a width) and/or a physical size in a second dimension, orthogonal to the first dimension (e.g., a height). In some embodiments, the size further comprises a physical size in a third dimensional (e.g., a depth). In some embodiments, the size of the visual media item corresponds to a surface area of the smallest bounding-rectangle that encompasses the shape of the visual media item or corresponds to a volume or surface area of the smallest bounding-box that encompasses the shape of the visual media item. In some embodiments, the electronic device detects one or more inputs to select and/or modify the size of the first automatically-generated visual media item. In some embodiments, the one or more inputs are directed towards a portion of the first automatically-generated visual media item in order to select the portion of the visual media item. In some embodiments, one or more portions of the first automatically-generated visual media are selectable, such as the resizing affordance 950 as illustrated in FIG. 9D. In some embodiments, the one or more selectable portions correspond to one or more points along the perimeter of or along the surface of the first automatically-generated visual media item (or of an associated bounding-rectangle).

In some embodiments, when the electronic device detects a selection of the portion of the visual media item, the electronic device can receive one or more further inputs to adjust the size of the first automatically-generated visual media item along one or more dimensions. In some embodiments, the one or more further inputs comprise a drag input, where the selection of the selected portion of the visual media item is maintained and the electronic device detects a movement of the selected portion from a first location to a second location (e.g., a dragging motion of the selected portion from one location to another). In some embodiments, detecting the drag input comprises detecting touchdown of a contact directed towards a selected portion of the visual media item, movement of the contact while the touchdown is maintained, and optionally a liftoff of the contact, such as is illustrated by contact 904c directed towards resizing affordance 950 in FIG. 9D. In one example, the contact is provided by one or more elements contacting a touch display (e.g., a finger touching the portion on the touch display and subsequently moving along the touch display). In another example, the contact is provided by detecting a mouse click on a user interface while a cursor is in proximity to the portion of the visual media item, and moving the mouse while the mouse click is maintained. In some embodiments, detecting the drag input comprises detecting a sequence of hand air gestures detected via the one or more input devices (e.g., a pinching motion, a moving motion while the pinch is maintained, and a release of the pinching motion).

In some embodiments, in response to detecting the drag input directed to the first automatically-generated visual media item, electronic device 500 displays (1008), via the one or more display generation components, a second automatically-generated visual media item at a second size, in accordance with the drag input, wherein: (1010) the second size is different from the first size; (1012) the second automatically-generated visual media item is generated based on the first prompt; and (1014) at the second size, the second automatically-generated visual media item includes a second amount of content, different from the first amount of content, such as is illustrated by the display of second automatically-generated visual media item 9101a in FIG. 9E. In some embodiments, in response to detecting the drag input, electronic device displays a second automatically-generated visual media item to reflect a new second size based on the distance, duration, and/or direction of the drag input. In some embodiments, the electronic device ceases to display the first automatically-generated visual media item and displays the second automatically-generated visual media item of the at a location at which the first automatically-generated visual media item had been displayed, such as is shown by the display of second automatically-generated visual media item 9101a in place of the first alternative automatically-generated visual media 910aa in FIG. 9E. In some embodiments, the second automatically-generated visual media item is generated using the same prompt as the first automatically-generated visual media item.

In some embodiments, the drag input is provided in one or more directions (e.g., in an X-direction to the left/right of a touch display and/or in a Y-direction to the top/bottom of the touch display). In some embodiments, the drag input is provided in a first direction (+X and/or +Y) to increase the size of the first automatically-generated visual media item in one or more dimensions. In some embodiments, the drag input is provided in a second direction (-X and/or -Y) to decrease the size of the first automatically-generated visual media item in one or more dimensions. In some embodiments, the drag input is terminated once the user stops maintaining selection of the selected one or more portions. In some embodiments, the second automatically-generated visual media item is generated upon termination of the drag input, such as is illustrated by the second automatically-generated visual media item generated in FIG. 9E. In one example, where the display is a two-dimensional touch display, the drag input is terminated once the user releases his or her finger from the display (e.g., in response to the electronic device detecting liftoff of the contact provided by the user) after dragging the one or more portions to the new location.

In some embodiments, the second automatically-generated visual media item comprises a second representation (e.g., a complete rendering) of the first automatically-generated visual media item. In some embodiments, the amount of content displayed by the second automatically-generated visual media item is different from the amount of content displayed by the first automatically-generated visual media item. In some embodiments, an automatically-generated visual media item is generated based on a prompt and size information, resulting in different content being generated for different sizes even with identical prompts. For example, the first automatically-generated visual media item at the first size (e.g., a square preview) displays a single flower. If the user wishes to take this preview and apply it to a background, the user provides the drag input to change the size of the visual media item to a 16:9 aspect ratio. However, instead of simply stretching the preview image to fit the new aspect ratio (e.g., not changing the amount of content displayed), a second automatically-generated visual media item is generated based the same prompt and based on the new aspect ratio, resulting in a background image having a plurality of the flowers in a different arrangement. In some embodiments, the first and second automatically-generated visual media items are displayed at a certain position within a user interface, regardless of the size. In some embodiments, the first automatically-generated visual media item is displayed at a first location within the user interface when it is displayed at the first size. In some embodiments, the second automatically-generated visual media item is also displayed at the first location within the user interface when it is displayed at the second size, such as is depicted by second automatically-generated visual media item 9101a being at the same location in FIG. 9E as first alternative automatically-generated visual media 910aa was shown in FIG. 9D. In some embodiments, displaying the first and/or second automatically-generated visual media item at the first location refers to centering the visual media item at the first location within the user interface when it is displayed. For example, the user may provide a drag input to one side of the visual media item to stretch the visual media item in the X-direction (increasing a width of the visual media item), though the center of the visual media item optionally remains coincident with the same location in the user interface.

In some embodiments, the display of the first automatically-generated visual media item is further updated in accordance with the drag input while the drag input is being provided (e.g., continuously or at regular intervals). For example, if the electronic device were to detect a drag input to move one selectable portion of the first automatically-generated visual media item 1 cm to the right along the X-axis, the display of the visual media item can be continuously updated while the drag input is detected.

In some embodiments displaying the second automatically-generated visual media item at the second size includes: in accordance with a determination that the drag input corresponds to a first aspect ratio included in a plurality of predefined aspect ratios (e.g., 1:1 [square], 2:3, 3:4, 9:16, 16:9, 4:3, or 3:2), displaying the second automatically-generated visual media item with the first aspect ratio, as is illustrated by providing a drag input directed towards the resizing affordance 950 and moved in a direction towards second aspect ratio outline 911d as shown in FIG. 9D. In some embodiments displaying the second automatically-generated visual media item at the second size includes: in accordance with a determination that the drag input corresponds to a second aspect ratio included in the plurality of predefined aspect ratios, different from the first aspect ratio, displaying the second automatically-generated visual media item with the second aspect ratio, as if the drag input directed towards the resizing affordance 950 in FIG. 9D were moved in a direction towards first aspect ratio outline 911c.

In some embodiments, the electronic device displays one or more of the plurality of predefined aspect ratios via the one or more display generation components. In some embodiments, the one or more of the plurality of predefined aspect ratios are displayed with one or more text elements (e.g., “Square”, “2:3”, “9:16”) corresponding to the plurality of predefined aspect ratios. In some embodiments, the electronic device displays one or more of the plurality of predefined aspect ratios (e.g., 1:1 concurrently with the display of the first automatically-generated visual media item. In some embodiments, the electronic device displays one or more of the plurality of predefined aspect ratios in response to detecting the drag input.

In some embodiments, the electronic device displays one or more representations of the plurality of predefined aspect ratios via the one or more display generation components (optionally with one or more text elements as discussed above). In some embodiments, the electronic device displays the one or more representations (or the one or more of the plurality of predefined aspect ratios) concurrently with the display of the first automatically-generated visual media item. In some embodiments, a respective representation of the one or more representations has a size and/or shape associated with a border of a respective aspect ratio (e.g., a rectangular shape in the aspect ratio of 9:16, the shape having a certain thickness). In some embodiments, the electronic device displays one or more object (or one or more of the plurality of predefined aspect ratios) having a first visual characteristic (e.g., a dashed border).

In some embodiments, as discussed above, the drag input includes maintaining a selection of a portion of the visual media item (e.g., a grabber handle) and a movement of the selected portion from a first location to a second location, such as is illustrated by the movement of resizing affordance 950 in FIG. 9D. In some embodiments, determining that the drag input corresponds to a respective aspect ratio includes determining that the second location of the selected portion is within a certain distance of at least a portion of an object associated with a respective aspect ratio (e.g., 0mm, 0.5mm, 1mm, 2mm, 5mm, 10mm). For example, when the electronic device detects that the user has selected a grabber handle associated with the visual media item, the electronic device displays one or more outlines (e.g., objects) of predefined aspect ratios. In some embodiments, the distance that the drag input moves is compared to predefined distances (where different respective distances optionally correspond to a different aspect ratios), and upon termination of the drag input (e.g., a release of the grabber handle), the computer system snaps the grabber handle to the closest aspect ratio (e.g., based on the smallest difference between the distance that the drag input has moved and a predefined distance). In some embodiments, upon snapping the grabber handle to the closest aspect ratio, the visual media item is re-sized and/or re-generated at the selected aspect ratio. In some embodiments, the location at which the drag input is terminated (e.g., the location of the grabber handle when the grabber handle is released) is different from the exact location of the selected aspect ratio (e.g., the grabber handle snaps to a certain aspect ratio within a certain distance from the aspect ratio). In this example, the user moves the grabber handle towards the outline marked as a 9:16 aspect ratio, and when the computer system detects that the grabber handle is within 1mm of the outline, the computer system snaps the grabber handle to the outline object and regenerates the visual media item at the aspect ratio associated with the selected outline.

In some embodiments, displaying the second automatically-generated visual media item at the second size includes displaying the second automatically-generated visual media item concurrently with an indication of an aspect ratio of the second size, such as is illustrated by the display of second aspect ratio label 911b below the second automatically-generated visual media item 9101a in FIG. 9E.

In some embodiments, the electronic device displays an indication of the aspect ratio of the second size. In some embodiments, the indication is a text element displayed in a portion adjacent to the second automatically-generated visual media item (e.g., below the second automatically-generated visual media item). In some embodiments, the indication is displayed at a fixed location via the one or more display generation components (e.g., at the bottom of a user interface of the automatically-generated visual media application displaying the first and second automatically-generated visual media items). In some embodiments, the indication is displayed at a fixed location relative to a location of the second automatically-generated visual media item (e.g., within 1mm, 5mm, 1cm, 2cm, 5cm of the location of the automatically-generated visual media item, optionally along one side of the automatically-generated visual media item). For example, the indication is displayed 1cm below the bottom edge of the second automatically-generated visual media item.

In some embodiments, the electronic device displays an indication of the aspect ratio of the first size. In some embodiments, displaying the second automatically-generated visual media item concurrently with an indication of an aspect ratio of the second size includes removing the indication of the aspect ratio of the first size. In some embodiments, displaying the second automatically-generated visual media item concurrently with the indication of the aspect ratio of the second size includes displaying the indication of the aspect ratio of the second size at the same location as the indication of the first automatically-generated visual media item. In some embodiments, the second size is associated with a first aspect ratio, and displaying the indication of the aspect ratio includes displaying the first aspect ratio. In some embodiments, the second size is associated with a second aspect ratio, different from the first aspect ratio, and displaying the indication of the aspect ratio includes displaying the second aspect ratio. In some embodiments, the electronic device removes the indication of the aspect ratio of the first size in response to detecting the drag input. For example, when the first automatically-generated visual media item is displayed, a text element (e.g., “square”) is provided below the first automatically-generated visual media item to indicate to the user the aspect ratio. In this example, while the user provides the drag input, the text element associated with the first automatically-generated visual media item is removed. Further, once the second automatically-generated visual media item is displayed, a new text element associated with the new aspect ratio (e.g., “9:16”) is displayed (and, optionally the text element corresponding to the previous aspect ratio ceases to be displayed).

In some embodiments, while displaying the first automatically-generated visual media item, the electronic device 500 displays, via the one or more display generation components, a resizing affordance associated with the first automatically-generated visual media item, such as resizing affordance 950 illustrated in FIGS. 9B to 9E. In some embodiments, the resizing affordance (also referred to herein as a grabber handle) is an element displayed within, adjacent to, or in the periphery of a respective automatically-generated visual media item indicating that the respective automatically-generated visual media item is able to be re-sized. In some embodiments, the resizing affordance is displayed at a corner of the respective automatically-generated visual media item. In some embodiments, the electronic device displays a plurality of resizing affordances (e.g., a resizing affordance at multiple corners or all corners of the respective visual media item).

In some embodiments, the resizing affordance includes an object, such as a square or L-shaped affordance displayed at the corner of the respective automatically-generated visual media item. In alternative embodiments, the electronic device forgoes displaying the resizing affordance (e.g., the resizing affordance is not made visible to the user). For example, even when a resizing affordance is not displayed, the computer system still detects inputs towards the resizing affordance at the corner of the automatically-generated visual media item and allows the visual media item to be resized.

In some embodiments, detecting the drag input directed to the first automatically-generated visual media item includes detecting a drag input directed to the resizing affordance associated with the first automatically-generated visual media item, such as is illustrated by contact 904a directed to resizing affordance 950 and the subsequent movement, as illustrated in FIG. 9D.

In some embodiments, the drag input includes maintaining a selection of the resizing affordance of the visual media item and a movement of the resizing affordance from a first location to a second location. In some embodiments, the drag is provided by one or more of the following: a touch input including contact at the location of the resizing affordance, an air gesture input including attention directed to the resizing affordance, a portion of a user (e.g., a hand or a finger) within a threshold distance of the resizing affordance, and/or a hardware input (e.g., a mouse click) including manipulating a cursor at the location of the resizing affordance. In some embodiments, the electronic device updates the size (and/or aspect ratio) of the respective automatically-generated visual media item during the drag input in accordance with the movement of the resizing affordance. In other embodiments, the electronic device updates the size (and/or aspect ratio) of the respective automatically-generated visual media item after the drag input in accordance with the movement of the resizing affordance.

In some embodiments, the first automatically-generated visual media item was generated by a first machine learning (ML) model associated with the first size, such as if the first automatically-generated visual media item 910a and the first alternative automatically-generated visual media 910aa shown in FIG. 9B and 9C were generated by a first ML model. In some embodiments, the second automatically-generated visual media item is generated by a second ML model associated with the second size, such as if the second automatically-generated visual media item 9101a shown in FIG. 9E were generated by a second ML model. In some embodiments, the second ML model is different from the first ML model.

In some embodiments, the first ML model and/or the second ML model are processing elements within the automatically-generated visual media application. In some embodiments, the first ML model and second ML model share one or more characteristics with the first and second ML models described in relation to methods 700, 800, and/or 1200. In some embodiments, the first ML model and/or the second ML model receive a respective prompt (optionally having one or more prompt components) as an input and output a respective automatically-generated visual media item at a respective size (and/or aspect ratio) based on the input. In some embodiments, the first ML model is trained based on first training data associated with the first size (e.g., a first aspect ratio). In some embodiments, the second ML model is trained based on second training data, different from the first training data, associated with the second size (e.g., a first aspect ratio). In some embodiments, the first AI model and second ML model share a same ML model architecture of the ML model (e.g., a type of neural network architecture) and/or a same training algorithm. As one example, the first and second ML model are both convolutional neural networks that differ only in the input-output relationship defined by training the first and second ML models on different data sets (where different respective data sets associated with previously-generated images optionally have different aspect ratios). In some embodiments, the first ML model and second ML model have different ML model architectures and/or a different training algorithm. In some embodiments, the first and second ML models include processing elements located locally on the electronic device, remote on a server, and/or a mix of local and remote models (e.g., the first ML model is located on the electronic device, and the second ML model is located on the server).

In some embodiments, the first automatically-generated visual media item was generated by a first ML model, such as if the first automatically-generated visual media item 910a and the first alternative automatically-generated visual media 910aa shown in FIG. 9B and 9C were generated by a first ML model. In some embodiments, the second automatically-generated visual media item is generated by the first ML model, such as if the second automatically-generated visual media item 9101a shown in FIG. 9E were generated by a second ML model.

In some embodiments, the first ML model (e.g., an ML model as described in method 700, 800 and/or 1200) is used by an automatically-generated visual media application to generate the first automatically-generated visual media item and the second automatically-generated visual media item. In some embodiments, the first ML model is trained based on training data with a set of visual media items having visual media items at both the first size and the second size. In some embodiments, the first ML model performs a cropping and/or scaling process to the crop the respective visual media item to the required size (e.g., the first ML model crops the automatically-generated visual media item in accordance with the selected size). In some embodiments, the first ML model performs the cropping and/or scaling process after the first ML model generates the automatically-generated visual media item (e.g., the cropping and/or scaling process is a post-processing step applied after the generation of the visual media item discussed above).

In some embodiments, in response to detecting the drag input directed to the first automatically-generated visual media item, the electronic device 500 generates, via an automatically-generated visual media application, the second automatically generated visual media item (e.g., in accordance with the drag input or in accordance with a new size and/or aspect ratio specified by the drag input), such as is illustrated by the generation of the second automatically-generated visual media item 9101a shown in FIG. 9E in response to the drag input.

In some embodiments, the second automatically-generated visual media item is generated via an automatically-generated visual media application. In some embodiments, the automatically-generated visual media application utilized to generate the second automatically-generated visual media item is the same automatically-generated visual media application utilized to generate the first automatically-generated visual media item. In some embodiments, generating the second automatically-generated visual media item includes generating the second automatically-generated visual media item upon termination of the drag input. In some embodiments, generating the second automatically-generated visual media item includes generating the second automatically-generated visual media item upon detecting that the drag input has exceeded a threshold (e.g., with a distance threshold of 5mm, a resizing affordance being moved 20mm results in the new visual media item being generated, but the same resizing affordance being moved 1mm does not result in any new visual media item being generated). In some embodiments, generating the second automatically-generated visual media item includes generating the second automatically-generated visual media item upon a determination that the drag input corresponds to a selection of a new aspect ratio (e.g., the user drags a resizing affordance associated with the first automatically-generated visual media item to select a new aspect ratio of 9:16).

In some embodiments, displaying, via the one or more display generation components, the second automatically-generated visual media item includes displaying a preview of the second automatically-generated visual media item, such as is illustrated by the display of second automatically-generated visual media item 9101a in FIG. 9E.

In some embodiments, the preview of the second automatically-generated visual media item is at the second size and has a first appearance, such as is illustrated by second automatically-generated visual media item 9101a in FIG. 9E having a 16:9 aspect ratio, as indicated by the aspect ratio label 911b. In some embodiments, displaying the first automatically-generated visual media item includes displaying a preview of the first automatically-generated visual media item, wherein the preview of the first automatically-generated visual media item is at the first size (e.g. a first aspect ratio) and has a respective first appearance. In some embodiments a preview of a respective automatically-generated visual media item is a preview image of the automatically-generated visual media item having a first resolution and/or a first size, different from a resolution and/or size of the automatically-generated visual media item. In some embodiments, the preview image has a same resolution and/or size as the resolution and/or size of the automatically-generated visual media item. In some embodiments, upon detecting one or more user input for sharing and/or saving a respective preview, the electronic device shares and/or saves the automatically-generated visual media item and not the preview (e.g., the full-resolution image is saved). In some embodiments, the preview of the second automatically-generated visual media item is the first of one or more previews generated by the automatically-generated visual media application based on a same prompt and based on the second size (e.g., a second aspect ratio). For example, for a certain prompt having one or more prompt components (e.g., “red” and “flowers”), the automatically-generated visual media application generates a plurality of images based on the prompt at the selected size (e.g., the second size), and displays a preview of one of the plurality of generated images. In some embodiments, a respective preview generated based on a respective prompt is generated in response to receiving an input from a user. For example, after generating a preview of the first automatically-generated visual media item in response to a prompt (e.g., “red flowers”), the preview of the second automatically-generated visual media item is generated in response to an input requesting a new variation of the automatically-generated visual media item based on the same prompt.

In some embodiments, while displaying, via the one or more display generation components, the preview of the second automatically-generated visual media item, electronic device 500 detects, via the one or more input devices, an input corresponding to a request to display, via the one or more display generation components, a preview of a third automatically-generated visual media item, different from the second automatically-generated visual media item, such as is illustrated by the contact 904e following by a movement of contact 904e in FIG. 9F to display a second alternative automatically-generated visual media item 9101aa as illustrated in FIG. 9G. In some embodiments, the preview of the second automatically-generated visual media item is displayed within a user interface of the automatically-generated visual media application, as discussed above. In some embodiments, input includes a selection of one or more affordances (e.g., a button) displayed in the user interface (e.g., received via detecting: a touch input, an air pinch gesture, a keyboard entry, a mouse or trackpad click, and/or attention of the user directed towards the one or more affordances, optionally while attention is directed toward the one or more affordances). In some embodiments, the input includes a swipe gesture on a touch screen to navigate through the plurality of previews. In some embodiments, in response to detecting the input, the preview of the third automatically-generated visual media item is displayed in the user interface of the automatically-generated visual media application. In some embodiments, while the preview of the third automatically-generated visual media item is displayed, a further input is detected corresponding to a request to display the preview of the second automatically-generated visual media item and/or a preview of a fourth automatically-generated visual media item.

In some embodiments, in response to detecting the input, electronic device 500 displays, via the one or more display generation components, the preview of the third automatically-generated visual media item, such as is illustrated by the display of second alternative automatically-generated visual media item 9101aa shown in FIG. 9G. In some embodiments, the preview of the third automatically-generated visual media item is at the second size (e.g., and at the second aspect ratio), and the preview of the third automatically-generated visual media item has a second appearance, different from the first appearance, such as is depicted by the different appearances between the second automatically-generated visual media item 9101a and the second alternative automatically-generated visual media item 9101aa. In some embodiments, the preview of the third automatically-generated visual media item maintains the size (e.g., aspect ratio) of the preview of the second automatically-generated visual media item but has a different appearance (e.g., the user can see multiple different images generated at the same size and with the same prompt). In some embodiments, the preview of the first, second, and third automatically-generated visual media items all are based on a same prompt. In some embodiments, the preview of the first automatically-generated visual media item, the preview of the second automatically-generated visual media item, the preview of the third automatically-generated visual media item have different respective appearances, even though they are generated with the same prompt. In some embodiments, the preview of the second automatically-generated visual media item and the preview of the second automatically-generated visual media item share a visual style, as described further with reference to method 700. For example, with a prompt of “red flowers” provided to the automatically-generated visual media application, the automatically-generated visual media application generates a first image with a plurality of red roses in a first arrangement, a plurality of red tulips in a second arrangement, and a plurality of red roses in the second arrangement, all at the selected size (e.g., the second size).

In some embodiments, the electronic device displays, via the one or more display generation components, a preview of the first automatically-generated visual media item at the first size, and detects, via the one or more input devices, an input corresponding to a request to display, via the one or more display generation components, a preview of a different automatically-generated visual media item at the first size (e.g., and at the first aspect ratio), such as is illustrated in FIGS. 9B and 9C, with contact 90be and the subsequent movement changing the display of the first automatically-generated visual media item 910a to a display of the first alternative automatically-generated visual media item 910aa. For example, the user swipes through a plurality of previews at the first size after displaying the first automatically-generated visual media item before providing the drag input to re-size the automatically generated visual media item to the second size.

In some embodiments, while displaying, via the one or more display generation components, the preview of the third automatically-generated visual media item, electronic device detects, via the one or more input devices, a drag input directed to the preview of the third automatically-generated visual media item, such as if a drag input directed towards a resizing affordance as illustrated in FIG. 9D were applied in relation to the second automatically-generated visual media item in FIG. 9G. In some embodiments, the drag input directed to the preview of the third automatically-generated visual media item shares one or more characteristics with the drag input directed to the first automatically-generated visual media item, as discussed above.

In some embodiments, in response to detecting the drag input directed to the preview of the third automatically-generated visual media item, electronic device 500 displays, via the one or more display generation components, a preview of a fourth automatically-generated visual media item at a third size (e.g., and a third aspect ratio different from the first aspect ratio and the second aspect ratio), in accordance with the drag input, wherein the third size is different from the second size and the first size, such as if a new aspect ratio were selected, such as the 4:3 aspect ratio depicted in FIG. 9D.

In some embodiments, in response to detecting the drag input, electronic device displays a preview of a fourth automatically-generated visual media item to reflect a new third size (and/or aspect ratio) based on the distance, duration, and/or direction of the drag input. In some embodiments, the electronic device ceases to display the preview of the third automatically-generated visual media item and displays the preview of the fourth automatically-generated visual media item of the at a location at which the preview of the third automatically-generated visual media item had been displayed. In some embodiments, the fourth automatically-generated visual media item is generated using the same prompt as the third automatically-generated visual media item. In some embodiments, generating the fourth automatically-generated visual media item includes generating the fourth automatically-generated visual media item upon termination of the drag input. In some embodiments, generating the fourth automatically-generated visual media item includes generating the fourth automatically-generated visual media item upon detecting that the drag input has exceeded a threshold (e.g., with a distance threshold of 5mm, a resizing affordance being moved 20mm results in the new visual media item being generated, but the same resizing affordance being moved 1mm does not result in any new visual media item being generated). In some embodiments, generating the fourth automatically-generated visual media item includes generating the fourth automatically-generated visual media item upon a determination that the drag input corresponds to a selection of a new aspect ratio (e.g., the user drags a resizing affordance associated with the third automatically-generated visual media item to select a new aspect ratio of 9:16). For example, after generating a plurality of previews associated with automatically-generated visual media item, the user selects a preview (e.g., as discussed above) out of a plurality of previews (e.g., to select a specific visual appearance) and then provides a drag input to re-size the selected preview to a new aspect ratio. In some embodiments, one or more characteristics of the selected preview are provided to the automatically-generated visual media application to guide the generation of the fourth automatically-generated visual media item.

In some embodiments, displaying, via the one or more display generation components, the second automatically-generated visual media item includes displaying a preview of the second automatically-generated visual media item, such as second automatically-generated visual media item 9101a shown in FIG. 9E (e.g., as discussed above).

In some embodiments, the preview of the second automatically-generated visual media item is at the second size and has a first appearance, such as is illustrated by the second automatically-generated visual media item 9101a shown at the 16:9 aspect ratio in FIG. 9E. In some embodiments, while displaying the preview of the second automatically-generated visual media item, the electronic device 500 displays, via the one or more display generation components, a first affordance that is selectable to save the second automatically-generated visual media item, such as save user interface element 600d shown in FIG. 9E. In some embodiments, while displaying the preview of the second automatically-generated visual media item, the electronic device detects a user input directed to the affordance for saving the current preview (e.g., a touch input including contact at the location of the first affordance for saving, an air gesture input including attention directed to the first affordance for saving, a portion of a user (e.g., a hand or a finger) within a threshold distance of the first affordance for saving, and/or a hardware input (e.g., a mouse click) including manipulating a cursor at the location of the first affordance for saving). In some embodiments, displaying the first affordance includes displaying the first affordance with a visual appearance depending on whether the preview has been saved to a memory (e.g., the first affordance has a first appearance when the preview has not yet been saved, and the first affordance has a second appearance when the preview has been saved). In accordance with detecting the user input directed to the affordance, the electronic device saves the preview to a memory of the electronic device. In some embodiments, the computer system updates the display of the affordance once the user input has been provided to indicate a confirmation of saving the image, such as displaying the affordance as a checkmark. In some embodiments, the process of saving the image shares one or more characteristics with the request to save first automatically-generated visual media described further in method 800.

In some embodiments, a first affordance for sharing a respective automatically-generated visual media item is displayed by the electronic device, such as is illustrated by share user interface element 600c in FIG. 9B. In some embodiments, in response to detecting one or more user inputs directed towards the first affordance for sharing, the electronic device initiates a process for sharing the current preview of the automatically-generated visual media item (e.g., launches a user interface for sharing the preview with one or more applications running on the electronic device).

In some embodiments, displaying the first affordance (e.g., as described above) includes displaying the first affordance at a first location in a user interface, such as is illustrated by the save user interface element 600d being displayed in the top-right of the visual media creation user interface 600a in FIG. 9F. In some embodiments, while displaying, via the one or more display generation components, the preview of the second automatically-generated visual media item, the electronic device 500 detects, via the one or more input devices, an input (e.g., an input received via detecting: a touch input, an air pinch gesture, a keyboard entry, a mouse or trackpad click, and/or attention of the user directed towards the one or more affordances, optionally while attention is directed toward the one or more affordances) corresponding to a request to display, via the one or more display generation components, a preview of a third automatically-generated visual media item, different from the second automatically-generated visual media item, such as is illustrated by contact 904e followed by a movement as shown in FIG. 9F for generating second alternative automatically-generated visual media item 9101aa as shown in FIG. 9G. (e.g., the preview described with reference to the input requesting to the display the preview of the second content item, as discussed above)

In some embodiments, in response to detecting the input, electronic device 500 displays, via the one or more display generation components, the preview of the third automatically-generated visual media item, and displays, via the one or more display generation components, a second affordance for saving the third automatically-generated visual media item at the first location in the user interface, such as is illustrated by the change in the display of save user interface element 600d in FIG. 9G. In some embodiments, the preview of the third automatically-generated visual media item is at the second size (e.g., and the second aspect ratio), and the preview of the third automatically-generated visual media item has a second appearance, different from the first appearance, such as is illustrated by the appearance of the second alternative automatically-generated visual media item 9101aa shown in FIG. 9G as compared to the appearance of the second automatically-generated visual media item 9101a shown in FIG. 9F. For example, the method for displaying the preview of the third automatically-generated visual media item is discussed in further detail in response to detecting an input above. In some embodiments, the second affordance for saving the third automatically-generated visual media item shares one or more characteristics with the first affordance for saving the third automatically-generated visual media item. In some embodiments, displaying the second affordance includes ceasing to display the first affordance and displaying the second affordance at the location of the first affordance. In some embodiments, displaying the second affordance includes displaying the second affordance with a visual style depending on whether the preview of the third automatically-generated visual media item has been saved to a memory.

For example, after the user has saved the preview, the first affordance is displayed with a checkmark indicating that the preview of the second automatically-generated visual media item has been saved, such as is illustrated by the checkmark view of save user interface element 600d in FIG. 9F. Afterwards, the user provides one or more user inputs to display the preview of the third automatically-generated visual media item, such as by providing contact 904e followed by a movement, as illustrated in FIG. 9F. The second affordance is then displayed at the location of the first affordance; however, the second affordance is displayed with an appearance indicating that the preview of the third automatically-generated visual media item has not yet been saved (e.g., a checkmark displayed on the first affordance is replaced with the text “Save” on the second affordance).

In some embodiments, a second affordance for sharing a respective automatically-generated visual media item is displayed by the electronic device. In some embodiments, the second affordance for sharing a respective automatically-generated visual media item shares one or more characteristics with the first affordance for sharing a respective automatically-generated visual media item as discussed above. In some embodiments, the second affordance for sharing a respective automatically-generated visual media item is the same as the first affordance for sharing a respective automatically-generated visual media item (e.g., regardless of which preview of the current automatically-generated visual media item is being displayed).

In some embodiments, while displaying the preview of the second automatically-generated visual media item with the first appearance and while displaying the first affordance for saving the second automatically-generated visual media item, optionally as described above, the electronic device 500 detects a user input directed to the first affordance, such as is illustrated by contact 904d directed towards save user interface element 600d in FIG. 9E. In some embodiments, the user input is detected via: a touch input, an air gesture, a keyboard entry, a mouse or trackpad click, and/or attention of the user directed towards the first affordance, optionally while attention is directed toward the first affordance. In some embodiments, in response to detecting the user input directed to the first affordance, the electronic device 500 saves the second automatically-generated visual media item, such as is illustrated in FIG. 9F. In some embodiments, saving a respective automatically-generated visual media item (e.g., the first and/or second automatically-generated visual media item) includes storing the respective automatically-generated visual media within a first memory of the electronic device and/or making the respective automatically-generated media accessible via another user interface such as a generated media gallery, an software keyboard, and/or a wallpaper selection user interface of an application or operating system.

In some embodiments, in response to detecting the user input directed to the first affordance, the electronic device displays, via the one or more display generation components, the preview of the second automatically-generated visual media item with a second appearance different from the first appearance, such as is illustrated by the visual change of save user interface element 600d from “Save” to a checkmark in FIG. 9F.

In some embodiments, the second appearance includes a temporary visual effect applied to the preview of the second automatically-generated visual media. In some embodiments, the temporary visual effect includes a movement effect (e.g., such that the preview appears to bounce, change in size, or has another animation effect). In some embodiments, the temporary visual effect includes one or more effects applied to the periphery of the preview (e.g., a sparkle effect applied around the preview). In some embodiments, after a certain amount of time (e.g., 0.05, 0.1, 0.2, 0.5, 1, 2, 5 seconds) displaying the preview with the second appearance, the preview is displayed once again with the first appearance. For example, once the user clicks the save button, the preview quickly expands and contracts in size to indicate that the item has been properly saved.

In some embodiments, the second appearance includes a change (e.g., an increase) in the visual emphasis of the preview of the second automatically-generated visual media item. In some embodiments, the electronic device controls one or more display properties of the preview of the second automatically-generated visual media item to increase or decrease the visual emphasis. For example, the electronic device controls display properties that adjust the size, opacity, and/or brightness of the preview of the second automatically-generated visual media item.

In some embodiments, while displaying the preview of the second automatically-generated visual media item with the first appearance and while displaying the first affordance for saving the second automatically-generated visual media item, electronic device 500 detects a user input directed to the first affordance for saving the second automatically-generated visual media item, such as is illustrated by contact 904d directed towards save user interface element 600d in FIG. 9E. For example, the user input includes an input received via detecting: a touch input, an air pinch gesture, a keyboard entry, a mouse or trackpad click, and/or attention of the user directed towards, optionally while attention is directed toward the one or more affordances as discussed above) In some embodiments, in response to detecting the user input directed to the first affordance for saving the second automatically-generated visual media item, electronic device 500 saves the second automatically-generated visual media item, such as is illustrated in FIG. 9F.For example, saving a respective automatically-generated visual media item includes storing the respective automatically-generated visual media within a first memory of the electronic device and/or making the respective automatically-generated media accessible via another user interface such as a generated media gallery, an software keyboard, and/or a wallpaper selection user interface of an application or operating system, as discussed above).

In some embodiments, before detecting the input directed to the first affordance for saving the second automatically-generated visual media item, the electronic device 500 displays, via the one or more display generation components, the first affordance for saving the second automatically-generated visual media item with a first appearance, such as is illustrated by the “SAVE” text displayed by save user interface element 600d in FIG. 9E. In some embodiments, the first appearance of the first affordance includes a visual appearance of the first affordance when the preview of the second automatically-generated visual media item has not yet been saved to a memory (e.g., including “save” text). In some embodiments, the first appearance of the first affordance includes one or more first colors.

In some embodiments, in response to detecting the input directed to the first affordance, the electronic device 500 displays, via the one or more display generation components, the first affordance for saving the second automatically-generated visual media item with a second appearance different from the first appearance, such as is illustrated by the checkmark displayed by save user interface element 600d in FIG. 9F. In some embodiments, the second appearance of the first affordance includes a visual appearance of the first affordance when the preview has already been saved to a memory (e.g., a checkmark). In some embodiments, the second appearance of the first affordance includes one or more second colors, different from the one or more first colors (e.g., such that the electronic device changes the color of the affordance in response to detecting the input directed to the first affordance).

In some embodiments, while displaying the preview of the second automatically-generated visual media item and the first affordance with the second appearance (optionally because the second automatically-generated visual media item has been saved), electronic device 500 detects, via the one or more input devices, one or more inputs corresponding to a request to update a prompt used to generate the second automatically-generated visual media item, such as if the second automatically-generated visual media item 9101a shown in FIGS. 9E and 9F were resized to a new aspect ratio, using the process shown in FIG. 9D. In some embodiments, the request to update a prompt includes a change in the one or more prompt components (e.g., provided by the user within a user interface element). In some embodiments, the request to update the prompt includes adding, removing, and/or replacing one of the one or more prompt components. In some embodiments, the prompt and/or a change to prompt components share one or more characteristics with the prompts and/or changes to prompt components as described in methods 700, 800, and 1200. For example, the electronic device generates, via the automatically-generated visual media application, a preview of the second automatically-generated visual media item based on a first prompt (e.g., “a day at the beach with friends”). If the user wishes to edit the first prompt, the user provides in this example a second prompt different from the first prompt (e.g., “sunset at the beach”) and the automatically-generated visual media application generates a new preview of an automatically-generated visual media item in accordance with the second prompt.

In some embodiments, in response to detecting the one or more inputs, electronic device displays, via the one or more display generation components, a third automatically-generated visual media item based on the updated prompt, such as if a new automatically-generated visual media item were generated based on a resizing input directed towards the second automatically-generated visual media item 9101a in FIG. 9F. In some embodiments, displaying a third automatically-generated visual media item shares one or more characteristics with displaying the first and/or second automatically-generated visual media item. In some embodiments, displaying the third automatically-generated visual media item includes generating, via the automatically-generated visual media application, the third automatically-generated visual media application in accordance with the updated prompt. In some embodiments, generating the third automatically-generated visual media item shares one or more characteristics with generating an automatically-generated visual media item as discussed in methods 700, 800, and 1200.

In some embodiments, in response to detecting the one or more inputs, electronic device 500 displays, via the one or more display generation components, a second affordance for saving the third automatically-generated visual media item, the second affordance having the first appearance (optionally because the third automatically-generated visual media item has not been saved), such as if the save user interface element 600d shown in FIG. 9F were to revert from a checkmark to include “SAVE” text as illustrated in FIG. 9E in view of the resizing input described above. In some embodiments, the second affordance for saving the third automatically-generated visual media item shares one or more characteristics with the first affordance for saving the second automatically-generated visual media item. In some embodiments, in response to detecting a user input directed to the second affordance for saving the third automatically-generated visual media item, the electronic device saves the second automatically-generated visual media item. In some embodiments, before detecting the input directed to the second affordance for saving the third automatically-generated visual media item, the electronic device displays the second affordance for saving the third automatically-generated visual media item with a first appearance. In some embodiments, the first appearance of the second affordance includes a visual appearance of the second affordance (e.g., including “save” text). In some embodiments, in response to detecting the input directed to the second affordance, the electronic device displays the second affordance for saving the third automatically-generated visual media item with a second appearance different from the first appearance. In the above example, since the automatically-generated visual media has changed from a second visual media item to a third visual media item in response to the updated prompt, the appearance of the first affordance for saving reverts to a first (e.g., default) appearance (e.g., the “save” text) regardless of its previous appearance.

It should be understood that the particular order in which the operations in FIG. 10 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, and/or 1200) are also applicable in an analogous manner to method 1000 described above with respect to FIG. 10. For example, the operation of the electronic device making automatically-generated visual media accessible in different locations described above with reference to method 1000 optionally has one or more of the characteristics of generating automatically-generated visual media using a machine learning (ML) model, making automatically-generated visual media accessible in different locations, and/or displaying an automatically-generated visual media item with a different appearance based on an appearance parameter described herein with reference to other methods described herein (e.g., methods 700, 800, and/or 1200). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 10 are, optionally, implemented by components depicted in FIGS. 1A-1B. For example, detecting a drag input (e.g. step 1002) and displaying a second automatically-generated visual media item (e.g., step 1008) are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

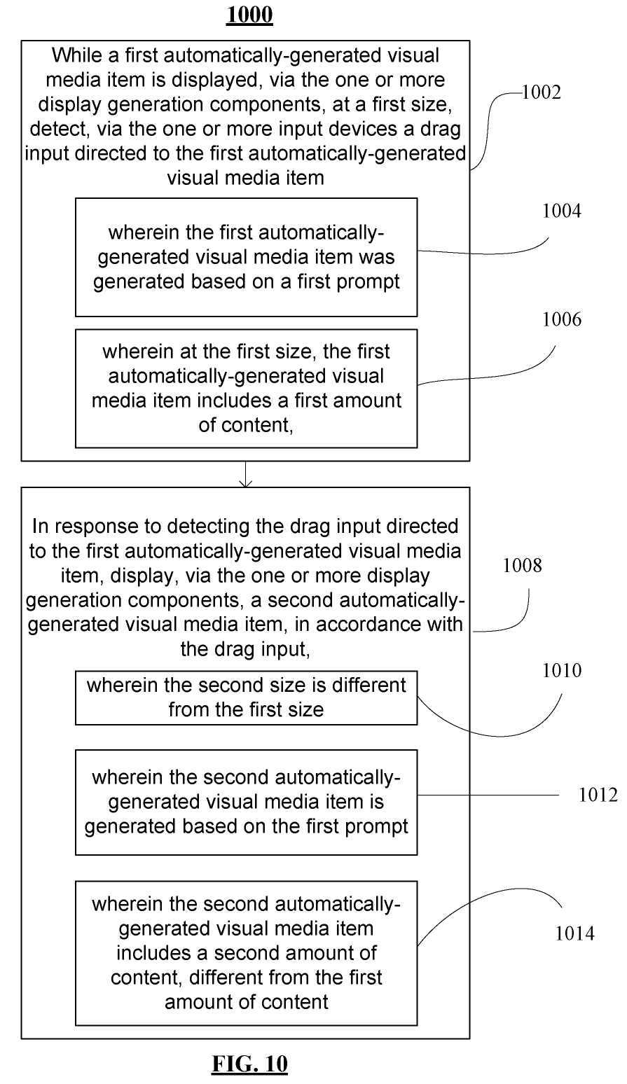

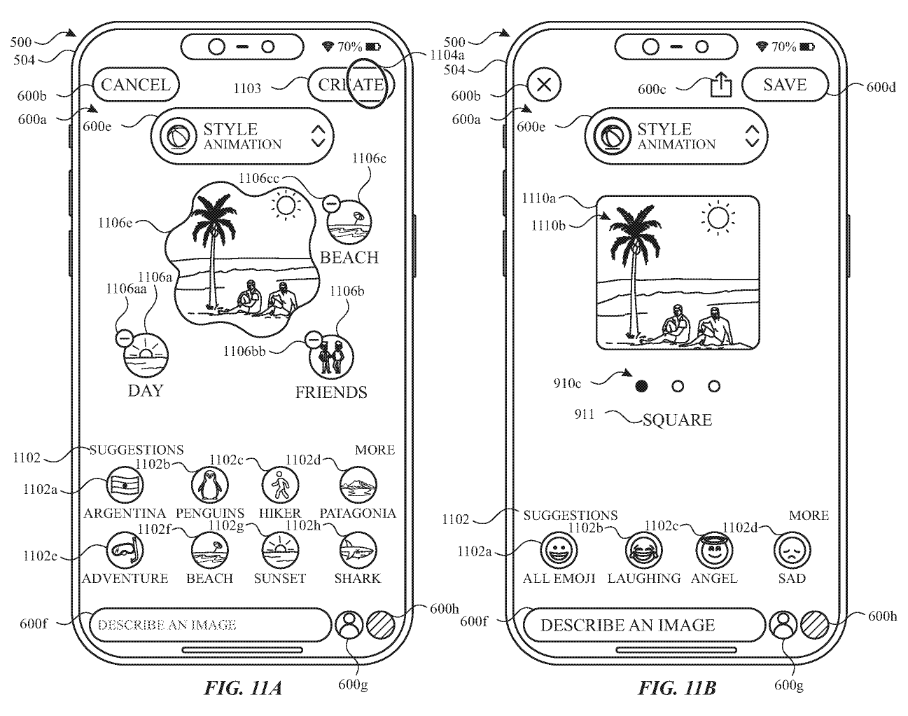

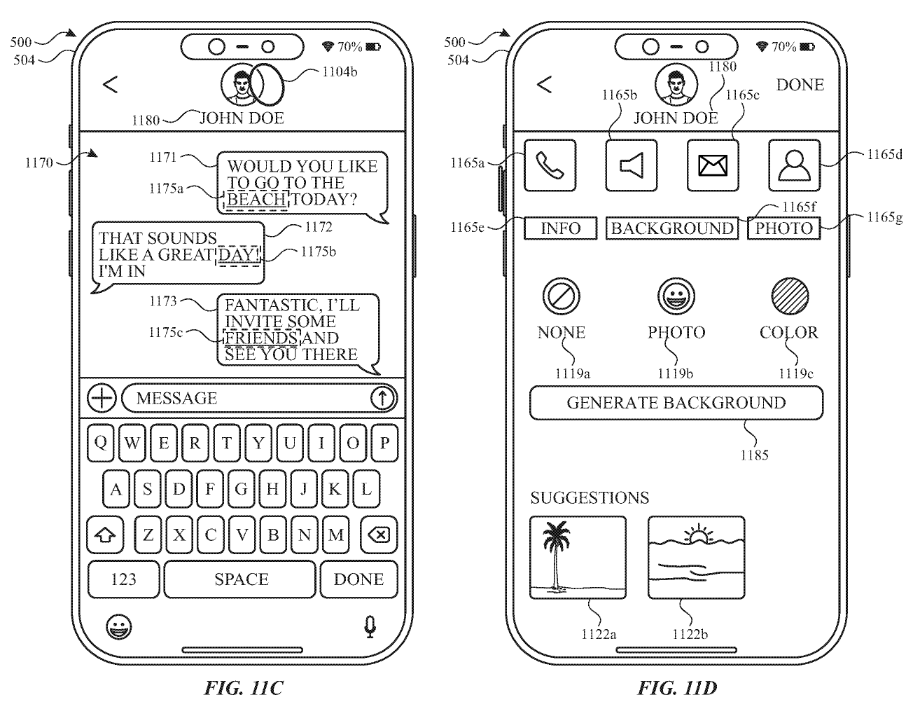

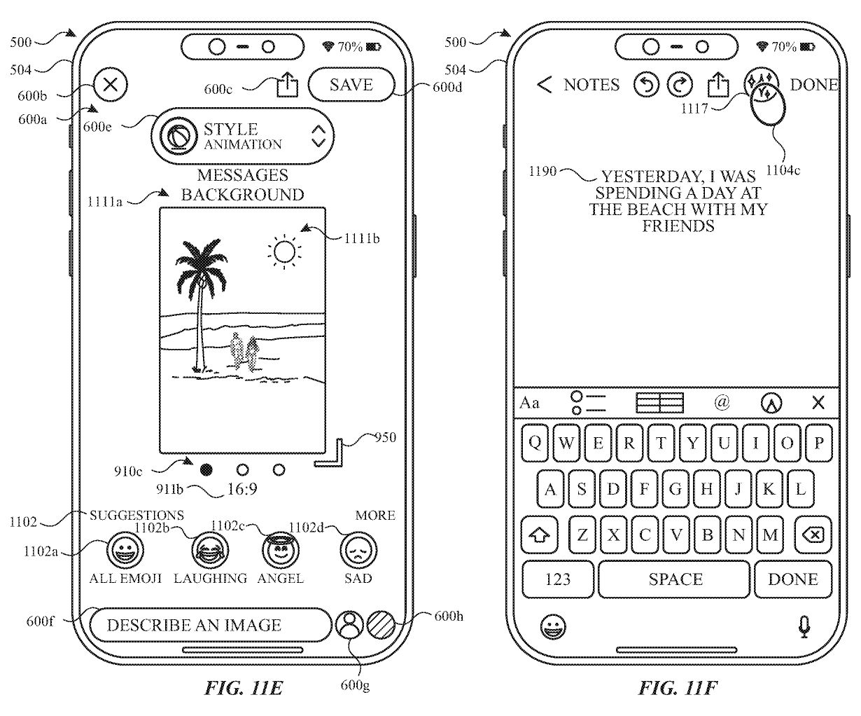

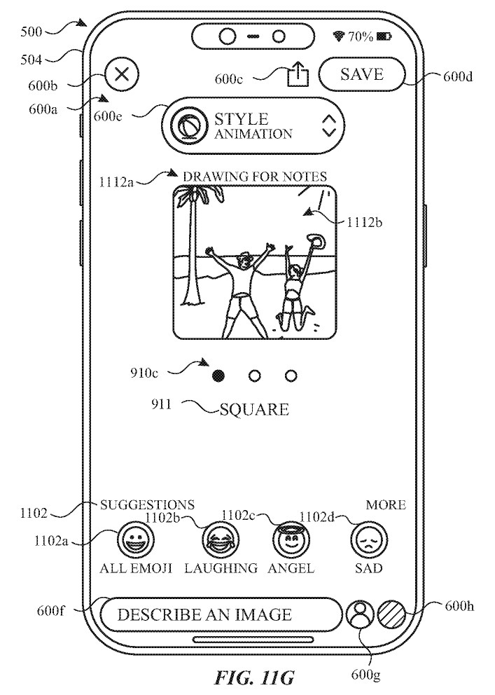

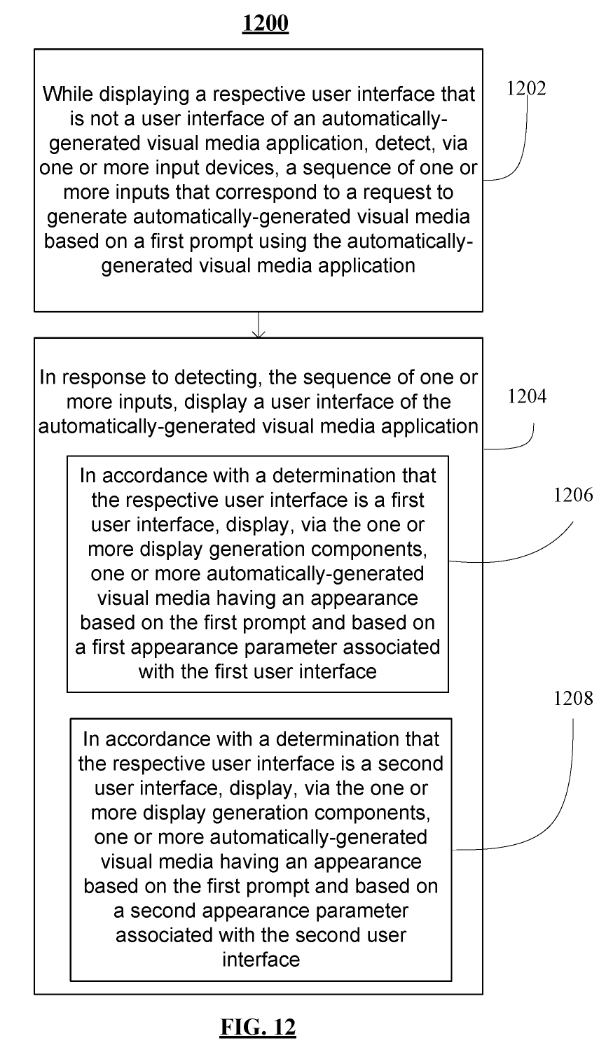

FIGS. 11A to 11G illustrate exemplary ways in which an electronic device generates automatically-generated visual media using a machine learning (ML) model in accordance with some embodiments of the disclosure. The embodiments in these figures are used to illustrate the processes described below, including the processes described with reference to FIG. 12. Although FIGS. 11A-11G illustrate various examples of ways an electronic device is able to perform the processes described below with respect to FIG. 12, it should be understood that these examples are not meant to be limiting, and the electronic device is able to perform one or more processes described below with reference to FIG. 12 in ways not expressly described with reference to FIGS. 11A-11G.

Users interact with electronic devices in many different manners. In some embodiments, an electronic device 500 is in communication with one or more display generation components 504 and one or more input devices described in detail with reference to method 1200 in FIG. 12. The embodiments described below provide ways in which the electronic device generates automatically-generated visual media using a ML model (e.g., described in more detail below and with reference to method 1200). For example, displaying a user interface for generating automatically-generated visual media using one or more ML models enables a user to quickly and conveniently access different ML models, without having to use additional inputs to navigate to a user interface of a ML model, thereby providing more direct interaction with the ML model to the user, reducing the need for additional inputs to display a user interface of the ML model, and avoiding erroneous inputs related to searching for the ML model which reduces power usage and improves battery life of the electronic device by enabling the user to use the electronic device more quickly and efficiently. It is understood that people use devices. When a person uses a device, that person is optionally referred to as a user of the device.

FIGS. 11A to 11G also illustrate that one or more features of the automatically-generated visual media application are accessible from a variety of different entry points (e.g., accessed from within different applications). As a result, an automatically-generated visual media item that is generated will vary based on the entry point to the automatically-generated visual media application, even when one or more prompt components for generating the automatically-generated visual media item are the same. For example, FIGS. 11A to 11B illustrate a method of generating an automatically-generated visual media item via directly accessing a visual media creation user interface 600a of an automatically-generated visual media application. FIGS. 11C to 11E illustrate a method of generating a different automatically-generated visual media item from an entry point to the automatically-generated visual media application via a messaging application. FIGS. 11F to 11G illustrate a method of generating a further different automatically-generated visual media item from an entry point to the automatically-generated visual media application via a notes application. Thus, the automatically-generated visual media items seen in FIGS. 11B, 11E, and 11G, and 11G are all different, even though the same prompt components (e.g., “Day”, “Beach”, and “Friends”) were used to generate the respective items.

FIG. 11A illustrates an electronic device 500 with a display generation component 504 (e.g., a touchscreen). In some embodiments, the electronic device 500 is a mobile device, such as a smartphone, tablet, wearable device, or any of the devices described in method 1000. In some embodiments, the electronic device 500 displays, via the display generation component 504, a plurality of different user interfaces of applications associated with the electronic device 500. For example, in FIG. 11A, the electronic device 500 displays, via display generation component 504, a visual media creation user interface 600a of an automatically-generated visual media application. In some embodiments, the visual media creation user interface 600a of an automatically-generated visual media application includes a plurality of user interface components or user interface elements (e.g., menus, fields, icons, buttons, options, or other element) that are selectable to initiate a process for generating automatically-generated visual media based on a prompt using a ML model. In some embodiments, the electronic device 500 initiates the process for generating an automatically-generated visual media in response to detecting (or, optionally, receiving) a prompt for use in generating automatically-generated visual media. In some embodiments, the prompt includes one or more prompt components and these prompt components include text, keywords, images, video, special characters, visual media, and/or other inputs describing a concept (e.g., style, theme, mood, activity, costume, accessory, places, graphics, or visual characteristic that will influence the generation of the automatically-generated visual media). In some embodiments, the one or more prompt components include computer-generated suggested concepts (or, optionally referred to as predefined concepts) or recognized concepts. For example, in FIG. 11A, the visual media creation user interface 600a includes a set of suggested prompt components 1102a through 1102h corresponding to computer-generated suggested concepts. For example, a respective prompt component (e.g., prompt component 1102a, prompt component 1102b, prompt component 1102c, prompt component 1102d, prompt component 1102e, prompt component 1102f, prompt component 1102g, or prompt component 1102h) is selectable (e.g., via various input methods described below, and in more detail, in method 700) to cause the electronic device 500 to use a corresponding computer-generated suggested concept (e.g., Argentina, penguins, hiker, Patagonia, adventure, beach, sunset, or shark) as basis or influence for generating automatically-generated visual media. In some embodiments, the set of suggested prompt components 1102a through 1102h share one or more characteristics with prompt components 602a through 602h (and/or 902a through 902h), respectively. Thus, in some embodiments, the electronic device 500 combines techniques described with reference to prompt components 602a through 602h (and/or 902a through 902h) with techniques described with respect to suggested prompt components 1102a through 1102h.

The visual media creation user interface 600a also includes content entry field 600f that, when selected (e.g., via various input methods described below, and in more detail, in method 700), causes the electronic device 500 to display, via display generation component 504, a soft keyboard (e.g., described in more detail below with reference to FIG. 6H) for inputting a textual description and/or one or more emojis that is used as a prompt component for use in generating an automatically-generated visual media.

The visual media creation user interface 600a also includes a subject prompt component option 600g that, when selected, causes the electronic device 500 to display a user interface component. In some embodiments, the visual media creation user interface 600a also includes an add photo prompt component option 600h that, when selected, causes the electronic device 500 to initiate a process to take a photo of a subject for inclusion in the prompt for generating the automatically-generated visual media; or initiate a process to select a photo of a subject from a photo library for inclusion in the prompt for generating the automatically-generated visual media.

The visual media creation user interface 600a also includes a style prompt component option 600e that, when selected, causes the electronic device 500 to display a user interface component. In some embodiments, the visual media creation user interface 600a also includes a cancel option 600b that, when selected, causes the electronic device 500 to close (e.g., cease to display) the visual media creation user interface 600a. In some embodiments, the cancel option 600b shares one or more characteristics with the close user interface element 600b.

In some embodiments, the electronic device 500 detects a request to generate an automatically-generated visual media item based on a prompt that includes one or more prompt components. For example, the electronic device 500 identifies the request to generate an automatically-generated visual media item in response to detecting a sequence of one or more inputs to add one or more prompt components. FIG. 11A illustrates a result of detecting the sequence of one or more inputs to add the one or more prompt components, as three prompt components 1106a, 1106b, and 1106c are displayed as bubbles in the central portion of the visual media creation user interface 600a. In some embodiments, the one or more inputs to add the first prompt component 1106a, the second prompt component 1106b, and the third prompt component 1106c shares one or more characteristics with the one or more inputs to add the prompt components 606a, 606b, and 606c, or 906a and 906b, as described above. In some embodiments, and as shown in FIG. 11A, in response to detecting the sequence of one or more inputs, the electronic device 500 generates a first automatically-generated visual media item (e.g., a first automatically-generated visual media item at a first size) based on a prompt that includes prompt component 1106a, prompt component 1106b, and prompt component 1106c. For example, in FIG. 11A, the electronic device 500 displays in the visual media creation user interface 600a a preview 1106e of the first automatically-generated visual media. In some embodiments, preview 1106e shares one or more characteristics with preview 606e or preview 906e described above.

The visual media creation user interface 600a also includes a deletion user interface element 1106aa associated with the prompt component 1106a that, when selected, causes the electronic device 500 to remove the prompt component 1106a from the prompt for generating automatically-generated visual media. The visual media creation user interface 600a also includes deletion user interface element 1106bb that, when selected, causes the electronic device 500 to remove the prompt component 1106b from the prompt for generating automatically-generated visual media. In some embodiments, the deletion user interface element 1106aa shares one or more characteristics with deletion user interface element 606aa or 906aa described above, the deletion user interface element 1106bb shares one or more characteristics with the deletion user interface element 606bb or 906bb, and the deletion user interface element 1106cc shares one or more characteristics with deletion user interface element 606cc described above.

In some embodiments, this prompt also specified a first style (e.g., animation) provided by a first ML model used to give the first automatically-generated visual media a particular aesthetic appearance or overall artistic look, such as the animation inspired aesthetic shown in the preview 1106e of the first automatically-generated visual media in FIG. 11A, such as is described in relation to method 700 and/or 800. In some embodiments, the prompt also includes other prompt components added in a manner similar to adding prompt component 1102a, prompt component 1102b, and prompt component 1102c described in FIG. 11A. As illustrated in FIG. 11A, the automatically-generated visual media application generates a preview 1106e for an automatically-generated visual media item 1110a that includes two friends on beach during the daytime, based on the first prompt component 1106a having an image of a day, based on the second prompt component 1106b having an image of friends, and based on the third prompt component 1106c having an image of a beach. As discussed above, preview 1106e is generated with an animation style based on the currently selected style from the style prompt component option 600e.

In some embodiments, as illustrated in FIG. 11A, the electronic device detects one or more user inputs directed towards an affordance for creating a complete version of the automatically-generated visual media item, such as “Create” option 1103. In some embodiments, the one or more user inputs includes contact 1104a (which optionally shares one or more characteristics with contacts 604a-ah, described above). Although contact 1104a is illustrated as a touch input, it should be understood that contact 1104a is not limited to touch inputs. Other types of inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible.

In response to detecting contact 1104a directed towards “Create” option 1103, the electronic device displays a new view of the visual media creation user interface 600a as depicted in FIG. 11B. In this view, the visual media creation user interface 600a displays a first automatically generated visual media item 1110a (which optionally shares one or more characteristics with preview 610a and first automatically-generated visual media item 910a). As illustrated, the first automatically-generated visual media item 1110a includes one or more graphical elements 1110b (which optionally share one or more characteristics with one or more graphical elements 910b).

The first automatically-generated visual media item 1110a is generated and displayed in FIG. 11B with a square aspect ratio, as indicated by an indication of the aspect ratio (e.g., the square aspect ratio label 911). Although the first automatically-generated visual media item 1110a that is displayed in FIG. 11B in response to contact 1104a has a square aspect ratio, it should be understood that the default aspect ratio when viewing the first automatically-generated visual media item 1110a in the view of FIG. 11B is not limited to a square aspect ratio, such as is described in relation to method 1000. In some embodiments, the visual media creation user interface 600a also includes a share user interface element 600c that, when selected, causes the electronic device 500 to initiate a process to share, copy, or print the automatically-generated visual media; and a save user interface element 600d that, when selected, causes the electronic device 500 to make the automatically-generated visual media accessible at a respective location (e.g., a first location, a second location, or other location described in more detail with reference to FIGS. 6E-6S and method 700). In response to receiving a selection directed towards the save user interface element 600d and/or the share user interface element 600c, the electronic device initiates a process to share and/or share the currently displayed automatically-generated visual media item, as discussed in further detail in relation to method 1000.

As is illustrated in FIG. 11B, the first automatically-generated visual media item 1110a is a first of a plurality of automatically-generated visual media items associated with the same prompt. In FIG. 11B, icon 910c is displayed to indicate that a first of three automatically-generated visual media items at the square aspect ratio is displayed, as is discussed in further detail in relation to method 1000. As noted above, the generation of the first automatically-generated visual media item 1110a is a result of direct access to the automatically-generated visual media application. That is, as is discussed further in relation to method 1200, the first automatically generated visual media item 1110a is generated based on a first appearance parameter which is provided from the automatically-generated visual media application itself.

FIGS. 11C to 11E illustrate a method for generating automatically-generated visual media items via a messaging application user interface. As depicted in FIG. 11C, a messaging application user interface 1170 includes a messaging conversation having one or more messages sent between the user account of electronic device 500 and another user account (e.g., user account of John Doe). As illustrated, the messaging conversation includes three text messages: first message 1171, second message 1172, and third message 1172.

In FIG. 11C, electronic device 500 detects content in the messaging conversation to use to generate one or more prompt components by the automatically-generated visual media application. As illustrated, the electronic device 500 has detected three words to be used as prompt components, first prompt component 1175a, second prompt component 1175b, and third prompt component 1175c. While the three prompt components 1175a, 1175b, and 1175c are illustrated as being underlined and surrounded by a dashed-line box, it is to be understood that any number of visual effects could be applied to the prompt components 1175a, 1175b, and 1175c to identify them to the user of the electronic device 500. Alternatively, the electronic device 500 applies no visual effect to the prompt components (e.g., the underlining and dashed-line box effects are not visible to the user).

The messaging user interface displayed in FIG. 11C also depicts an affordance associated with displaying a control panel associated with the current messaging conversation, such as current user account element 1180. As illustrated, in FIG. 11C, the electronic device detects one or more user inputs directed towards current user account element 1180. In some embodiments, the one or more user inputs includes contact 1104b (which optionally shares one or more characteristics with contacts 604a-ah, described above). Although contact 1104b is illustrated as a touch input, it should be understood that contact 1104b is not limited to touch inputs. Other types of inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible.

In response to detecting contact 1104b directed towards current user account element 1180, the electronic device displays a control panel view of the messaging user interface 1170 as depicted in FIG. 11D. The control panel view includes a number of affordances associated with performing actions in relation to the current messaging conversation. For example, call option 1165a initiates a phone call with John Doe, video call option 1165b initiates a video call with John Doe, email option 1165c opens an email application and prepares a new email to John Doe, and info option 1165d opens up contact details associated with John Doe. Furthermore, info option 1165e provides information about the current messaging conversation, background option 1165f displays one or more pre-generated backgrounds that are able to be selected and applied as background layer of the messaging conversation, and photo option 1165g displays one or more photos from current messaging conversation (e.g., previously sent photos within the messaging conversation). In response to selecting background option 1165f, the control panel view includes one or more affordances for selecting and/or generating a new background, such as options 1119a through 1119c, options 1122a and 1122b, and “Generate Background” option 1185. The control panel view as illustrated includes an affordance for generating an automatically-generated visual media item from within the messaging application, such as “Generate Background” option 1185. The control panel view as illustrated further includes an affordance for removing a current background layer (e.g., setting the background to a default background, such as to a solid white color), such as “None” option 1119a. The control panel view as illustrated includes an affordance for selecting a photo from a visual media content library as a current background layer, such as “Photo” option 1119b. The control panel view as illustrated includes an affordance for selecting one or more colors (e.g., a color gradient) as the background layer, such as “Color” option 1119c. In addition, control panel view includes one or more suggested automatically-generated visual media items (first suggested automatically-generated visual media item shown as option 1122a and second suggested automatically-generated visual media item shown as option 1122b) to be used as background for the current messaging conversation. As illustrated, first suggested automatically-generated visual media item shown as option 1122a and second suggested automatically-generated visual media item shown as option 1122b are based on the prompt components 1175a through 1175c identified in the current messaging conversation.

As illustrated, in FIG. 11D, if the electronic device detects one or more user inputs directed towards “Generate Background” option 1185, the electronic device 101 optionally initiates a process for generating an automatically-generated visual media item based on the prompt components within the messaging conversation. In some embodiments, the one or more user inputs includes contact 1104c (which optionally shares one or more characteristics with contacts 604a-ah, described above). Although contact 1104c is illustrated as a touch input, it should be understood that contact 1104c is not limited to touch inputs. Other types of inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible. In FIG. 11D, if the electronic device detects one or more user inputs directed towards phone option 1185, the electronic device 101 optionally initiates a phone call with John Doe. Further, if the electronic device detects one or more user inputs directed towards video call option 1165b, the electronic device optionally initiates a video call with John Doe (and similarly, detection of one or more user inputs towards email option 1165c optionally causes the computer system to initiate a process for sending an email to John Doe).

In response to detecting contact 1104c directed towards “Generate Background” option 1185, the electronic device transfers the first prompt component 1175a (“Beach”), second prompt component 1175b (“Day”), and third prompt component 1175c (“Friends”) to the automatically-generated visual media application to generate a second automatically-generated visual media item 1111a. Further in response to detecting contact 1104c, the electronic device 500 displays a visual media creation user interface 600a having a second automatically-generated visual media item 1111a including one or more graphical elements 1111b as depicted in FIG. 11E. As illustrated, in some embodiments, the visual media creation user interface 600a which is displayed in response to selecting the “Generate Background” option 1185 is a user interface generated by the automatically-generated visual media application. In some embodiments, the visual media creation user interface 600a is displayed within the automatically-generated visual media application (e.g., in response to detecting contact 1104c, the electronic device 500 switches the currently-active application to the automatically-generated visual media application). In some embodiments, the visual media creation user interface 600a is displayed within the messaging application (e.g., in response to detecting contact 1104c, the electronic device 500 shares data between the messaging application and the automatically-generated visual media application, and in response, displays a new user interface within the messaging application). As noted above, the generation of the second automatically-generated visual media item 1111a is a result the automatically-generated visual media application being accessed via (e.g., an entry point from) the messaging application. That is, as is discussed further in relation to method 1200, the second automatically generated visual media item 1111a is generated based on a second appearance parameter (e.g., which is provided to the automatically-generated visual media application based on the entry point from the messaging application).

As illustrated in FIG. 11E, the aspect ratio of the second automatically-generated visual media item 1111a is 16:9, as indicated by the 16:9 aspect ratio label 911b. Therefore, as illustrated, the default aspect ratio of an automatically-generated visual media item generated via the messaging application is different from the default aspect ratio of an automatically-generated visual media item generated directly though interaction with the automatically-generated visual media application. In FIG. 11E, icon 910c is displayed to indicate that a first of three automatically-generated visual media items at the 6:9 aspect ratio is displayed, as is discussed in further detail in relation to method 1000. FIG. 11E further illustrates a resizing affordance 950 for changing the size and/or aspect ratio of the second automatically-generated visual media item 1111a, as discussed further in relation to method 1000.

Furthermore, as is illustrated in FIG. 11E, the one or more graphical elements 1111b of the second automatically generated visual media item 1111a include elements that are different from the one or more graphical elements 1110b of the first automatically-generated visual media item 1110a, even though the first automatically-generated visual media item 1110a and second automatically-generated visual media item 1111a are both generated with “Beach”, “Friends”, “Day” as prompt components. For example, as illustrated in FIG. 11B and 11E, the first automatically-generated visual media item 1110a has an appearance based on the first appearance parameter and the second automatically-generated visual media item 1111a has a different appearance based on the second appearance parameter. Thus, the second automatically-generated visual media item 1111a is an image that is suitable for a background layer of the messaging conversation. That is, as illustrated, the friends displayed in the second automatically-generated visual media item 1111a are further in the background, a blurring effect is applied to the image. As shown in FIG. 11E, the text “Messages Background” is displayed above the second automatically-generated visual media item 1111a. It is also possible that this text is not visible to the user (and therefore is displayed in FIG. 11E only for reference) and/or the text is positioned at a different location within visual media creation user interface 600a (such as between the second automatically-generated visual media item 1111a and the icon 910c).

FIGS. 11F to 11G illustrate a method for generating automatically-generated visual media items via a notes application user interface. FIG. 11F depicts a notes application user interface running on the electronic device 500. As illustrated, the notes application user interface displays a current note, including note text 1190 that was previously entered by a user of the electronic device 500. The notes application user interface also includes an affordance for generating an automatically-generated visual media item based on contents within the current note, such as generate option 1117.

As illustrated, in FIG. 11F, if electronic device 500 detects one or more user inputs directed towards the generate option 1117, in response to detecting selection of generate option 1117, the device initiates a process for generating an automatically-generated visual media item based on the contents of the current note. In some embodiments, the one or more user inputs includes contact 1104d (which optionally shares one or more characteristics with contacts 604a-ah, described above). Although contact 1104d is illustrated as a touch input, it should be understood that contact 1104d is not limited to touch inputs. Other types of inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 1000, are possible. Furthermore, if electronic device 500 detects one or more user inputs directed towards the new table icon or the new list icon, in response to detecting selection of the respective icon, the device initiates a process for generating a table and/or list for adding to the contents of the current note. If electronic device 500 detects one or more user inputs directed towards the text change icon or the highlight text icon, the electronic device 500 initiates a process for altering the text size and/or highlighting one or more element of the current note.

In response to detecting contact 1104d directed towards the generate option 1117, the electronic device extracts prompt components from the contents of the current note and transfers the first prompt component 1175a (“Beach”), second prompt component 1175b (“Day”), and third prompt component 1175c (“Friends”) to the automatically-generated visual media application to generate a third automatically-generated visual media item 1112a. Further in response to detecting contact 1104d, the electronic device 500 displays a visual media creation user interface 600a having a third automatically-generated visual media item 1112a including one or more graphical elements 1112b as depicted in FIG. 11G. As illustrated, in some embodiments, the visual media creation user interface 600a which is displayed in response to selecting the generate option 1117 is a user interface generated by the automatically-generated visual media application. In some embodiments, the visual media creation user interface 600a is displayed within the automatically-generated visual media application (e.g., in response to detecting contact 1104d, the electronic device 500 switches the currently-active application to the automatically-generated visual media application). In some embodiments, the visual media creation user interface 600a is displayed within the notes application (e.g., in response to detecting contact 1104d, the electronic device 500 shares data between the messaging application and the automatically-generated visual media application, and in response, displays a new user interface within the messaging application).

As noted above, the generation of the second automatically-generated visual media item 1112a is a result the automatically-generated visual media application being accessed via (e.g., an entry point from) the notes application. In some embodiments, the third automatically generated visual media item 1112a is generated based on a third appearance parameter (e.g., which is provided to the automatically-generated visual media application based on the entry point from the notes application), as is discussed further in relation to method 1200.

As illustrated in FIG. 11G, the aspect ratio of the second automatically-generated visual media item 1112a is square, as indicated by the square aspect ratio label 911. Therefore, as illustrated, the default aspect ratio of an automatically-generated visual media item generated via the notes application is the same as the default aspect ratio of an automatically-generated visual media item generated directly though interaction with the automatically-generated visual media application, but different from a default aspect ratio of an automatically-generated visual media item generated via a different application (e.g., a messaging application). In FIG. 11G, icon 910c is displayed to indicate that a first of three automatically-generated visual media items at the square aspect ratio is displayed, as is discussed in further detail in relation to method 1000. Furthermore, as is illustrated in FIG. 11G, the one or more graphical elements 1112b of the third automatically generated visual media item 1112a include elements that are different from the one or more graphical elements 1110b of the first automatically-generated visual media item 1110a and the one or more graphical elements 1111b of the second automatically-generated visual media item 1111a, even though the third automatically-generated visual media item, the first automatically-generated visual media item 1110a, and the second automatically-generated visual media item 1111a are generated with “Beach”, “Friends”, “Day” as prompt components, respectively.

For example, as illustrated in FIG. 11B, 11E, and 11G, the first automatically-generated visual media item 1110a has an appearance based on the first appearance parameter, the second automatically-generated visual media item 1111a has a different appearance based on the second appearance parameter, and the third automatically-generated visual media item 1112a has a further different appearance based on the third appearance parameter. Thus, the third automatically-generated visual media item 1112a is an image that is suitable for insertion as an image into the current note. For example, as illustrated in FIG. 11G, the friends displayed in the third automatically-generated visual media item 1112a are in the close foreground of the image, without any a blurring effect applied to the image. As shown in FIG. 11G, the text “Drawing for Notes” is displayed above the second automatically-generated visual media item. It is also possible that this text is not visible to the user (and therefore is displayed in FIG. 11G only for reference) and/or the text is positioned at a different location within visual media creation user interface 600a (such as between the third automatically-generated visual media item 1112a and the icon 910c).

FIG. 12 illustrates a flow diagram illustrating a method in which an electronic device displays one or more automatically-generated visual media having an appearance based on a prompt and based on a respective appearance parameter associated with a respective user interface in accordance with some embodiments of the disclosure. The method 1200 is optionally performed at first electronic device and/or electronic devices such as device 100, device 300, or device 500 as described above with reference to FIGS. 1A-1B, 2-3, 4A-4B and 5A-5H. Some operations in method 1200 are, optionally combined and/or order of some operations is, optionally, changed.

By generating one or more one or more automatically-generated visual media items to have a certain appearance based on a prompt being received from a different respective application, an appearance of the one or more automatically-generated visual media items can be controlled without a further user input. For example, when a prompt to generate an automatically-generated visual media item is received from a messaging application, a background wallpaper can be automatically-generated without the need for a user to specify the type of visual media which is to be generated. This reduces the number of user interactions with an automatically-generated visual media application, which can reduce user error and expedite the generation of the visual media, thereby reducing the amount of computing resources required to perform the task.

In some embodiments, a method 1200 is performed at an electronic device, such as electronic device 500, in communication with one or more display generation components, such as display generation component 504, and one or more input devices. In some embodiments, the electronic device, the one or more display generation components, and/or the one or more input devices, share one or more characteristics with the electronic device, one or more display generation components, and/or input devices described with respect to method 700, 800, and/or 1000.

In some embodiments, while displaying a respective user interface that is not a user interface of an automatically-generated visual media application, such as messaging application user interface 1170 shown in FIG. 11C, electronic device 500 detects, via the one or more input devices, a sequence of one or more inputs that correspond to a request to generate one or more automatically-generated visual media items based on a first prompt using the automatically-generated visual media application, such as is shown by contact 1104b in FIG. 11C to select current user account element 1180 and open the control panel view and contact 1104c in FIG. 11D to select the “Generate Background” option 1185. In some embodiments, the respective user interface includes a user interface associated with one or more of the following applications running on the electronic device: a messaging application, a notes application, a social media application, a photo application, a music application, a map or transit application, and a games application.

In some embodiments, the sequence of one or more inputs that correspond to a request to generate one or more automatically-generated visual media items includes a selection of one or more affordances displayed on the respective user interface (e.g., one or more button presses on a touch display, detecting attention (e.g., including gaze) and/or a gesture performed by the user; and/or one or more inputs received from a hardware input device of the one or more input devices). In some embodiments, a first prompt comprises an input directed to an automatically-generated visual media application and/or one or more machine learning models (e.g., text, image, data associated with a source application, or a current time), such as is illustrated by a prompt having prompt components 1106a through 1106c in FIG. 11A. In some embodiments, the first prompt includes one or more prompt components. In some embodiments, the one or more prompt components include one or more concepts to be shown in the one or more automatically-generated visual media items (e.g., text indicating a parameter for the generation of the visual media). In some embodiments, the one or more prompt components include a visual style for the one or more automatically-generated visual media items. In one example, the prompt components include text (e.g., “balloon”) and a visual style (e.g., “cartoon”) and these components are fed into a machine learning model as inputs, which allows the machine learning model to generate one or more AI-generated images including a balloon in the visual style of a cartoon.

In some embodiments, the one or more automatically-generated visual media items comprises a visual media item that is generated by an automatically-generated visual media application and/or one or more machine learning (AI) models, such as is illustrated by first automatically-generated visual media item 1110a shown in FIG. 11B. In some embodiments, the automatically-generated visual media application shares one or more characteristics with the automatically-generated visual media application described with respect to method 700 and/or 800. In some embodiments, the one or more ML models share one or more characteristics with the first ML models described with respect to method 700 and/or 800. In some embodiments, the one or more automatically-generated visual media items has one or more characteristics of the automatically-generated visual media described in method 700, 800, and/or 1000.

In some embodiments, in response to detecting the sequence of one or more inputs, the electronic device 500 displays (1012) a user interface of the automatically-generated visual media application, such as is shown by the display of visual media creation user interface 600a. In some embodiments, the user interface of the automatically-generated visual media application is displayed within the respective user interface. In some embodiments, displaying the user interface of the automatically-generated visual media application includes switching the application that is active on the display of the electronic device from the application associated with respective user interface to the automatically-generated visual media application.

In some embodiments, displaying a user interface of the automatically-generated visual media application includes: in accordance with a determination that the respective user interface is a first user interface, such as messaging application as illustrated in FIG. 11C and 11D, displaying (1206), via the one or more display generation components, one or more automatically-generated visual media items having an appearance based on the first prompt and based on a first appearance parameter associated with the first user interface, such as is illustrated by second automatically-generated visual media item 1111a illustrated in FIG. 11E. In some embodiments, displaying, via the one or more display generation components, one or more automatically-generated visual media items having an appearance based on the first prompt and based on the first appearance parameter comprises generating the one or more automatically-generated visual media items using a first machine learning (AI) model.

In some embodiments, the determination that the respective user interface is a first user interface includes a determination that the first prompt is received from a first source (e.g., from a certain application running on the electronic device, or from a certain element of an application running on the electronic device), such as a determination in FIG. 11A that the automatically-generated visual media application was directly accessed resulting in first automatically-generated visual media item 1110a in FIG. 11B. For example, a plurality of applications running on the electronic device include automatic visual media generation features that leverage an automatic visual media generation application. In some embodiments, the determination that the respective user interface is a first user interface includes a determination of the first appearance parameter associated with the first user interface. In some embodiments, the first appearance parameter includes an indication of the first source and/or an appearance characteristic for the appearance of the one or more automatically-generated visual media items (e.g., a visual style, a size, a shape, an aspect ratio, and/or particular visual content of the one or more automatically-generated visual media items).

In some embodiments, the first prompt is received at the automatically-generated visual media application with contextual data (e.g., a timestamp, user credentials, or data associated with the electronic device). In some embodiments, the first appearance parameter includes the contextual data. In some embodiments, the contextual data is received from an application associated with the first user interface. In some embodiments, the automatically-generated visual media application generates the visual media in accordance with the contextual data. In some embodiments, the first source sends the first prompt to an automatically-generated visual media application as part of a visual media generation request. As another example, when an automatically-generated visual media application is active on the electronic device, the automatically-generated visual media application receives a first prompt from an external source (e.g., a photo application) and generates one or more automatically-generated visual media items based on the context of the external source.

As a further example, when an automatically-generated visual media application is active on the electronic device, the first prompt is received from a certain element of the automatically-generated visual media application itself. As a result, the first source is the automatically-generated visual media application in some embodiments. For example, one or more inputs is provided to the automatically-generated visual media application (e.g., a user inputs one or more text inputs to the automatically-generated visual media application for generating a certain visual media item, such as an emoji). For example, when the automatically-generated visual media application receives a first prompt from a messaging application, the automatically-generated visual media application generates an automatically-generated background wallpaper for the messaging application based on the first prompt. As another example, when the automatically-generated visual media application receives the first prompt from a social media application (e.g., the same first prompt described as being received by the messaging application), the automatically-generated visual media application generates an automatically-generated emoji based on the first prompt. In these examples, the first prompt provided by different respective applications to the automatically-generated visual media application is identical, and the automatically-generated application differently processes the generation of the one or more automatically-generated visual media items based solely on the source of the first prompt.

In some embodiments, displaying a user interface of the automatically-generated visual media application includes: in accordance with a determination that the respective user interface is a second user interface different from the first user interface, such as notes application illustrated in FIG. 11F, displaying (1208), via the one or more display generation components, one or more automatically-generated visual media items having an appearance based on the first prompt and based on a second appearance parameter associated with the second user interface, wherein the second appearance parameter is different from the first appearance parameter, such as is illustrated by third automatically-generated visual media item 1112a illustrated in FIG. 11G having a different appearance from second automatically-generated visual media item 1111a illustrated in FIG. 11E. In some embodiments, displaying, via the one or more display generation components, one or more automatically-generated visual media items having a second appearance based on the first prompt and based on a second appearance parameter associated with the second user interface comprises generating one or more automatically-generated visual media items using a second machine learning (AI) model. In some embodiments, the second ML model is the same as the first ML model.

In some embodiments, the determination that the respective user interface is a second user interface includes a determination that the second prompt is received from a second source, that is different from the first source (e.g., a certain application running on the electronic device, or a certain element of an application running on the device), such as a determination in FIG. 11D that the automatically-generated visual media application was accessed via the messaging application resulting in second automatically-generated visual media item 1111a in FIG. 11E. In some embodiments, the second source shares one or more characteristics with the first source discussed above. In some embodiments, the determination that the respective user interface is a second user interface includes a determination of the second appearance parameter associated with the second user interface. In some embodiments, the second appearance parameter includes an indication of the second source and/or an appearance characteristic for the appearance of the one or more automatically-generated visual media items (e.g., a visual style, a size, a shape, an aspect ratio, and/or particular visual content of the one or more automatically-generated visual media items).

In some embodiments, the first prompt is received at the automatically-generated visual media application with contextual data (e.g., a timestamp, user credentials, or data associated with the electronic device). In some embodiments, the second appearance parameter includes the contextual data. In some embodiments, the contextual data is received from an application associated with the second user interface. In some embodiments, the automatically-generated visual media application generates the visual media in accordance with the contextual data. In some embodiments, the second appearance characteristic shares one or more characteristics with the first appearance characteristic discussed above.

In some embodiments, the appearance of the one or more automatically-generated visual media items based on the first prompt and based on the first appearance parameter is different from the appearance of the one or more automatically-generated visual media items based on the first prompt and based on the second appearance parameter, such as is illustrated by third automatically-generated visual media item 1112a illustrated in FIG. 11G having a different appearance from second automatically-generated visual media item 1111a illustrated in FIG. 11E. In some embodiments, different appearance parameters (e.g., associated with different user interfaces) result in different appearances of automatically-generated visual media items generated based on the same prompt. In some embodiments, different generated content comes from different prompts provided based on a same entry point. In some embodiments, prompts that include the same prompt components specifying semantic contents of the one or more automatically-generated visual media items are the same prompt, even if they are associated with different appearance parameters, such as the first appearance parameter and the second appearance parameter. In some embodiments, a respective user interface provides a respective appearance parameter to the automatically-generated visual media application. In some embodiments, the first appearance parameter and/or the second appearance parameter are not provided based on a user input (e.g., are received independent of any action taken by a user). For example, the user does not control the appearance parameters, but rather the entry point to the automatically-generated visual media application dictates the appearance parameter. For example, when a first prompt is received at the automatically-generated visual media application (e.g., including a number of prompt components such as “day”, “beach”, “friends”) from a messaging application, the automatically-generated visual media application generates a background image having a 9:16 aspect ratio and a high amount of blur based on the first prompt. As another example, when the same first prompt (e.g., including the same prompt components) is received at the automatically-generated visual media application from a notes application, the automatically-generated visual media application generates a square image (1:1 aspect ratio) with a low level of blur. In some embodiments, as discussed above, the appearance between two generated visual media items based on different appearance parameters varies based on a different visual style, size, shape, aspect ratio, and/or particular visual content. In some embodiments, content of (e.g., elements included in) the one or more automatically-generated visual media items based on the first appearance parameter is different from content of the one or more automatically-generated visual media items based on the second appearance parameter. In some embodiments, content of (e.g., elements included in) the one or more automatically-generated visual media items based on the first appearance parameter is the same from content of the one or more automatically-generated visual media items based on the second appearance parameter, but the visual appearance of the content in a respective automatically-generated visual media item is different. In some embodiments, the different visual appearances of the same content is due to one or more of the following: different filtering applied to the content, different overlays applied to the content (e.g., a blurring effect, a lighting effect), and/or a different aspect ratio

In some embodiments, while displaying a second respective user interface, electronic device 500 detects, via the one or more input devices, a second sequence of one or more inputs that correspond to a request to generate one or more automatically-generated visual media items based on a second prompt using the automatically-generated visual media application, such as is illustrated by the visual media creation user interface 600a of the automatically-generated visual media application shown in FIGS. 11A and 11B.

In some embodiments, the second respective user interface is a user interface of the automatically-generated visual media application. In some embodiments, the second respective user interface is a user interface that is not the respective user interface discussed above. In some embodiments, the respective user interface includes a user interface associated with one or more of the following applications running on the electronic device: an automatically-generated visual media application, a messaging application, a notes application, a social media application, a photo application, a music application, a map or transit application, and a games application.

In some embodiments, the second sequence of one or more inputs that correspond to a request to generate one or more automatically-generated visual media items includes a selection of one or more affordances displayed in the respective user interface (e.g., one or more button presses on a touch display, detecting attention (e.g., including gaze) and/or a gesture performed by the user; and/or one or more inputs received from a hardware input device of the one or more input devices), such as if the “Generate Background” option 1185 depicted in FIG. 11D were selected by a contact input. In some embodiments, the second sequence of one or more inputs that correspond to a request to generate one or more automatically-generated visual media items includes an interaction with a virtual assistant and/or another system user interface (e.g., a user interface not associated with another application running on the electronic device) that passes the one or more inputs to the automatically-generated visual media application.

In some embodiments, the second sequence of one or more inputs provide the second prompt to the automatically-generated visual media application and/or one or more machine learning models. In some embodiments the second prompt includes one or more prompt components (e.g., text, image, data associated with a source application, or a current time). In some embodiments, the second prompt shares one or more characteristics with the first prompt discussed above. In some embodiments, the second prompt is the same as the first prompt as described above, with reference to the prompts being the same. In some embodiments, the second prompt is different from the first prompt (e.g., including different prompt components). In some embodiments, the second prompt is received with a second appearance characteristic and the first prompt is received with a first appearance characteristic. In some embodiments, the first appearance characteristic is different from the second appearance characteristic. In some embodiments, the first appearance characteristic is the same as the second appearance characteristic.

In some embodiments, in response to detecting the second sequence of one or more inputs, electronic device 500 displays, via the one or more display generation components, a second user interface of the automatically-generated visual media application, such as is illustrated by the view of visual media content creation user interface 600a shown in FIG. 11B In some embodiments, the second user interface of the automatically-generated visual media application is the same user interface as the first user interface of the automatically-generated visual media application and/or shares one or more characteristics with the first user interface of the automatically-generated visual media application. In some embodiments, the second user interface of the automatically-generated visual media application is a different user interface than the first user interface of the automatically-generated visual media application. In some embodiments, the second user interface of the automatically-generated visual media application is displayed within the second respective user interface. In some embodiments, displaying the second user interface of the automatically-generated visual media application includes switching the application that is active on the display of the electronic device from the application associated with second respective user interface to the automatically-generated visual media application. In some embodiments, displaying the second user interface of the automatically-generated visual media application includes maintaining display of a user interface of the automatically-generated visual media application (e.g., when the second prompt is received from within the automatically-generated visual media application).

In some embodiments, displaying the second user interface of the automatically-generated visual media application includes: in accordance with a determination that the second respective user interface is a third user interface of the automatically-generated visual media application, displaying, via the one or more display generation components, one or more automatically-generated visual media items having an appearance based on the second prompt and based on a third appearance parameter associated with the third user interface, such as illustrated by the first automatically-generated visual media item 600a shown in FIG. 11B.

In some embodiments, displaying, via the one or more display generation components, one or more automatically-generated visual media items having an appearance based on the second prompt and based on a third appearance parameter comprises generating the one or more automatically-generated visual media items using a third machine learning (ML) model. In some embodiments, the third ML model is the same as the first ML model and/or the second ML model. In some embodiments, the appearance based on the second prompt and based on the third appearance parameter is different from the appearance based on the first prompt and based on the first appearance parameter and/or the appearance based on the first prompt and based on the second appearance parameter. In some embodiments, the third appearance parameter is different from the first appearance parameter and/or the second appearance parameter.

In some embodiments, the third user interface of the automatically-generated visual media application is the same as the second user interface of the automatically-generated visual media application. In some embodiments, the determination that the second respective user interface is a third user interface of the automatically-generated visual media application includes a determination that the second prompt is received from the automatically-generated visual media application running on the electronic device. In some embodiments, the determination that the second respective user interface is a third user interface of the automatically-generated visual media application includes a determination of the third appearance parameter associated with the third user interface. In some embodiments, the third appearance parameter includes an indication of the source and/or an appearance characteristic for the appearance of the one or more automatically-generated visual media items (e.g., a visual style, a size, a shape, an aspect ratio, and/or particular visual content of the one or more automatically-generated visual media items).

In some embodiments, the second prompt is received at the automatically-generated visual media application with contextual data (e.g., a timestamp, user credentials, or data associated with the electronic device). In some embodiments, the third appearance parameter includes the contextual data. In some embodiments, the automatically-generated visual media application generates the visual media in accordance with the contextual data. As an example, when an automatically-generated visual media application is active on the electronic device, the second prompt is received from a certain element of the automatically-generated visual media application itself. As a result, the source of the second prompt is the automatically-generated visual media application in some embodiments. For example, one or more inputs (e.g., one or more button presses on a touch display, detecting attention (e.g., including gaze) and/or a gesture performed by the user; and/or one or more inputs received from a hardware input device of the one or more input devices) is provided to the automatically-generated visual media application (e.g., a user inputs one or more text inputs to the automatically-generated visual media application for generating a certain visual media item, such as an emoji).

In some embodiments, displaying the second user interface of the automatically-generated visual media application includes: in accordance with a determination that the second respective user interface is a fourth user interface that is not a user interface of the automatically-generated visual media application, displaying, via the one or more display generation components, one or more automatically-generated visual media items having an appearance based on the second prompt and based on a fourth appearance parameter associated with the fourth user interface, such as if the fourth user interface were a user interface of another application, such as a messaging application as shown in FIG. 11C and resulted in a display of an automatically-generated visual media item having an appearance in accordance with the second prompt and in accordance with an appearance parameter based on the messaging application. In embodiments, the one or more automatically-generated visual media items having the appearance based on the second prompt and based on the fourth appearance parameter comprise a visual representation of a background layer for the fourth user interface, such as if the fourth user interface were a user interface of another application, such as a messaging application as shown in FIG. 11C. In some embodiments, displaying, via the one or more display generation components, one or more automatically-generated visual media items having an appearance based on the second prompt and based on a fourth appearance parameter comprises generating the one or more automatically-generated visual media items using a fourth machine learning (AI) model. In some embodiments, the fourth ML model is the same model as the first, second, and/or third ML models.

In some embodiments, the appearance based on the second prompt and based on the fourth appearance is different from the appearance based on the second prompt and based on the third appearance parameter, the appearance based on the first prompt and based on the first appearance parameter, and/or the appearance based on the first prompt and based on the second appearance parameter. In some embodiments, the fourth appearance parameter is different from the first appearance parameter, the second appearance parameter, and/or the third appearance parameter.

In some embodiments, the fourth user interface is optionally the same as the first and/or second user interface. In some embodiments, the determination that the second respective user interface is a fourth user interface shares one or more characteristics with the determination that the respective user interface is a first user interface and/or a second user interface, as discussed above. In some embodiments, the fourth appearance parameter shares one or more characteristic with the first and second appearance characteristics discussed above.

In some embodiments, the one or more automatically-generated visual media items having the appearance based on the second prompt and based on the third appearance parameter is not a visual representation of a background layer. For example, an automatically-generated visual media item has a different appearance based on the source of the prompt for generating the visual media (e.g., directly within an automatically-generated visual media application vs. from a background generation context such as a messaging application). As an example, when the second prompt is received directly from within the automatically-generated visual media application, the automatically-generated visual media application generates a square image having a specific visual style and when the second prompt is received from another application, the automatically-generated visual media application generates an image with a different aspect ratio and/or different visual style.

In some embodiments, the fourth user interface is a messaging user interface associated with a messaging application, including a messaging conversation between a user account of the electronic device and a second user account (optionally of a different electronic device), such as the messaging application illustrated in FIG. 11C.In some embodiments, the second prompt includes one or more prompt components based on contents of the messaging conversation, such as is illustrated by messaging application user interface 1170 in FIG. 11C and prompt components 1175a through 1175c shown in FIG. 11C.

In some embodiments, the messaging application corresponds to messages which include text based messaging, voice based messaging, visual media based messaging (e.g., photo, video, animations, and/or Machine Learning (ML) generated media, and/or other messaging activity.), and/or social media applications. In some embodiments, the messaging user interface includes representations of messaging activity (e.g., text-based messages, voice-recorded messages, and/or messages with graphical and/or image content between the first user and a participant associated with the second user account, optionally a first participant). In some embodiments, a messaging application refers to an application running on the electronic device that displays and/or facilitates messaging activity (e.g., representations of text messages, images, web-links, and/or other messaging activity) which are sent to and received from other users and/or electronic devices. In some embodiments, the representations of messages displayed via the messaging user interface include representations of messages between the first user and a first participant. In some embodiments, the representations of messages displayed via the messaging user interface includes representations of messages between the first user and one or more other participants in the messaging conversation (e.g., a first participant, a second participant, a third participant, and/or other participants in the conversation) within the same conversation, wherein one or more or any messages sent or received by the first user and/or the one or more second users, are received by one or more or of the respective users within the conversation. In some embodiments, the representations of messages displayed via the messaging user interface includes representations of messages between the first electronic device corresponding to the first user and a one or more second electronic devices corresponding to one or more respective second users.

In some embodiments, the presence of first content in the contents of the messaging conversation results in first prompt components for the first prompt corresponding to the first content, such as is illustrated by second automatically-generated visual media item 1111a illustrated in FIG. 11E having an appearance based on first through third prompt components 1175a through 1175c.. In some embodiments, the presence of second content in the contents of the messaging conversation results in second prompt components for the second prompt corresponding to the second content.

In some embodiments, while the electronic device displays the messaging user interface, the electronic device receives (or, optionally, detects), via the one or more input devices, a prompt including one or more prompt components associated with the messaging conversation. In some embodiments, a prompt component includes text, keywords, images, video, special characters, visual media, and/or other inputs describing a concept (e.g., style, theme, mood, activity, costume, accessory, places, graphics, or visual characteristic that will influence the generation of the visual media). In some embodiments, one of the prompt components is based on the contents of the messaging conversation (e.g., derived from the text of the messaging conversation). For example, when the electronic device detects that the first user and the second user have started talking about golfing in the recent text messages, the electronic device detects this new topic, and generates a prompt associated with golf for use by the automatically-generated visual media application. In some embodiments, the prompt component includes a computer-generated suggested concept (or, optionally referred to as a predefined concept) or a recognized concept. For example, the electronic device optionally uses the respective ML model and/or language/image understanding capabilities (e.g., built-in the electronic device or part of the operating system of the electronic device) to recognize the prompt component as a particular concept.

In some embodiments, the electronic device determines the one or more prompt components that are based on the contents of the messaging conversation without any user input to specify the one or more prompt components. In some embodiments, a first prompt component of the one or more prompt components corresponds to a first predefined concept that will influence the generation of the visual media.

In some embodiments, the electronic device generates the prompt having a number of prompt components based on the content of the messaging conversation for use with the automatically generated visual media application. In some embodiments, first prompt components (e.g., for a first prompt) corresponding to first messaging content are generated based on the first messaging content, and second prompt components (e.g., for a second prompt) corresponding to second messaging content are generated based on the second messaging content, such as if different messages were present in FIG. 11C (including different prompt components) to result in a different image being generated in FIG. 11E as opposed to the second automatically-generated visual media item 1111a.. For example, when the electronic device detects that the first user and the second user have started talking about golfing in the recent text messages, the electronic device detects this new topic, and generates the second prompt in accordance with the determined topic.

In some embodiments, the appearance based on the first prompt and based on the second appearance parameter includes one or more visual effects that are not present in the appearance based on the first prompt and based on the first appearance parameter, such as is illustrated by the blurring effect applied to the people in the second automatically-generated visual media item 1111a shown in FIG. 11E versus the lack of a blurring effect shown in the first automatically-generated visual media item 600a shown in FIG. 11B.

In some embodiments, the one or more visual effects include one or more of the following: a simulated tilt-shift effect, a simulated bokeh effect, a simulated macro-photography effect, and/or a reduced amount of high-frequency elements in the appearance compared to an amount of high-frequency elements in the appearance of the first appearance parameter, such as is illustrated by the blurring effect applied to the people in the second automatically-generated visual media item 1111a shown in FIG. 11E.

In some embodiments, one or more visual effects are applied, during generation of the one or more automatically-generated visual media items, to the visual media generated based on the second appearance parameter. In some embodiments, an effect applied to the visual media generated based on the second appearance parameter is not applied to the visual media generated based on the first appearance parameter. In some embodiments, the one or more visual effects are associated with creating one or more background images for display in a background layer of a UI, such as a background of a messaging application UI or of a home screen.

In some embodiments, a simulated tilt-shift effect includes a visual effect applied to an image mimicking a tilt-shift performed by a real camera. In some embodiments, a tilt-shift includes a change to the tilt of the image (e.g., based on a rotation of a lens plane relative to an image plane) and/or a shift in the movement of the lens parallel to the image plane, resulting in a change in a focus plane in the image. In some embodiments, a simulated macro-photography effect includes a visual effect applied to an image mimicking one or more features present in a macro-photography image (e.g., a more pronounced bokeh effect or high degree of contrast between lights and shadows).

In some embodiments, an amount of high-frequency elements corresponds to an amount of fine-detailed elements, or the parts of the image that rapidly change color across the image (e.g., hair, pores, lines). In some embodiments, an amount of low-frequency elements corresponds to an amount of coarse-detailed elements (e.g., tone and shadows). In some embodiments, the high-frequency elements and low-frequency elements are independently adjustable (e.g., reducing the high-frequency elements includes reducing the resolution and/or contrast of the image or so as to reduce the visibility of sharp edges in the image).

In some embodiments, while displaying the respective user interface that is not a user interface of the automatically-generated visual media application, electronic device 500 detects, via the one or more input devices, a second sequence of one or more inputs that correspond to a request to generate one or more automatically-generated visual media items based on a second prompt using the automatically-generated visual media application, such as if a contact input were provided directed towards the “Generate Background” option 1185 shown in FIG. 11D. As noted above, in some embodiments, prompts that include the same prompt components specifying semantic contents of the one or more automatically-generated visual media items are the same prompt, even if they are associated with different appearance parameters, such as the first appearance parameter and the second appearance parameter. In some embodiments, the second prompt shares one or more characteristics with the first prompt. In some embodiments, the second prompt is different from the first prompt (e.g., the second prompt includes different prompt components) and therefore leads to a different visual media item to be automatically-generated even with a same appearance parameter. In some embodiments, the second sequence of one or more inputs (e.g., one or more button presses on a touch display, detecting attention (e.g., including gaze) and/or a gesture performed by the user; and/or one or more inputs received from a hardware input device of the one or more input devices) that correspond to a request to generate one or more automatically-generated visual media items shares one or more characteristics with the sequence of one or more inputs that correspond to a request to generate one or more automatically-generated visual media items, as discussed above.

In some embodiments, in response to detecting the second sequence of one or more inputs, electronic device 500 displays a user interface of the automatically-generated visual media application, as illustrated by visual media creation interface 600a in FIG. 11E. In some embodiments, the user interface of the automatically-generated visual media application is displayed within the respective user interface. In some embodiments, displaying the user interface of the automatically-generated visual media application includes switching the application that is active on the display of the electronic device from the application associated with respective user interface to the automatically-generated visual media application.

In some embodiments, displaying a user interface of the automatically-generated visual media application includes, in accordance with a determination that the respective user interface is the first user interface, displaying, via the one or more display generation components, one or more automatically-generated visual media items having an appearance based on the second prompt and based on the first appearance parameter associated with the first user interface, such as is illustrated by the generation of second automatically-generated visual media item 1111a in FIG. 11E. In some embodiments, the one or more automatically-generated visual media items are generated based on the first appearance parameter when the respective user interface is the first user interface. For example, when the first user interface is a messaging application, the automatically-generated visual media application will receive the same first appearance parameter for generation of one or more automatically-generated visual media items with different prompts received from the messaging application (e.g., a first prompt and second prompt). In some embodiments, in accordance with a determination that the respective user interface is the first user interface, the electronic device displays, via the one or more display generation components, one or more automatically-generated visual media items having an appearance based on the second prompt and based on a third appearance parameter associated with the first user interface, wherein the third appearance parameter has one or more components in common with components of the first appearance parameter.

In some embodiments, displaying a user interface of the automatically-generated visual media application includes, in accordance with a determination that the respective user interface is the second user interface, displaying, via the one or more display generation components, one or more automatically-generated visual media items having an appearance based on the second prompt and based on the second appearance parameter associated with the second user interface, such as is illustrated by the generation of third automatically-generated visual media item 1112a in FIG. 11G, which has a different appearance from second automatically-generated visual media item 1111a as depicted in FIG. 11E. In some embodiments, the one or more automatically-generated visual media items is generated based on the second appearance parameter when the respective user interface is the second user interface. For example, when the second user interface is a notes application, the automatically-generated visual media application will receive the same second appearance parameter for generation of one or more automatically-generated visual media items with different prompts received from the notes application (e.g., a first prompt and second prompt). In some embodiments, in accordance with a determination that the respective user interface is the second user interface, the electronic device displays, via the one or more display generation components, one or more automatically-generated visual media items having an appearance based on the second prompt and based on a fourth appearance parameter associated with the first user interface, wherein the fourth appearance parameter has one or more components in common with components of the second appearance parameter. For example, same prompts received from different sources (e.g., different entry points to the automatically-generated visual media application) result in different visual media items with different visual styles. As another example, different prompts received from a same source result in different visual media items with the same visual style.

In some embodiments, while displaying the user interface of the automatically-generated visual media application including respective one or more automatically-generated visual media items having a respective appearance based on the first prompt (e.g., one or more automatically-generated visual media items having an appearance based on the first prompt and based on a first appearance parameter associated with the first user interface and/or one or more automatically-generated visual media items having an appearance based on the first prompt and based on a second appearance parameter associated with the second user interface) and an affordance for saving the respective one or more automatically-generated visual media items, such as save user interface element 600d shown in FIG. 11E, electronic device 500 detects, via the one or more input devices, an input directed towards the affordance, such as illustrated in relation to contact 904d being directed to save user interface element 600d in FIG. 9E. In some embodiments, detecting the input includes detecting a button press (e.g., a touch screen press or an air pinch gesture directed towards the button). In some embodiments, detecting the input includes detecting one or more button presses on a touch display, detecting attention (e.g., including gaze) and/or a gesture performed by the user; and/or one or more inputs received from a hardware input device of the one or more input devices)

In some embodiments, the respective one or more automatically-generated visual media items having a respective appearance based on the first prompt is the one or more automatically-generated visual media items having an appearance based on the first prompt and based on a first appearance parameter associated with the first user interface. In some embodiments, the respective one or more automatically-generated visual media items having a respective appearance based on the first prompt is the one or more automatically-generated visual media items having an appearance based on the first prompt and based on a second appearance parameter associated with the second user interface.

For example, the electronic device displays the user interface of the automatically-generated visual media application in response to detecting the sequence of one or more inputs (e.g., one or more button presses on a touch display, detecting attention (e.g., including gaze) and/or a gesture performed by the user; and/or one or more inputs received from a hardware input device of the one or more input devices) received via the first user interface. Subsequently, in this example, the automatically generated visual media application generates an automatically-generated visual media item having an appearance based on the first prompt and based on an appearance parameter received from the first user interface. In some embodiments, the affordance for saving the respective one or more automatically-generated visual media items is a button in the user interface of the automatically-generated visual media application (e.g., a “save” button).

In some embodiments, in response to detecting the input, electronic device 500 makes the respective one or more automatically-generated visual media items accessible at a first location associated with the automatically-generated visual media application, such as if the automatically-generated visual media application shown in FIG. 11A includes a visual media content library. In some embodiments, making the respective one or more automatically-generated visual media items accessible at a first location shares one or more characteristics with making the first automatically respective automatically-generated visual media accessible at a first location as described in method 800. In some embodiments, the first location (e.g., a first storage location) is a first memory accessible via the automatically-generated visual media application (as discussed in further detail below). In some embodiments, the first memory is a local memory on the electronic device. In some embodiments, the first memory is a memory external to the electronic device (e.g., a cloud storage memory of a server in communication with the electronic device). In some embodiments, the electronic device updates the visual appearance of the affordance for saving in response to detecting the input (e.g., the button changes appearances from “save” to a check-mark).

In some embodiments, the electronic device accesses and/or displays the contents of the first location (e.g., displays items within a visual media content library) in response to detecting one or more user inputs (e.g., one or more button presses on a touch display, detecting attention (e.g., including gaze) and/or a gesture performed by the user; and/or one or more inputs received from a hardware input device of the one or more input devices), such as if the automatically-generated visual media application shown in FIG. 11A included an affordance for displaying a visual media content library. In some embodiments, the first location is associated with the automatically-generated visual media application. In some embodiments, making the first automatically-generated visual media item accessible at a first location includes displaying, via the one or more display generation components, an automatically-generated visual media library user interface of the automatically-generated visual media application that includes a collection of saved automatically-generated visual media items. In some embodiments, the electronic device displays the automatically-generated visual media library user interface in response to detecting an input (e.g., one or more button presses on a touch display, detecting attention (e.g., including gaze) and/or a gesture performed by the user; and/or one or more inputs received from a hardware input device of the one or more input devices) corresponding to a request to open the automatically-generated visual media application. In some embodiments, the electronic device displays the automatically-generated visual media library user interface in response to detecting an input corresponding to a request to display the automatically-generated visual media library user interface. In some embodiments (e.g., as described further in relation to method 800), the electronic device displays in the user interface of the automatically-generated visual media application the automatically-generated visual media library user interface and/or element that, when accessed (or, optionally, selected or displayed), causes the electronic device to display the one or more automatically-generated visual media items and optionally, the plurality of images and/or videos (e.g., without navigating away from the automatically-generated visual media application).

In some embodiments, the user interface of the automatically-generated visual media application includes one or more affordances for generating one or more automatically-generated visual media items, such as “Create” option 1103 shown in FIG. 11A. In some embodiments, the automatically-generated visual media application includes a second user interface for displaying one or more automatically-generated visual media items accessible at the first location, such as if the automatically-generated visual media application shown in FIG. 11A included a visual media content library accessible a second user interface.

In some embodiments, the automatically-generated visual media application includes two distinct user interfaces, one for creating one or more automatically-generated visual media items (e.g., a “create” user interface) and another for viewing any saved automatically-generated visual media items (e.g., a “library” user interface). In some embodiments, in response to detecting a user input (e.g., one or more button presses on a touch display, detecting attention (e.g., including gaze) and/or a gesture performed by the user; and/or one or more inputs received from a hardware input device of the one or more input devices) directed towards one of the affordances for generating one or more automatically-generated visual media items, the electronic device displays the user interface of the automatically-generated visual media application as discussed above (e.g., the user interface does not change from a “create” user interface of the automatically-generated visual media application in response to selecting a “generate” button). In some embodiments, the first location is accessible via selection of an affordance in the user interface of the automatically-generated visual media application for switching between the user interface and the second user interface. In some embodiments, the user interface of the automatically-generated visual media application is a first user interface of the automatically generated visual media application (e.g., a user interface for generating one or more automatically-generated visual media items). In some embodiments, in response to selecting one or more affordances in the first user interface for switching between the user interface and the second user interface, the electronic device displays the automatically-generated visual media application with a second user interface. For example, the electronic device displays tabs at the top of the user interface displaying “Create” and “Library”, with the currently displayed user interface highlighted. In this example, when the “Create” user interface is being displayed, the user provides a user input (e.g., one or more button presses on a touch display, detecting attention (e.g., including gaze) and/or a gesture performed by the user; and/or one or more inputs received from a hardware input device of the one or more input devices) directed towards the “Library” tab, and in response the electronic device changes the display from the first user interface to the second user interface. In some embodiments, the second user interface includes one or more automatically-generated visual media items saved via the affordance for saving in the first user interface (e.g., a visual media library associated with saved automatically-generated visual media items).

In some embodiments, in response to detecting, via the one or more input devices, the input directed towards the affordance for saving the respective one or more automatically-generated visual media items displayed on the user interface of the automatically-generated visual media application for saving the currently displayed automatically-generated visual media item: electronic device 500 makes the one or more automatically-generated visual media items, having the appearance based on the first prompt and based on the first appearance parameter, accessible at the first location, such as if save user interface element 600d in FIG. 11E were selected, as is illustrated by contact 904d directed towards the save user interface element 600d in FIG. 9E.

In some embodiments, in response to detecting, via the one or more input devices, the input directed towards the affordance for saving the respective one or more automatically-generated visual media items displayed on the user interface of the automatically-generated visual media application for saving the currently displayed automatically-generated visual media item, the electronic device 500 makes the one or more automatically-generated visual media items, having the appearance based on the first prompt and based on the second appearance parameter, accessible at the first location, such as if save user interface element 600d in FIG. 11G were selected, as is illustrated by contact 904d directed towards the save user interface element 600d in FIG. 9E.

In some embodiments, the one or more automatically-generated visual media items having the appearance based on the first prompt and based on the first appearance parameter and the one or more automatically-generated visual media items having the appearance based on the first prompt and based on the second appearance parameter are both accessible at (e.g., saved to) the same storage location (e.g. the first location). In some embodiments, the one or more automatically-generated visual media items having the appearance based on the first prompt and based on the first appearance parameter is accessible at the first location with a first metadata parameter associated with the first appearance parameter. In some embodiments, the one or more automatically-generated visual media items having the appearance based on the first prompt and based on the second appearance parameter is accessible at the first location with a second metadata parameter associated with the second appearance parameter. For example, different visual media items generated based on prompts received from different applications are saved in a same location (e.g., a same memory).

In some embodiments, in response to detecting an input (e.g., one or more button presses on a touch display, detecting attention (e.g., including gaze) and/or a gesture performed by the user; and/or one or more inputs received from a hardware input device of the one or more input devices) to display the second user interface (as discussed above), the electronic device displays the second user interface with the one or more automatically-generated visual media items having the appearance based on the first prompt and based on the first appearance parameter and with the one or more automatically-generated visual media items having the appearance based on the first prompt and based on the second appearance parameter concurrently.

In some embodiments, an automatically-generated visual media item is displayed in the second user interface associated with the first location (as discussed above) in accordance with the respective metadata parameter. For example, the second user interface displays background wallpapers generated from a messaging application in a first portion of the second user interface, and displays emojis generated from a notes application in a second portion of the second user interface.

In some embodiments, displaying the one or more automatically-generated visual media items having the appearance based on the first prompt and based on the first appearance parameter includes displaying the one or more automatically-generated visual media items with a first aspect ratio associated with the first appearance parameter, such as is illustrated by the square aspect ratio of first automatically-generated visual media item 600a shown in FIG. 11B. In some embodiments, displaying the one or more automatically-generated visual media items having the appearance based on the first prompt and based on the second appearance parameter includes displaying the one or more automatically-generated visual media items with a second aspect ratio, different from the first aspect ratio, associated with the second appearance parameter, such as is illustrated by the 16:9 aspect ratio of second automatically-generated visual media item 1111a shown in FIG. 11B.

In some embodiments, the first appearance parameter includes a first aspect ratio parameter, and the second appearance parameter includes a second aspect ratio parameter, different from the first aspect ratio parameter. In some embodiments, the first aspect ratio parameter and/or second aspect ratio parameter are determined by the electronic device without any user input to define the aspect ratio parameters. In some embodiments, the automatically-generated visual media application generates one or more automatically-generated visual media items with a first aspect ratio (e.g., 6:9) when the first aspect ratio parameter is present. In some embodiments, the automatically-generated visual media application generates one or more automatically-generated visual media items with a second aspect ratio (e.g., 1:1) when the second aspect ratio parameter is present. In some embodiments, once the automatically-generated visual media item is displayed, the electronic device updates, in response to one or more user inputs, the aspect ratio of the automatically-generated media item, and optionally re-generates the one or more automatically-generated visual media item, as discussed in relation to method 1000. In some embodiments, in response to detecting an input directed towards an affordance for saving the respective automatically-generated visual media item (as discussed above), the electronic devices makes the respective automatically-generated visual media item accessible at the first location with the respective aspect ratio (e.g., an image generated with a 6:9 aspect ratio will be saved with a 6:9 aspect ratio).

It should be understood that the particular order in which the operations in FIG. 12 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, and/or 1000) are also applicable in an analogous manner to method 1200 described above with respect to FIG. 12. For example, the operation of the electronic device making automatically-generated visual media accessible in different locations described above with reference to method 1200 optionally has one or more of the characteristics of generating automatically-generated visual media using a machine learning (ML) model, making automatically-generated visual media accessible in different locations, and/or displaying an automatically-generated visual media item at a new size described herein with reference to other methods described herein (e.g., methods 700, 800, and/or 1000). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 12 are, optionally, implemented by components depicted in FIGS. 1A-1B. For example, detecting a sequence of one or more inputs corresponding to a request to generate automatically-generated visual media 1202 and displaying a user interface of the automatically-generated visual media application 1204, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data relating to a person’s likeness, name, date of birth, or any other identifying or personal information.

The present disclosure recognizes that the use of such personal information data, in the present technology, can be used to the benefit of users. For example, analyzing prompts to generate automatically-generated visual media can enable the electronic device to generate improved automatically-generated visual media. Accordingly, use of such personal information data (e.g., user preferences derived from prompts) enables users to use electronic devices to perform enhanced automatically-generated visual media operations. Further, other uses for personal information data that benefit the user are also contemplated by the present disclosure. For instance, analyzing a user’s entered prompt may enhance detection of suggested prompt components to be included in the prompt for generating automatically-generated visual media.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to "opt in" or "opt out" of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device generated generative visual media content without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the visual media generation using an ML model process, the automatically-generated visual media saving process, the resizing process, and/or the process for generating automatically-generated visual media items with different appearances based on different appearance parameters can be used to benefit users. For example, the data can be used to train models that can be deployed to improve performance, accuracy, and/or functionality of applications and/or services. Accordingly, the use of the data enables the visual media generation using an ML model process, the automatically-generated visual media saving process, the resizing process, and/or the process for generating automatically-generated visual media items with different appearances based on different appearance parameters to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the visual media generation using an ML model process, the automatically-generated visual media saving process, the resizing process, and/or the process for generating automatically-generated visual media items with different appearances based on different appearance parameters are also contemplated by the present disclosure.

The present disclosure contemplates that, in some embodiments, data used by the visual media generation using an ML model process, the automatically-generated visual media saving process, the resizing process, and/or the process for generating automatically-generated visual media items with different appearances based on different appearance parameters includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with the visual media generation using an ML model process, the automatically-generated visual media saving process, the resizing process, and/or the process for generating automatically-generated visual media items with different appearances based on different appearance parameters, should attempt to comply with well-established privacy policies and/or privacy practices.

For example, such entities may implement and consistently follow policies and practices recognized as meeting or exceeding industry standards and regulatory requirements for developing and/or training the visual media generation using an ML model process, the automatically-generated visual media saving process, the resizing process, and/or the process for generating automatically-generated visual media items with different appearances based on different appearance parameters. In doing so, attempts should be made to ensure all intellectual property rights and privacy considerations are maintained. Training should include practices safeguarding training data, such as personal information, through sufficient protections against misuse or exploitation. Such policies and practices should cover all stages of the visual media generation using an ML model process, the automatically-generated visual media saving process, the resizing process, and/or the process for generating automatically-generated visual media items with different appearances based on different appearance parameters development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, the visual media generation using an ML model process, the automatically-generated visual media saving process, the resizing process, and/or the process for generating automatically-generated visual media items with different appearances based on different appearance parameters may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for the visual media generation using an ML model process, the automatically-generated visual media saving process, the resizing process, and/or the process for generating automatically-generated visual media items with different appearances based on different appearance parameters may be kept strictly separated from platforms where the visual media generation using an ML model process, the automatically-generated visual media saving process, the resizing process, and/or the process for generating automatically-generated visual media items with different appearances based on different appearance parameters are deployed and/or used to interact with users and/or process data. In such embodiments, data used for offline training of the visual media generation using an ML model process, the automatically-generated visual media saving process, the resizing process, and/or the process for generating automatically-generated visual media items with different appearances based on different appearance parameters may be maintained in secured datastores with restricted access and/or not be retained beyond the duration necessary for training purposes. In some embodiments, the visual media generation using an ML model process, the automatically-generated visual media saving process, the resizing process, and/or the process for generating automatically-generated visual media items with different appearances based on different appearance parameters may utilize a local memory cache to store data temporarily during a user session. The local memory cache may be used to improve performance of the visual media generation using an ML model process, the automatically-generated visual media saving process, the resizing process, and/or the process for generating automatically-generated visual media items with different appearances based on different appearance parameters . However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the visual media generation using an ML model process, the automatically-generated visual media saving process, the resizing process, and/or the process for generating automatically-generated visual media items with different appearances based on different appearance parameters . The visual media generation using an ML model process, the automatically-generated visual media saving process, the resizing process, and/or the process for generating automatically-generated visual media items with different appearances based on different appearance parameters should be monitored for changes in underlying data distribution such as concept drift or data skew that can degrade performance of the visual media generation using an ML model process, the automatically-generated visual media saving process, the resizing process, and/or the process for generating automatically-generated visual media items with different appearances based on different appearance parameters over time.

In some embodiments, the visual media generation using an ML model process, the automatically-generated visual media saving process, the resizing process, and/or the process for generating automatically-generated visual media items with different appearances based on different appearance parameters are trained using a combination of offline and online training. Offline training can use curated datasets to establish baseline model performance, while online training can allow the visual media generation using an ML model process, the automatically-generated visual media saving process, the resizing process, and/or the process for generating automatically-generated visual media items with different appearances based on different appearance parameters to continually adapt and/or improve. The present disclosure recognizes the importance of maintaining strict data governance practices throughout this process to ensure user privacy is protected.

In some embodiments, the visual media generation using an ML model process, the automatically-generated visual media saving process, the resizing process, and/or the process for generating automatically-generated visual media items with different appearances based on different appearance parameters may be designed with safeguards to maintain adherence to originally intended purposes, even as the visual media generation using an ML model process, the automatically-generated visual media saving process, the resizing process, and/or the process for generating automatically-generated visual media items with different appearances based on different appearance parameters adapt based on new data. Any significant changes in data collection and/or applications of the visual media generation using an ML model process, the automatically-generated visual media saving process, the resizing process, and/or the process for generating automatically-generated visual media items with different appearances based on different appearance parameters use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the visual media generation using an ML model process, the automatically-generated visual media saving process, the resizing process, and/or the process for generating automatically-generated visual media items with different appearances based on different appearance parameters and/or for use as input during the inference stage of such systems. In yet another example, the present technology should be configured to allow users to be able to select to limit the length of time data is maintained or entirely prohibit the use of their data for use by the visual media generation using an ML model process, the automatically-generated visual media saving process, the resizing process, and/or the process for generating automatically-generated visual media items with different appearances based on different appearance parameters . In addition to providing “opt in” and “opt out” options, the present disclosure contemplates providing notifications relating to the access or use of personal information. For instance, a user can be notified when their data is being input into the visual media generation using an ML model process, the automatically-generated visual media saving process, the resizing process, and/or the process for generating automatically-generated visual media items with different appearances based on different appearance parameters for training or inference purposes, and/or reminded when the visual media generation using an ML model process, the automatically-generated visual media saving process, the resizing process, and/or the process for generating automatically-generated visual media items with different appearances based on different appearance parameters generate outputs or make decisions based on their data.

The present disclosure recognizes the visual media generation using an ML model process, the automatically-generated visual media saving process, the resizing process, and/or the process for generating automatically-generated visual media items with different appearances based on different appearance parameters should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to or failures to cite third-party products and/or services in the outputs should not be construed as endorsements or affiliations by the entities providing the visual media generation using an ML model process, the automatically-generated visual media saving process, the resizing process, and/or the process for generating automatically-generated visual media items with different appearances based on different appearance parameters . Generated content can be filtered for potentially inappropriate or dangerous material prior to being presented to users, while human oversight and/or ability to override or correct erroneous or undesirable outputs can be maintained as a failsafe.

The present disclosure further contemplates that users of the visual media generation using an ML model process, the automatically-generated visual media saving process, the resizing process, and/or the process for generating automatically-generated visual media items with different appearances based on different appearance parameters should refrain from using the services in any manner that infringes upon, misappropriates, or violates the rights of any party. Furthermore, the visual media generation using an ML model process, the automatically-generated visual media saving process, the resizing process, and/or the process for generating automatically-generated visual media items with different appearances based on different appearance parameters should not be used for any unlawful or illegal activity, nor to develop any application or use case that would commit or facilitate the commission of a crime, or other tortious, unlawful, or illegal act including misinformation, disinformation, misrepresentations (e.g., deepfakes), deception, impersonation, and propaganda. The visual media generation using an ML model process, the automatically-generated visual media saving process, the resizing process, and/or the process for generating automatically-generated visual media items with different appearances based on different appearance parameters should not violate, misappropriate, or infringe any copyrights, trademarks, rights of privacy and publicity, trade secrets, patents, or other proprietary or legal rights of any party, and appropriately attribute content as required. Further, the visual media generation using an ML model process, the automatically-generated visual media saving process, the resizing process, and/or the process for generating automatically-generated visual media items with different appearances based on

different appearance parameters should not interfere with any security, digital signing, digital rights management, content protection, verification, or authentication mechanisms. The visual media generation using an ML model process, the automatically-generated visual media saving process, the resizing process, and/or the process for generating automatically-generated visual media items with different appearances based on different appearance parameters should not misrepresent machine-generated outputs as being human-generated.

What is claimed is:

1. A method comprising:
at an electronic device in communication with one or more display generation components and one or more input devices:
while displaying, via the one or more display generation components, a user interface of an automatically-generated visual media application for generating automatically-generated visual media using a respective machine learning (ML) model, detecting, via the one or more input devices, a sequence of one or more inputs directed to the user interface corresponding to a request to generate an automatically-generated visual media item based on a prompt; and in response to detecting the sequence of one or more inputs directed to the user interface of the automatically-generated visual media application, generating an automatically-generated visual media item based on the prompt, including:
in accordance with a determination that the sequence of one or more inputs specified a first ML model for use in generating the automatically-generated visual media item, generating the automatically-generated visual media based on the prompt using the first ML model; and
in accordance with a determination that the sequence of one or more inputs specified a second ML model for use in generating the automatically-generated visual media item, generating the automatically-generated visual media based on the prompt using the second ML model.

2. The method of claim 1, wherein:
the first ML model is associated with a first provider; and
the second ML model is associated with the first provider.

3. The method of claim 2, wherein:
the first ML model specifies a first visual style used as a stylistic basis for generating the automatically-generated visual media item; and
the second ML model specifies a second visual style used as the stylistic basis for generating the automatically-generated visual media item, different from the first visual style.

4. The method of claim 1, wherein:
displaying the user interface of the automatically-generated visual media application for generating automatically-generated visual media using the respective ML model includes displaying, via the one or more display generation components, a representation of a respective prompt component associated with the respective ML model including one or more selectable options for specifying the respective ML model for use in generating the automatically-generated visual media item; and
the one or more selectable options include:
a first option selectable to select the first ML model associated with a first provider;
a second option selectable to select the second ML model associated with a second provider, different from the first provider; and
a third option selectable to select a third ML model associated with a third provider, different from the second provider.

5. The method of claim 1, wherein:
the first ML model is associated with an entity that is responsible for maintaining an operating system of the electronic device;
the second ML model is not associated with the entity that is responsible for maintaining the operating system of the electronic device; and
the second ML model is an ML model that has been selected for use by a functionality of the electronic device, other than the automatically generated visual media application, to provide one or more automatically-generated responses to one or more second inputs.

6. The method of claim 1, wherein generating the automatically-generated visual media based on the prompt using the respective ML model includes:
in accordance with a determination the respective ML model is a first type of ML model, displaying, via the one or more display generation components, an alert associated with using the respective ML model before allowing the generation of the automatically-generated visual media using the respective ML model; and in accordance with a determination the respective ML model is a second type of ML model, different from the first type of model, forgoing displaying the alert.

7. The method of claim 1, wherein generating the automatically-generated visual media based on the prompt using the respective ML model includes:
in accordance with a determination that the prompt indicates a first visual style, displaying, via the one or more display generation components, a notification indicating a third ML model that is available for use in generating the automatically-generated visual media item based on the first visual style; and
in accordance with a determination that the prompt indicates a second visual style, different from the first visual style, displaying, via the one or more display generation components, a notification indicating a fourth ML model that is available for use in generating the automatically-generated visual media based on the second visual style.

8. The method of claim 7, wherein the notification includes an indication of a provider associated with the third ML model.

9. The method of claim 7, wherein the notification includes an indication of the visual style and the indication of the third ML model capable of generating the automatically-generated visual media item based on the visual style.

10. The method of claim 1, wherein the respective ML model specifies an emoji style used as a stylistic basis for generating the automatically-generated visual media item.

11. The method of claim 1, wherein displaying the user interface of the automatically-generated visual media application for generating automatically-generated visual media using the respective ML model includes concurrently displaying, via the one or more display generation components, a representation of a respective prompt component associated with the respective ML model including a first visual style for use in generating the automatically-generated visual media item, the method further comprising:
while displaying the representation of the respective prompt component, detecting, via the one or more input devices, a sequence of one or more second inputs corresponding to a request to change the first visual style; and
in response to detecting the sequence of one or more second inputs corresponding to a request to change the first visual style, initiating a process to change the first visual style.

12. The method of claim 11, wherein the process to change the first visual style includes regenerating the automatically-generated visual media item based on the prompt including a second visual style, different from the first visual style.

13. The method of claim 1, further comprising:
while displaying the user interface of the automatically-generated visual media application for generating automatically-generated visual media using the respective ML model, detecting, via the one or more input devices, a sequence of one or more second inputs corresponding to a request to customize an appearance of a subject of the prompt using the respective ML model; and
in response to detecting the sequence of one or more second inputs corresponding to the request to customize the appearance of the subject of the prompt using the respective ML model, displaying, via the one or more display generation components, an editing user interface element including one or more selectable options for customizing the appearance of the subject of the prompt using the respective ML model.

14. The method of claim 13, wherein the one or more selectable options include one or more options to select one or more predetermined appearance characteristics for the subject of the prompt.

15. The method of claim 13, wherein the one or more selectable options include one or more content entry fields for inputting content for customizing the appearance of the subject of the prompt using the respective ML model.

16. The method of claim 13, further comprising:
while displaying the editing user interface element including the one or more selectable options for customizing the appearance of the subject of the prompt using the respective ML model, detecting, via the one or more input devices, a sequence of one or more third inputs corresponding to a selection of a respective option of the one or more selectable options for customizing the appearance of the subject;
in response to detecting the sequence of the one or more third inputs corresponding to the selection of the respective option of the one or more selectable options for customizing the appearance of the subject, displaying, via the one or more display generation components, a first representation of the subject that is based on a first visual reference for the subject and has been modified based on the respective option;
while displaying the first representation of the subject, detecting, via the one or more input devices, a navigation input; and
in response to detecting the navigation input, displaying, via the one or more display generation components, a second representation of the subject that is based on a second visual reference for the subject that is different from the first visual reference for the subject and has been modified based on the respective option.

17. The method of claim 13, wherein the one or more selectable options include a reset option that, when selected, causes the electronic device to reset the appearance of the subject of the prompt to a state prior to detecting the sequence of one or more second inputs corresponding to the request to customize the appearance of the subject of the prompt using the respective ML model.

18. The method of claim 1, wherein:
displaying the user interface of the automatically-generated visual media application for generating automatically-generated visual media using the respective ML model includes displaying, via the one or more display generation components, one or more respective selectable options selectable to add, to the prompt, a plurality of suggested prompt components based on a respective style associated with the respective ML model, wherein displaying the plurality of suggested prompt components:
in accordance with a determination that the respective ML model is the first ML model, displaying a first set of prompt components with a first appearance; and
in accordance with a determination that the respective ML model is the second ML model, displaying a second set of prompt components with a second appearance, different from the first set of prompt components.

19. The method of claim 1, wherein:
the respective ML model specifies an emoji style used as a stylistic basis for generating the automatically-generated visual media item; displaying the user interface of the automatically-generated visual media application for generating automatically-generated visual media using the respective ML model includes displaying, via the one or more display generation components, a plurality of suggested prompt components based on a respective style associated with the respective ML model, wherein displaying the plurality of suggested prompt components includes:
in accordance with a determination that the respective ML model is the first ML model, displaying one or more prompt suggested components that correspond to previously used emoji prompt components.

20. The method of claim 19, wherein displaying the user interface of the automatically-generated visual media application for generating automatically-generated visual media using the respective ML model includes displaying, via the one or more display generation components, a content entry field for inputting a prompt component; and
the method further comprises:
while displaying the content entry field for inputting the prompt component, detecting, via one or more input devices, one or more second inputs directed to the content entry field; and
in response to detecting the one or more second inputs directed to the content entry field, displaying, via the one or more display generation components, a soft keyboard operating in an emoji mode for entering emoji content into the content entry field.

21. The method of claim 19, wherein displaying the user interface of the automatically-generated visual media application for generating automatically-generated visual media using the respective ML model includes displaying, via the one or more display generation components, respective suggested prompt components based on a respective style associated with the respective ML model, wherein:
in accordance with a determination that the respective ML model is the first ML model, the respective suggested prompt components are emotive emoji prompt components.

22. An electronic device that is in communication with one or more display generation components and one or more input devices, the electronic device comprising:
one or more processors;
memory; and
one or more programs, wherein the one or more programs are stored in the memory and configured to be executed by the one or more processors, the one or more programs including instructions for:
while displaying, via the one or more display generation components, a user interface of an automatically-generated visual media application for generating automatically-generated visual media using a respective machine learning (ML) model, detecting, via the one or more input devices, a sequence of one or more inputs directed to the user interface corresponding to a request to generate an automatically-generated visual media item based on a prompt; and
in response to detecting the sequence of one or more inputs directed to the user interface of the automatically-generated visual media application, generating an automatically-generated visual media item based on the prompt, including:
in accordance with a determination that the sequence of one or more inputs specified a first ML model for use in generating the automatically-generated visual media item, generating the automatically-generated visual media based on the prompt using the first ML model; and
in accordance with a determination that the sequence of one or more inputs specified a second ML model for use in generating the automatically-generated visual media item, generating the automatically-generated visual media based on the prompt using the second ML model.

23. A non-transitory computer readable storage medium storing one or more programs, the one or more programs comprising instructions, which when executed by one or more processors of an electronic device, cause the electronic device to perform a method comprising:
while displaying, via one or more display generation components, a user interface of an automatically-generated visual media application for generating automatically-generated visual media using a respective machine learning (ML) model, detecting, via one or more input devices, a sequence of one or more inputs directed to the user interface corresponding to a request to generate an automatically-generated visual media item based on a prompt; and
in response to detecting the sequence of one or more inputs directed to the user interface of the automatically-generated visual media application, generating an automatically-generated visual media item based on the prompt, including:
in accordance with a determination that the sequence of one or more inputs specified a first ML model for use in generating the automatically-generated visual media item, generating the automatically-generated visual media based on the prompt using the first ML model; and
in accordance with a determination that the sequence of one or more inputs specified a second ML model for use in generating the automatically-generated visual media item, generating the automatically-generated visual media based on the prompt using the second ML model.
